(19) United States
(12) Patent Application Publication
(10) Pub. No.: US 2007/0274764 A1
(43) Pub. Date: Nov. 29, 2007

(54) Capless writing tools and methods

(76) Inventor: Youngtack Shim, Port Moody (CA)

Correspondence Address: Youngtack Shim, 155 Aspenwood Drive, Port Moody, BC, V3H 5A5, US

(21) Appl. No.: 11/441,023

(22) Filed: May 26, 2006

(51) Int. Cl. B43K 7/12; B43K 24/02

(52) U.S. Cl. 401/108; 401/107

(57) ABSTRACT

The present invention generally relates to writing tools for applying volatile marking substances over articles but not including removable caps in one ends thereof to prevent drying of their tips. More particularly, the present invention generally relates to writing tools with one or more caps movably or fixedly couple with such tools, operate between off-states and on-states, obstruct openings of such writing tools in order to prevent drying of their tips in the off-states, and clear such openings so as to expose their tips through the openings in the on-states, where the caps are preferably synchronized with the tips. The present invention also relates to various methods of preventing drying of such tips of the writing tools without having to use removable caps, those of incorporating various caps into the writing tools and obstructing and clearing the openings of the writing tools thereby, those of exposing and enclosing such tips between use and rest positions while preventing or minimizing leaking of the marking substances out of the writing tools, those of and so on. The present invention further relates to various processes of providing any of the above writing tools, their members, and/or their units.

### CROSS-REFERENCES TO RELATED APPLICATIONS

The present application is related to a Disclosure Document entitled “Capless Writing Tools and Methods” which was deposited in the U.S. Patent and Trademark Office on Sep. 7, 2004 under the Disclosure Document Deposit Program of the Office and which bears a Ser. No. 560,239, to another Disclosure Document entitled “Multicolor Writing Tools and Methods” which was deposited in the Office on Mar. 1, 2005 under the Program and which bears a Ser. No. 571,688, and to the U.S. Utility patent application which is entitled “Multicolor Writing Tools and Methods” and which is filed to the Office by the same Applicant on the same date as this application. Thus, the present application claims the benefits of earlier invention dates pertinent to the above Disclosure Documents. All of such Documents and application are to be referred to as the “co-pending applications” hereinafter and also to be incorporated herein in their entirety by reference.

### FIELD OF THE INVENTION

The present invention generally relates to writing tools for applying volatile marking substances over articles but not including removable caps in one ends thereof to prevent drying of their tips. More particularly, the present invention generally relates to writing tools incorporated with one or more caps which fixedly or movably couple with such tools, operate between off-states and on-states, obstruct openings of such writing tools in order to prevent drying of their tips in the off-states, and clear such openings so as to expose their tips through the openings in the on-states. Such caps of the present invention are preferably synchronized to the tips of the tools so that the caps may clear the openings of the tools as the tips move and become exposed out of the openings and that the caps may obstruct such openings when such tips move back to their original positions after use. In addition, the present invention relates to various members of the writing tools such as, e.g., case members, cap members, cartridge members, actuator members, and so on, as well as to various units of these members such as, e.g., absorber units for absorbing the marking substances spilling through the tips and recoil units for providing driving force for movement of those caps. The present invention also relates to various methods of preventing drying of such tips of the writing tools without having to use removable caps, those of incorporating various caps into the writing tools and obstructing and clearing the openings of the writing tools thereby, those of exposing and enclosing such tips of the writing tools between use and rest positions while preventing or minimizing leaking of the marking substances out of the writing tools, those of and so on. The present invention further relates to various processes of providing any of the above writing tools, their members, and/or their units.

### BACKGROUND OF THE INVENTION

Pens and other writing tools have been evolving with the history of mankind. With the advent of chemical technologies of synthesizing inks and dyes, current writing tools allow an user to write or draw in numerous colors in almost any thicknesses of his or her choice. In general, such writing tools may be categorized into two groups based upon physical characteristics of marking substances used thereby, e.g., those employing volatile marking substances and those using less volatile or nonvolatile marking substances.

When the volatile marking substances are employed, they continuously evaporate through tips of such writing tools and tend to form deposits or chunks of inks or dyes on such tips, which not only interfere with normal operation of the writing tools but also shorten a life span of such tools. In order to prevent such evaporation, all conventional writing tools using the volatile marking substances come with caps capable of being disposed over and removed from the tips so that an user may remove the caps from the tips and write or draw and that the user may then put such caps back to the tips when not in use in order to prevent evaporation of the marking substances through the tips. Because such caps are generally provided as separate articles, the user has to keep track of whereabouts of such caps while he or she uses the writing tools. When the caps are lost, the user has to find other caps or to ditch the entire tools. In order to overcome such inconvenience, some caps are coupled to such writing tools by string, chains, strips or other conventional couplers. However, such writing tools still force the user to remove the caps before she or he uses the tools and to put the caps back after she or he is done with writing or drawing.

The conventional writing tools employing less volatile marking substances may not require any caps, for such substances may neither significantly evaporate through tips nor leave any deposits or residues in the tips. However, such tools may tend to collect dust in their tips during storage, and the marking substances may harden or otherwise degrade in their tips due to evaporation and/or oxidation thereof. Therefore, such conventional tools may also be provided with caps or, alternatively, may be provided with mobile mechanisms in order to move the tips inside cases of the tools when not in use. Other writing tools using nonvolatile marking substances such as, e.g., pencils do not need any cap at all. However, tips of such tools may be damaged during storage or may damage cloths when carried by the user in his or her pockets.

Accordingly, there is a need for writing tools which incorporate various cap members capable of moving tips of such tools between use and rest positions and respectively exposing and enclosing the tips between such positions. In addition, there is a need for writing tools with such cap members which are synchronized with the tips so that the cap members clear openings of the tools as the tips move to the use positions and obstruct such openings when the tips move to the rest positions.

### SUMMARY OF THE INVENTION

The present invention generally relates to writing tools for applying volatile marking substances over articles but not including removable caps in one ends thereof to prevent drying of their tips. More particularly, the present invention generally relates to writing tools incorporated with one or more caps which fixedly or movably couple with such tools, operate between off-states and on-states, obstruct openings of such writing tools in order to prevent drying of their tips in the off-states, and clear such openings so as to expose their tips through the openings in the on-states. Such caps of the present invention are preferably synchronized to the tips of the tools so that the caps may clear the openings of the tools as the tips move and become exposed out of the openings and that the caps may obstruct such openings when such tips move back to their original positions after use. In addition, the present invention relates to various members of the writing tools such as, e.g., case members, cap members, cartridge members, actuator members, and so on, as well as to various units of these members such as, e.g., absorber units for absorbing the marking substances spilling through the tips and recoil units for providing driving force for movement of those caps.

The present invention also relates to various methods of preventing tips of writing tools from getting dry without having to use removable caps, to various methods of incorporating various mobile caps into the writing tools, thereby obstructing and clearing openings of the writing tools when such tools are not in use and during its use, respectively, to various methods of exposing and enclosing the tips of such writing tools between use and rest positions while preventing or minimizing leaking of the marking substances out of the writing tools, and the like. The present invention also relates to various methods of enclosing and exposing such tips of the writing tools and at the same time obstructing and clearing such openings of the tools, respectively, by synchronizing or coupling operations of such tips with those of the caps.

The present invention further relates to various processes for providing and/or making various writing tools which have configurational and/or operational characteristics described in the above two previous paragraphs. More particularly, the present invention relates to various processes for making the writing tools for applying volatile marking substances on articles but not requiring removable caps in one ends thereof to prevent drying of their tips and/or those writing tools incorporated with one or more caps configured to fixedly or movably couple with such tools, to operate between on-states and off-states, to obstruct openings of the writing tools for preventing drying of their tips in the off-states, and to clear the openings for exposing their tips therethrough in the on-states. The present invention also relates to various processes for synchronizing and/or coupling the caps with the tips of the tools so that the caps may clear the openings of the tools as the tips move and become exposed out of the openings, while the caps may obstruct the openings as such tips move back to their original positions after use. In addition, the present invention relates to various processes for making various members of the writing tools (e.g., case members, cap members, cartridge members, actuator members, and so on) and various units of these members (e.g., absorber units, recoil units, and the like).

Various writing tools of the present invention may be applied to any conventional writing tools using water as a base for their marking substances, where examples of such tools may include, but not be limited to, roller pens, coloring pens, sign pens, highlighters, and the like. Various writing tools of this invention may also be applied to any conventional writing tools employing more volatile organic solvents as bases for their marking substances, where examples of such tools may include, but not be limited to, erasable markers, permanent marker pens, and so on. When incorporated thereinto, the writing tools of the present invention may obviate use of the conventional removable caps by sealing tips of such tools from evaporation of the water-based or solvent-based marking substances when the tools are not in user and by exposing such tips through the caps only during the use of such tools. The writing tools of the present invention may further be arranged to contain therein correction fluids, manicures, water-based paints, oil-based paints, and other water-based and solvent-based marking substances in order to be respectively used as, e.g., correction fluid pens, manicure pens, paint pens, and the like.

Various writing tools of the present invention may also be applied to other conventional writing tools using various marking substances which are generally less volatile than water, where examples of such tools may include, but not be limited to, ball-point pens, oil-based pens, and other conventional pens employing less volatile or nonvolatile fluids as bases for their marking substances. Although the above tools do not need any caps per se, some of such tools are typically provided with the caps for various reasons such as, e.g., preventing evaporation of the marking substances, protecting their tips from mechanical damages, protecting the user and/or his or her cloths from damages caused by such tips of the writing tools, and the like. Accordingly, such writing tools of the present invention may also be arranged to contain therein correction fluids, oil-based paints, manicure solutions, mascara fluids, lipstick gels or sols, and other liquid- or solid-phase cosmetic products so as to be respectively used as, e.g., correction fluid pens, paint brush pens, manicure pens, mascara pens, lipstick pens, and the like.

Various writing tools of the present invention may also be applied to other conventional writing tools which do not employ any fluid marking substances but which may require various caps so as to provide protection of their tips and/or of the user from the sharp tips thereof, where examples of such tools may include, but not be limited to, mechanical pencils, crayons, and the like. Such writing tools of this invention may further be arranged to contain therein pastels, lipstick gels or sols, and other fluid- or solid-phase marking substances in order to be used as, e.g., pastel pens, lipstick pens, and the like. Furthermore, the writing tools of this invention may be applied to contain various non-writing fluids or solids for various purposes such as, e.g., preventing evaporation of such fluids or solids, protecting tips of such non-writing tools, protecting the user from such non-writing fluids or solids and/or from such tips of the non-writing tools, and the like, where examples of such non-writing tools may include, but not be limited to, glue pens, plastic or rubber cement pens, and the like.

It is to be understood, however, that the scope of the present invention is limited to the above writing tools which are arranged to contain therein and to dispense therefrom the marking substance having a single or monochromic color and/or shade. When cartridge members are used to contain the marking substance therein, the scope of the present invention is to be limited to such writing tools with a single cartridge member for a single or monochromic color and/or shade. It is also to be understood that the scope of this invention is limited to the above non-writing tools which are arranged to contain a single compound or mixture therein and to dispense therefrom such a compound or mixture. When the cartridge members are similarly used to contain such compounds or mixtures therein, the scope of the present invention is also to be limited to those non-writing tools with a single cartridge member for a single compound or mixture.

In one aspect of the present invention, various capless writing tools may be provided to apply marking substances onto an article and include multiple members at least one of which is arranged to receive input force applied thereto by an user.

In one exemplary embodiment of this aspect of the present invention, a writing tool may include at least one case member, at least one cap member, and at least one cartridge member. Such a case member may be arranged to be stationary, to provide the user with a grip, to include at least one case forming an interior therein, and to define an opening which is disposed in one end thereof and capable of providing fluid communication between the interior and an exterior of its case. Such a cap member may include at least one cap arranged to operate between at least one off-state and at least one on-state, where the cap in the off-state may be arranged to obstruct at least a substantial portion of the opening and to prevent the fluid communication through the opening, whereas the cap in the on-state may be arranged to clear the substantial portion of the opening and to provide the fluid communication through the opening. The cartridge member may be arranged to be at least partially disposed in such an interior, to contain the marking substance therein, to include a tip by which the user is arranged to apply the marking substance onto the article, and to operate between at least one rest position and at least one use position. In one example, the cartridge member may be arranged to operate from one to the other of the rest and use positions in response to the input force while operating the cap from one to the other of the off- and on-states, respectively. In another example, the cap may be arranged to operate from one to the other of the off- and on-states in response to the input force while operating the cartridge member from one to the other of the rest and use positions, respectively.

In another exemplary embodiment of this aspect of such an invention, a writing tool may have at least one case member, at least one cartridge member, and at least one cap member. Such a case member may be arranged to be stationary, to provide the user with a grip, and to include at least one case forming an interior therein. Such a cartridge member may be arranged to be stationary, to be at least partially disposed inside the interior, to contain the marking substance therein, and to include a tip exposed out of the interior and by which the user is arranged to apply the marking substance onto the article. The cap member may include at least one cap which is arranged to operate between at least one off-state and at least one on-state in response to the input force, to enclose and isolate such a tip from an exterior of the case in the off-state, and to expose the tip to the exterior in the on-state.

In another exemplary embodiment of this aspect of such an invention, a writing tool may have at least one case member, at least one cartridge member, and at least one cap member. Such a case member may be arranged to provide a grip to an user, to include at least one case defining an interior therein, to form an opening in one end thereof in order to provide fluid communication between such an interior and an exterior of the case, and to operate between at least one rest position and at least one use position. The cap member may include at least one cap arranged to operate between at least one off-state and at least one on-state, where the cap in the off-state is arranged to obstruct at least a substantial portion of the opening and to prevent the fluid communication through the opening, while the cap in the on-state is arranged to clear such a portion of the opening and, therefore, to provide the fluid communication through such an opening. The cartridge member may be arranged to be at least partially disposed inside the interior, to contain the marking substance therein, to include a tip by which the user may apply such marking substance onto the article, and to operate between at least one rest position and at least one use position. In one example, at least one of the case and cartridge members may be arranged to operate from one to the other of such rest and use positions in response to such input force while operating the cap from one to the other of such off- and on-states, respectively. In another example, one of the case and cartridge members may be arranged to operate from one to the other of the rest and use positions in response to the input force, whereas the other of the case and cartridge members may be arranged to receive at least a portion of the input force from the one of the members and to operate from one to the other of such rest and use positions while operating the cap from one to the other of the off- and on-states, respectively. In yet another example, the cap may be arranged to operate from one to the other of such off- and on-states in response to such input force, while moving at least one of the case and cartridge members from one to the other of the rest and use positions, respectively.

In another exemplary embodiment of this aspect of such an invention, a writing tool may have at least one case member, at least one cartridge member, and at least one cap member. Such a case member may be arranged to provide a grip to an user, to include at least one case defining an interior therein, to define an opening in one end thereof for providing fluid communication between the interior and an exterior of such a case, and to operate between at least one rest position and at least one use position. The cap member may include at least one cap arranged to operate between at least one off-state and at least one on-state, where the cap in the off-state may be arranged to obstruct at least a substantial portion of the opening and to prevent such fluid communication through the opening, while the cap in the on-state may be arranged to clear such a portion of the opening and to provide the fluid communication through the opening. Such a cartridge member may be arranged to be at least partially disposed inside the interior, to contain the marking substance therein, and to include a tip by which the user is arranged to apply such marking substance onto the article. In one example, the case member may be arranged to operate in response to such input force from one to the other of the rest and use positions, while operating such a cap from one to the other of the off- and on-states, respectively. In another example, the cap may be arranged to operate in response to such input force from one to the other of the off- and on-states, while moving the case member from one to the other of the rest and use positions, respectively.

In another aspect of the present invention, various capless writing tools may also be provided to apply marking substances onto an article.

In one exemplary embodiment of this aspect of the present invention, a writing tool may include at least one case member, at least one cap member, and at least one cartridge member. Such a case member may be arranged to be stationary, to provide an user with a grip, to include at least one case forming an interior therein, and to form an opening which is disposed in one end thereof and capable of providing fluid communication between the interior and an exterior of the case. Such a cap member may include at least one cap arranged to operate between at least one off-state and at least one on-state, where the cap in the off-state may be arranged to obstruct at least a substantial portion of such an opening and to prevent such fluid communication through the opening, while the cap in the on-state may be arranged to clear such a portion of the opening and to provide the fluid communication through the opening. The cartridge member may be arranged to be at least partially disposed in the interior, to contain the marking substance therein, to include a tip by which the user may be arranged to apply the marking substance onto the article, and to operate between at least one rest position and at least one use position. Such a writing tool may also include at least one actuator member. In one example, the actuator member may be arranged to manipulate both of such cap and cartridge members indirectly or directly, to keep the cap in the off-state while keeping the cartridge member in the rest position, and to operate such a cap to the on-state while moving the cartridge member to the use position. In another example, the actuator member may be arranged to manipulate both of the cap and cartridge members directly and indirectly, to keep the cartridge member in its rest position while keeping such a cap in the off-state, and to move the cartridge member to the use position while operating such a cap to the on-state.

In another exemplary embodiment of this aspect of such an invention, a writing tool may have at least one case member, at least one cartridge member, and at least one cap member. Such a case member may be arranged to be stationary, to provide a grip to an user, and to have at least one case defining an interior therein. Such a cartridge member may be arranged to be stationary, to be at least partially disposed inside such an interior, to contain the marking substance therein, and to include a tip exposed out of the interior and by which the user is arranged to apply the marking substance onto the article. The cap member may include at least one cap arranged to operate between at least one off-state and at least one on-state, to enclose and isolate such a tip from an exterior of the case in its off-state, and to expose the tip to the exterior in the on-state. Such a writing tool may also include at least one actuator member arranged to operate the cap from one to the other of the off- and on-states.

In another exemplary embodiment of this aspect of such an invention, a writing tool may have at least one case member, at least one cartridge member, and at least one cap member. Such a case member may be arranged to provide a grip to an user, to include at least one case defining an interior therein, to form an opening in one end thereof in order to provide fluid communication between such an interior and an exterior of the case, and to operate between at least one rest position and at least one use position. The cap member may include at least one cap arranged to operate between at least one off-state and at least one on-state, where the cap in the off-state may be arranged to obstruct at least a substantial portion of the opening and to prevent the fluid communication through the opening, while the cap in the on-state may be arranged to clear such a portion of the opening and to provide the fluid communication through the opening. Such a cartridge member may be arranged to be at least partially disposed inside the interior, to contain the marking substance therein, to include a tip by which the user is arranged to apply the marking substance onto the article, and to operate between at least one rest position and at least one use position. The writing tool may also include at least one actuator member. In one example, such an actuator member may be arranged to manipulate the cap member, to manipulate at least one of the case and cartridge members directly or indirectly, to maintain the cap in the off-state while keeping at least one of the case and cartridge members in the rest position, and to operate the cap to the on-state while moving at least one of the case and cartridge members to the use position. In another example, the actuator member may instead be arranged to manipulate the cap member, to manipulate at least one of the case and cartridge members directly or indirectly, to keep at least one of the case and cartridge members in the rest position while keeping the cap in the off-state, and to operate at least one of the case and cartridge members to the use position while operating the cap to the on-state.

In another exemplary embodiment of this aspect of such an invention, a writing tool may have at least one case member, at least one cartridge member, and at least one cap member. Such a case member may be arranged to provide a grip to an user, to include at least one case defining an interior therein, to define an opening in one end thereof for providing fluid communication between the interior and an exterior of such a case, and to operate between at least one rest position and at least one use position. The cap member may include at least one cap arranged to operate between at least one off-state and at least one on-state, where such a cap in its off-state may be arranged to obstruct at least a substantial portion of the opening and to prevent the fluid communication through the opening, while the cap in the on-state may be arranged to clear such a portion of the opening and to provide the fluid communication through the opening. Such a cartridge member may be arranged to be at least partially disposed inside the interior, to contain the marking substance therein, and to include a tip by which the user is arranged to apply such marking substance onto the article. Such a writing tool may include at least one actuator member. In one example, the actuator member may be arranged to manipulate the case and cap members directly or indirectly, to keep such a cap in its off-state while keeping the case member in the rest position, and to move the cap to the on-state while moving the case member to the use position. In another example, the actuator member may be arranged to manipulate the case and cap members directly or indirectly, to maintain the case member in the rest position while keeping the cap in the off-state, and to operate the case member to the use position while moving the cap to the on-state.

In another aspect of the present invention, various capless writing tools may also be provided to apply marking substances onto an article, while reducing or minimizing leakage of such substances therethrough.

In one exemplary embodiment of this aspect of the present invention, a writing tool may include at least one cartridge member, at least one case member, at least one cap member, as well as at least one absorber unit. The cartridge member may be arranged to keep the marking substance therein and to include a tip with which the user may be arranged to apply such marking substance onto the article. The case member may be arranged to retain at least a portion of the cartridge member and to form an opening to expose the tip of the cartridge member therethrough. The cap member may include at least one cap which is arranged to operate between at least one off-state and at least one on-state, to respectively obstruct and clear the opening in the off- and on-states, and to respectively prevent and provide the fluid communication through the opening in the off- and on-states. In one example, the absorber unit may be arranged to be fixedly or movably coupled to at least one of such members and to absorb such marking substance which is leaked out of the cartridge member, thereby minimizing the leakage of the marking substance out of the writing tool. In another example, the absorber unit may be arranged to disposed adjacent to at least one of such members and to absorb the marking substance leaked from the cartridge member, thereby minimizing the leakage of the marking substance out of the writing tool. Such a writing tool may optionally be arranged so that the case member may be arranged to receive input force applied by an user and to operate the cap from one to the other of the off- and on-states by transmitting at least a portion of such input force to the cap directly or indirectly, thereby enclosing and isolating the tip from an exterior of the tool as the cap may be arranged to obstruct the opening in the off-state and thereby exposing the tip to the exterior as the cap is arranged to clear the opening in the on-state. Such a writing tool may instead be arranged such that the cartridge member may be arranged to receive input force supplied by an user and to move the cap from one to the other of the off- and on-states by transmitting at least a portion of the input force to such a cap indirectly or directly, thereby enclosing and isolating the tip from an exterior of the tool when the cap is arranged to obstruct the opening in the off-state and thereby exposing the tip to the exterior when the cap may be arranged to clear the opening in the on-state.

In another exemplary embodiment of such an aspect of this invention, a writing tool may have at least one cartridge member, at least one case member, at least one cap member, and at least one absorber unit. The cartridge member may be arranged to keep the marking substance therein and to have a tip with which the user may be arranged to apply the marking substance onto the article, while the case member may be arranged to retain at least a portion of such a cartridge member therein. The cap member may include at least one cap arranged to operate between at least one off-state and at least one on-state, to enclose and isolate the tip from an exterior of the writing tool in its off-state, and to expose the tip to the exterior in the on-state. In one example, the absorber unit may be arranged to be fixedly or movably coupled to at least one of such members and to absorb the marking substance which is leaked out of the cartridge member, thereby minimizing the leakage of the marking substance out of the writing tool. In another example, the absorber unit may be arranged to disposed adjacent to at least one of such members and to absorb the marking substance leaked from the cartridge member, thereby minimizing the leakage of such marking substance out of the writing tool. Such a writing tool may optionally be arranged so that the case member may be arranged to receive input force applied by an user and to move the cap from one to the other of the off- and on-states by transmitting at least a portion of the input force to the cap directly or indirectly, thereby enclosing and isolating the tip from an exterior of the tool when the cap is in the off-state and thereby exposing the tip to such an exterior as the cap is in the on-state. Alternatively, such a writing tool may be arranged so that the cartridge member may be arranged to receive input force supplied by an user and to move the cap from one to the other of the off- and on-states by transmitting at least a portion of such input force to such a cap directly or indirectly, thereby enclosing and isolating the tip to an exterior of the tool when the cap is in the off-state and thereby exposing the tip to the exterior when the cap is in the on-state.

In another exemplary embodiment of such an aspect of this invention, such a writing tool may have at least one cartridge member, at least one case member, at least one cap member, at least one actuator member, and at least one absorber unit. The cartridge member may be arranged to keep the marking substance therein and to have a tip by which the user may be arranged to apply the marking substance onto the article. Such a case member may be arranged to retain at least a portion of such a cartridge member and to define an opening capable of exposing the tip of the cartridge member therethrough. The cap member may have at least one cap arranged to operate between at least one off-state and at least one on-state, to respectively obstruct and clear the opening in the off- and on-states, and to respectively prevent and provide the fluid communication through the opening in the off- and on-states. In one example, the actuator member may be arranged to manipulate the cap member directly or indirectly, to keep the cap in the off-state when the user does not use the writing tool, and to operate the cap to the on-state as the user uses the writing tool. In another example, the actuator member may be arranged to manipulate such a cap member and at least one of the case and cartridge members directly or indirectly, to keep the cap in the off-state while keeping at least one of such case and cartridge members in the rest position, and then to operate the cap to the on-state while moving at least one of the case and cartridge members to the use position. In yet another example, the actuator member may be arranged to manipulate such a cap member and at least one of the case and cartridge members directly or indirectly, to maintain at least one of such case and cartridge members in the rest position while keeping such a cap member in the off-state, and to operate at least one of the case and cartridge members to the use position while operating the cap to the on-state. For each of the above examples, the absorber unit may be arranged to be fixedly or movably coupled to at least one of such members and to absorb the marking substance which is leaked out of the cartridge member, thereby minimizing the leakage of the marking substance out of the writing tool. Alternatively, the absorber unit may be arranged to be disposed adjacent to at least one of such members, and to absorb the marking substance leaked from the cartridge member, thereby minimizing the leakage of the marking substance out of the writing tool.

In another exemplary embodiment of such an aspect of this invention, such a writing tool may have at least one cartridge member, at least one case member, at least one cap member, at least one actuator member, and at least one absorber unit. The cartridge member may be arranged to keep the marking substance therein and to include a tip with which the user is arranged to apply such marking substance onto the article, while the case member may be arranged to retain therein at least a portion of the cartridge member. The cap member may include at least one cap arranged to operate between at least one off-state and at least one on-state, to enclose and isolate the tip from an exterior of such a writing tool in the off-state, and to expose the tip to the exterior in the on-state. In one example, the actuator member may be arranged to manipulate the cap member directly or indirectly, to keep the cap in the off-state when the user does not use such a writing tool, and to operate the cap to the on-state when the user uses the writing tool. In another example, such a actuator member may be arranged to manipulate the cap member and at least one of such case and cartridge members directly or indirectly, to maintain the cap in the off-state while keeping at least one of the case and cartridge members in the rest position, and to move the cap to the on-state while moving at least one of the case and cartridge members to the use position. In another example, the actuator member may be arranged to manipulate the cap member and at least one of such case and cartridge members directly or indirectly, to keep at least one of the case and cartridge members in the rest position while keeping such a cap member in the off-state, and to operate at least one of the case and cartridge members to the use position while operating the cap to its on-state. For each of the above examples, the absorber unit may be arranged to fixedly or movably couple with at least one of such members and to absorb the marking substance which is leaked out of the cartridge member, thereby minimizing the leakage of the marking substance out of the writing tool. In the alternative, the absorber unit may be arranged to disposed adjacent to at least one of such members and to absorb such marking substance leaked from the cartridge member, thereby minimizing the leakage of the marking substance out of the writing tool.

In another aspect of the present invention, various capless writing tools may also be provided to apply marking substances onto an article, while minimizing evaporation of such marking substances during a period of nonuse of such tools.

In one exemplary embodiment of such an aspect of this invention, such a writing tool may have at least one cartridge member, at least one case member, at least one cap member, as well as at least one divider. The cartridge member may be arranged to contain such marking substance therein and to have a tip with which the user may be arranged to apply the marking substance onto the article. The case member may be arranged to define an interior to retain at least a portion of the cartridge member therein and to define an opening capable of exposing the tip of the cartridge member therethrough. The cap member may include at least one cap arranged to operate between at least one off-state and at least one on-state, to respectively obstruct and clear such an opening in its off- and on-states, and to respectively prevent and provide such fluid communication through the opening in the off- and on-states. The divider may be arranged to be fixedly or movably disposed in the interior and to partition a portion of the interior into an inner space in which the tip may be disposed during the period in which the opening may be obstructed by the cap in the off-state, thereby minimizing a space into which such marking substance is to evaporate from the tip. Such a writing tool may optionally be arranged so that the case member may be arranged to receive input force applied by an user and to move the cap from one to the other of the off- and on-states by transmitting at least a portion of the input force to the cap directly or indirectly, thereby enclosing and isolating the tip from an exterior of the tool when the cap is arranged to obstruct the opening in the off-state and thereby exposing the tip to the exterior when the cap is arranged to clear the opening in the on-state. Such a writing tool may alternatively arranged so that the cartridge member may be arranged to receive input force supplied by an user and to move the cap from one to the other of the off- and on-states by transmitting at least a portion of the input force to the cap directly or indirectly, thereby enclosing and isolating the tip from an exterior of the writing tool as the cap is arranged to obstruct the opening in the off-state and thereby exposing the tip to the exterior when the cap is arranged to clear the opening in the on-state.

In another exemplary embodiment of such an aspect of this invention, a writing tool may have at least one cartridge member, at least one case member, at least one cap member, as well as at least one divider. Such a cartridge member may be arranged to keep the marking substance therein and to include a tip with which the user is arranged to apply the marking substance onto the article, whereas the case member may be arranged to define an interior for retaining at least a portion of the cartridge member therein. The cap member may include at least one cap arranged to operate between at least one off-state and at least one on-state, to enclose and isolate the tip from an exterior of the tool in the off-state, and to expose the tip to the exterior in the on-state. Such a divider may be arranged to be fixedly or movably disposed in the interior and to partition a portion of the interior into an inner space in which the tip is disposed during the period in which the tip is enclosed and isolated from the exterior in the off-state, thereby minimizing a space into which such marking substance is to evaporate from the tip. The writing tool may optionally be arranged so that the case member may be arranged to receive input force applied by an user and to move the cap from one to the other of the off- and on-states by transmitting at least a portion of the input force to the cap directly or indirectly, thereby enclosing and isolating the tip from an exterior of the tool when the cap is arranged to obstruct the opening in its off-state and thereby exposing the tip to the exterior as the cap is arranged to clear the opening in the on-state. Such a writing tool may instead be arranged so that the cartridge member may be arranged to receive input force supplied by an user and to move the cap from one to the other of the off- and on-states by transmitting at least a portion of such input force to such a cap directly or indirectly, thereby enclosing and isolating the tip from an exterior of the tool when the cap may be arranged to obstruct the opening in the off-state and thereby exposing the tip to the exterior as the cap may be arranged to clear the opening in the on-state.

In another exemplary embodiment of such an aspect of this invention, a writing tool may also have at least one cartridge member, at least one case member, at least one cap member, at least one divider, and at least one actuator member. The cartridge member may be arranged to keep therein the marking substance and to include a tip with which the user may apply the marking substance onto the article. The case member may be arranged to define an interior capable of retaining therein at least a portion of the cartridge member and to define an opening to expose the tip therethrough. Such a cap member may include at least one cap arranged to operate between at least one off-state and at least one on-state, to obstruct and clear the opening in its off- and on-states, respectively, and to prevent and provide such fluid communication through such an opening in the off- and on-states, respectively. The divider may be arranged to be fixedly or movably disposed inside such an interior and to partition a portion of the interior into an inner space in which the tip is disposed during the period in which the opening is obstructed by the cap in the off-state, thereby minimizing a space into which such marking substance may have to evaporate from the tip. In one example, the actuator member may be arranged to manipulate the cap member directly or indirectly, to maintain the cap in its off-state as the user does not use the writing tool, and to operate the cap to the on-state when the user uses the writing tool. In another example, the actuator member may be arranged to manipulate such a cap member and at least one of the case and cartridge members directly or indirectly, to maintain the cap in the off-state while keeping at least one of the case and cartridge members in the rest position, and to operate such a cap to the on-state while moving at least one of such case and cartridge members to the use position. In another example, the actuator member may be arranged to manipulate such a cap member and at least one of the case and cartridge members directly or indirectly, to maintain at least one of the case and cartridge members in the rest position while keeping the cap member in the off-state, and to operate at least one of the case and cartridge members to the use position while operating such a cap to the on-state.

In another exemplary embodiment of such an aspect of this invention, a writing tool may also have at least one cartridge member, at least one case member, at least one cap member, at least one divider, and at least one actuator member. The cartridge member may be arranged to keep therein the marking substance and to have a tip with which the user is arranged to apply the marking substance onto the article, while the case member may be arranged to define an interior to retain therein at least a portion of the cartridge member therein. The cap member may include at least one cap arranged to operate between at least one off-state and at least one on-state, to enclose and isolate the tip from an exterior of such a writing tool in the off-state, and to expose the tip to the exterior in the on-state. The divider may be arranged to be fixedly or movably disposed inside the interior and to partition a portion of the interior into an inner space in which the tip may be disposed during such a period in which such a tip is enclosed and isolated from the exterior in the off-state, thereby minimizing a space into which the marking substance may have to evaporate from the tip. In one example, the actuator member may be arranged to manipulate the cap member directly or indirectly, to keep the cap in the off-state when the user does not use the writing tool, and to operate the cap to the on-state when the user uses the writing tool. In another example, the actuator member may be arranged to manipulate the cap member and at least one of such case and cartridge members directly or indirectly, to maintain the cap in such an off-state while maintaining at least one of the case and cartridge members in the rest position, and to operate such a cap to the on-state while moving at least one of the case and cartridge members to the use position. In yet another example, the actuator member may be arranged to manipulate the cap member and at least one of the case and cartridge members directly or indirectly, to keep at least one of the case and cartridge members in the rest position while keeping the cap member in the off-state, and to operate at least one of the case and cartridge members to the use position while operating the cap to the on-state.

In another aspect of the present invention, various capless writing tools may also be provided to apply marking substances onto an article.

In one exemplary embodiment of this aspect of the present invention, a writing tool may include at least one cartridge member, at least one case member, and at least one cap member. The cartridge member may be arranged to keep therein the marking substance and to have a tip with which the user may be arranged to apply the marking substance onto the article. The case member may be arranged to define an interior for retaining at least a portion of such a cartridge member therein and to define an opening capable of exposing the tip of the cartridge member therethrough. The cap member may include at least one track and at least one cap, where the cap may be arranged to operate between at least one off-state and at least one on-state while being guided by the track and maintaining an airtight sealing with the track in and/or near the off-state, to obstruct and clear at least a substantial portion of the opening in the off- and on-states, respectively, and to prevent and provide the fluid communication through such a portion of the opening in the off- and on-states, respectively. Such a writing tool may optionally be arranged so that the case member may be arranged to receive input force applied by an user and then to move the cap from one to the other of the off- and on-states by transmitting at least a portion of such input force to the cap directly or indirectly, thereby enclosing and isolating the tip from an exterior of the tool when the cap is arranged to obstruct the opening in the off-state and thereby exposing the tip to the exterior as the cap is arranged to clear the opening in the on-state. The writing tool may instead be arranged so that the cartridge member is arranged to receive input force supplied by an user and to move the cap from one to the other of the off- and on-states by transmitting at least a portion of the input force to the cap directly or indirectly, thereby enclosing and isolating the tip from an exterior of the tool when the cap is arranged to obstruct the opening in the off-state and thereby exposing the tip to the exterior when the cap is arranged to clear the opening in the on-state.

In another exemplary embodiment of such an aspect of this invention, a writing tool may also have at least one cartridge member, at least one case member, and at least one cap member. Such a cartridge member may be arranged to keep therein the marking substance and to have a tip by which the user may be arranged to apply the marking substance onto the article, while the case member may be arranged to define an interior for retaining at least a portion of the cartridge member therein. Such a cap member may include at least one track and at least one cap which is arranged to move between at least one off-state and at least one on-state while being guided by the track and while maintaining an airtight sealing with such a track in and/or near the off-state, to enclose and isolate the tip from an exterior of the writing tool in the off-state, and to expose the tip to the exterior in the on-state. Such a writing tool may be arranged such that the case member is arranged to receive input force applied by an user and to move the cap from one to the other of the off- and on-states by transmitting at least a portion of such input force to the cap directly or indirectly, thereby enclosing and isolating the tip from an exterior of the tool when the cap is arranged to obstruct the opening in the off-state and thereby exposing the tip to the exterior as the cap is arranged to clear the opening in the on-state. The writing tool may instead be arranged so that the cartridge member is arranged to receive input force supplied by an user and to move the cap from one to the other of the off- and on-states by transmitting at least a portion of the input force to the cap directly or indirectly, thereby enclosing and isolating the tip from an exterior of the tool as the cap is arranged to obstruct such an opening in the off-state and thereby exposing the tip to the exterior when the cap is arranged to clear the opening in the on-state.

In another exemplary embodiment of such an aspect of this invention, a writing tool may also have at least one cartridge member, at least one case member, at least one cap member, and at least one actuator member. The cartridge member may be arranged to keep therein the marking substance and to have a tip with which the user is arranged to apply the marking substance onto the article. The case member may be arranged to define an interior to retain at least a portion of the cartridge member therein and to define an opening to expose the tip of the cartridge member therethrough. The cap member may include at least one track and at least one cap which may be arranged to move between at least one off-state and at least one on-state while being guided by such a track and maintaining an airtight sealing with the track in and/or near the off-state, to obstruct and clear at least a substantial portion of the opening in the off- and on-states, respectively, and then to prevent and provide the fluid communication through the portion of such an opening in the off- and on-states, respectively. In one example, the actuator member may be arranged to manipulate the cap member directly or indirectly, to keep such a cap in the off-state when the user does not use the writing tool, and to operate the cap to its on-state when the user uses the writing tool. In another example, the actuator member may be arranged to manipulate the cap member and at least one of the case and cartridge members directly or indirectly, to maintain the cap in the off-state while maintaining at least one of such case and cartridge members in the rest position, and then to move the cap to the on-state while moving at least one of the case and cartridge members to its use position. In another example, the actuator member may also be arranged to manipulate the cap member and at least one of the case and cartridge members directly or indirectly, to keep at least one of the case and cartridge members in the rest position while keeping the cap member in the off-state, and to operate at least one of the case and cartridge members to the use position while operating the cap to the on-state.

In another exemplary embodiment of such an aspect of this invention, a writing tool may also have at least one cartridge member, at least one case member, at least one cap member, and at least one actuator member. The cartridge member may be arranged to keep therein the marking substance and to have a tip with which the user is arranged to apply the marking substance onto the article. The case member may be arranged to define an interior to retain at least a portion of the cartridge member therein. The cap member may include at least one track and at least one cap which may be arranged to move between at least one off-state and at least one on-state while being guided by the track and while maintaining an airtight sealing with the track in and/or near the off-state, to encircle and isolate the tip from an exterior of the writing tool in the off-state, and then to expose the tip to the exterior in the on-state. In one example, the actuator member may be arranged to manipulate such a cap member directly or indirectly, to keep the cap in the off-state when the user does not use the writing tool, and then to operate the cap to the on-state when the user uses the writing tool. In another example, such an actuator member may be arranged to manipulate the cap member and at least one of the case and cartridge members directly or indirectly, to keep the cap in the off-state while keeping at least one of the case and cartridge members in the rest position, and to move the cap to the on-state while moving at least one of the case and cartridge members to the use position. In another example, the actuator member may be arranged to manipulate such a cap member and at least one of the case and cartridge members directly or indirectly, to maintain at least one of the case and cartridge members in the rest position while maintaining such a cap member in its off-state, and to move at least one of the case and cartridge members to the use position while operating the cap to the on-state.

In another aspect of the present invention, various capless writing tools may also be provided to apply a marking substance onto an article.

In one exemplary embodiment of this aspect of the present invention, a writing tool may include at least one cartridge member, at least one case member, and at least one cap member. The cartridge member may be arranged to keep the marking substance therein and to have a tip with which the user may be arranged to apply the marking substance onto the article. The case member may be arranged to have an interior to retain at least a portion of the cartridge member therein and to define an opening to expose the tip of the cartridge member therethrough. The cap member may include at least one cap which is arranged to operate between at least one off-state and at least one on-state, to define a first shape capable of obstructing at least a substantial portion of the opening and preventing the fluid communication through the portion of the opening in the off-state, and to have a second shape which is arranged to be different from the first shape and which is capable of clearing such a portion of the opening and providing the fluid communication therethrough in the on-state. Such a writing tool may be arranged so that the case member may be arranged to receive input force applied by an user and to move the cap from one to the other of the off- and on-states by transmitting at least a portion of the input force to the cap directly or indirectly, thereby enclosing and isolating such a tip from an exterior of the tool when the cap is arranged to obstruct the opening in the off-state and thereby exposing the tip to the exterior when the cap is arranged to clear the opening in the on-state. The writing tool may instead be arranged so that the cartridge member may be arranged to receive input force supplied by an user and to move the cap from one to the other of the off- and on-states by transmitting at least a portion of the input force to the cap directly or indirectly, thereby enclosing and isolating the tip from an exterior of the writing tool when the cap is arranged to obstruct the opening in the off-state and thereby exposing the tip to the exterior when the cap is arranged to clear the opening in the on-state.

In another exemplary embodiment of such an aspect of this invention, a writing tool may rather include at least one cartridge member, at least one case member, and at least one cap member. Such a cartridge member may be arranged to keep such marking substance therein and to include a tip with which the user is arranged to apply the marking substance onto the article. The case member may be arranged to define an interior for retaining at least a portion of the cartridge member therein. The cap member may include at least one cap arranged to operate between at least one off-state and at least one on-state, to define a first shape which may be capable of enclosing and isolating the tip from an exterior of the tool in the off-state, and to have a second shape which may be different from the first shape and which may be capable of exposing the tip to the exterior in its on-state. Such a writing tool may be arranged so that the case member may be arranged to receive input force applied by an user and to move the cap from one to the other of the off- and on-states by transmitting at least a portion of the input force to the cap directly or indirectly, thereby enclosing and isolating the tip from an exterior of the tool in the off-state and thereby exposing the tip to the exterior in the on-state. Such a writing tool may be arranged so that the cartridge member may be arranged to receive input force supplied by an user and to move the cap from one to the other of the off- and on-states by transmitting at least a portion of the input force to the cap directly or indirectly, thereby enclosing and isolating the tip from an exterior of the tool in the off-state and thereby exposing the tip to the exterior in the on-state.

In another exemplary embodiment of such an aspect of this invention, a writing tool may have at least one cartridge member, at least one case member, at least one cap member, as well as at least one actuator member. The cartridge member may be arranged to keep the marking substance therein and to have a tip with which the user is arranged to apply the marking substance onto the article. The case member may be arranged to define an interior to retain at least a portion of the cartridge member therein and to define an opening to expose the tip of the cartridge member therethrough. The cap member may include at least one cap arranged to operate between at least one off-state and at least one on-state, to have a first shape capable of obstructing at least a substantial portion of the opening and preventing the fluid communication through the portion of the opening in the off-state, and to have a second shape which is arranged to be different from the first shape and capable of clearing such a portion of the opening as well as providing the fluid communication therethrough in its on-state. In one example, the actuator member may be arranged to manipulate the cap member directly or indirectly, to keep the cap in its off-state when the user does not use the writing tool, and to operate such a cap to its on-state when the user uses such a writing tool. In another example, the actuator member may be arranged to manipulate the cap member and at least one of the case and cartridge members indirectly and directly, to keep the cap in the off-state while maintaining at least one of such case and cartridge members in the rest position, and to move the cap to its on-state while moving at least one of the case and cartridge members to the use position. In another example, the actuator member may be arranged to manipulate the cap member and at least one of the case and cartridge members either indirectly or directly, to keep at least one of the case and cartridge members in the rest position while keeping the cap member in the off-state, and to move at least one of the case and cartridge members to the use position while operating the cap to the on-state.

In another exemplary embodiment of such an aspect of this invention, a writing tool may have at least one cartridge member, at least one case member, at least one cap member, as well as at least one actuator member. The cartridge member may be arranged to keep the marking substance therein and to have a tip with which the user is arranged to apply the marking substance onto the article. The case member may be arranged to define an interior to retain at least a portion of the cartridge member therein. The cap member may include at least one cap arranged to operate between at least one off-state and at least one on-state, to define a first shape which is capable of enclosing and isolating the tip from an exterior of the tool in the off-state, and to define a second shape which may be different from such a first shape and capable of exposing the tip to the exterior in its on-state. In one example, the actuator member may be arranged to manipulate the cap member directly or indirectly, to keep the cap in the off-state when the user does not use the writing tool, and then to operate the cap to its on-state when the user uses the writing tool. In another example, the actuator member may be arranged to manipulate the cap member and at least one of the case and cartridge members either indirectly or directly, to keep the cap in the off-state while keeping at least one of the case and cartridge members in the rest position, and to move such a cap to the on-state while moving at least one of the case and cartridge members to the use position. In another example, the actuator member may be arranged to manipulate the cap member and at least one of the case and cartridge members directly or indirectly, to maintain at least one of the case and cartridge members in the rest position while keeping the cap member in the off-state, and then to move at least one of the case and cartridge members to the use position while operating the cap to the on-state.

In another aspect of the present invention, various capless writing tools may be provided to be capable of receiving at least one cartridge member containing at least one marking substance therein, including at least one tip, and applying the marking substance onto an article by the tip.

In one exemplary embodiment of such an aspect of this invention, a writing tool may include at least one case member and at least one cap member. The case member may be arranged to define a grip for an user, to have multiple cases forming therein an inner space in at least a substantial number thereof, and to define an opening for providing fluid communication between such an inner space and an exterior of the cases. At least one of such cases may be arranged to receive user input force and to generate at least one of curvilinear movement in response to such force from one to the other of at least one rest position and at least one use position. Such a cap member may include at least one cap which may be arranged to be fixedly or movably coupled to at least one of such cases and to operate from one to the other of at least one off-state and at least one on-state in response to the movement. Such a cap may be arranged to obstruct the opening, to prevent the fluid communication therethrough, and to enclose the inner space in the off-state, while such a cap may also be arranged to clear such an opening and to allow the fluid communication therethrough in the on-state. Thereby, the writing tool which may be provided with the cartridge member may be capable of isolating the tip from the exterior when the case is in the rest position and the cap is in the off-state, and capable of exposing the tip to the exterior when the case is in the use position and the cap is in the on-state.

In another exemplary embodiment of such an aspect of this invention, a writing tool may have at least one case member and at least one cap member. The case member may be arranged to define a grip for an user, to include at least one case which may be arranged to form an inner space therein and to move between at least one rest position and at least one use position, and to define an opening arranged to provide fluid communication between the inner space and an exterior of the cases. Such a cap member may include at least one cap which is arranged to operatively couple with the case and to operate from one to the other of at least one off-state and at least one on-state in response to user input force. Such a cap is arranged to move the case to the rest position, to obstruct the opening, to block the fluid communication therethrough, and to enclose the inner space in the off-state, while such a cap is arranged to move the case to the use position, to clear the opening, and to provide such fluid communication therethrough in the on-state. Thereby and in one example, such a writing tool provided with the cartridge member is capable of isolating the tip from the exterior when the cap is arranged to be in the off-state and to keep the case member in the rest position, and capable of exposing the tip to the exterior when the cap is arranged to be in the on-state and to manipulate the case member in the use position. Thereby and in another example, the cartridge member is arranged to move between at least one rest position and at least one use position, and the writing tool which is provided with such a cartridge member is capable of isolating the tip from the exterior when the cap is arranged to be in the off-state and to keep the cartridge member in the rest position, and capable of exposing the tip to the exterior when the cap is arranged to be in the on-state and to manipulate the cartridge member in the use position. Thereby and in another example, the cartridge member may be arranged to operate between at least one rest position and at least one use position, and the writing tool provided with the cartridge member is capable of isolating the tip from the exterior when the cap is arranged to be in the off-state and to keep the case and cartridge members in the rest positions, and capable of exposing the tip to the exterior as the cap is arranged to be in the on-state and to keep the case and cartridge members in the use position.

In another exemplary embodiment of such an aspect of this invention, a writing tool may have at least one case member, at least one cap member, and at least one actuator member. Such a case member may be arranged to define a grip for an user, to include at least one case arranged to form an inner space therein and to move between at least one rest position and at least one use position, and to define an opening arranged to provide fluid communication between the inner space and an exterior of the cases. Such a cap member may include at least one cap arranged to fixedly or movably couple with the case and to operate between at least one off-state and at least one on-state, where the cap is arranged to obstruct the opening, to prevent the fluid communication therethrough, and to enclose the inner space in the off-state, while the cap is arranged to clear the opening and to provide the fluid communication therethrough in the on-state. In one example, the actuator member may be arranged to be operatively coupled to the case member, to receive user input force, and to move the case member from one to the other of the rest and use positions in response to the input force, where such a case member may be arranged to move the cap from one to the other of the off- and on-states. In another example, the actuator member may be arranged to operatively couple with the cap member, to receive user input force, and to operate the cap from one to the other of the off- and on-states in response to the input force, where such a cap member may be arranged to operate the case member from one to the other of the rest and use positions. In another example, the actuator member may be arranged to operatively couple with both of the case and cap members, to receive user input force, and to operate the case member from one to the other of the rest and use positions and to operate the cap from one to the other of the off- and on-states in response to the user input force. Thereby and in all of these examples, the writing tool which is provided with the cartridge member may be capable of isolating the tip from the exterior when the case member is in the rest position and when the cap is in the off-state, and capable of exposing the tip to the exterior when the case member is in the use position and when the cap is in the on-state.

In another exemplary embodiment of such an aspect of this invention, a writing tool may have at least one case member and at least one cap member. The case member may be arranged to define a grip for an user, to have at least one case forming an inner space therein, and to define an opening arranged to provide fluid communication between the inner space and an exterior of the case. Such a cap member may include at least one cap arranged to fixedly or movably couple with the opening and to operate from one to the other of at least one off-state and at least one on-state in response to user input force. Such a cap in the off-state may be arranged to obstruct the opening, to prevent the fluid communication therethrough, and to enclose such an inner space, while the cap may be arranged to clear the opening and to provide the fluid communication through the opening in the on-state. Thereby, such a writing tool provided with the cartridge member may be capable of isolating such a tip from the exterior when the case member is in the rest position and the cap is in the off-state, and also capable of exposing the tip to the exterior when the case is in the use position and the cap is in the on-state.

In another aspect of the present invention, various cap members may be arranged so that they may be capable of enclosing an inner space defined inside a case of a writing tool and isolating such an inner space from an exterior of the case when the writing tool is not in use by an user and capable of fluidly communicating the inner space with the exterior through an opening which is defined in such a case when the writing tool is in use by the user.

In one exemplary embodiment of such an aspect of this invention, a cap member may include a single cap which may be arranged to be at least partially supported by such a case and to be movably disposed inside the inner space. Such a cap may be arranged to rotate, translate, and/or deform between at least one off-state and at least one on-state, to obstruct at least a substantial portion of the opening and to enclose the inner space in the off-state, and to clear the portion of the opening and to fluidly communicate the inner space with the exterior in the on-state.

In another exemplary embodiment of such an aspect of this invention, a cap member may have a single cap which may be arranged to be at least partially supported by the case so as to be movably disposed inside the inner space. The cap may be arranged to translate between at least one off-state and at least one on-state across the opening, to obstruct at least a substantial portion of the opening and to enclose the inner space in the off-state, and to clear the portion of the opening and to provide fluid communication between the inner space and the exterior in the on-state.

In another exemplary embodiment of such an aspect of this invention, a cap member may have a single cap which may be arranged to be at least partially supported by the case so as to be movably disposed inside the inner space. Such a cap may be arranged to rotate and/or pivot between at least one off-state and at least one on-state along a direction at least partially parallel with the opening, to obstruct at least a substantial portion of the opening and enclose the inner space in the off-state, and to clear the portion of the opening and fluidly communicate the inner space with the exterior in the on-state.

In another exemplary embodiment of such an aspect of this invention, a cap member may have a single cap which may be arranged to be at least partially supported by the case so as to be movably disposed in the inner space. Such a cap may be arranged to rotate and/or pivot between at least one off-state and at least one on-state about an axis of rotation which is defined along at least one edge of the opening, to obstruct at least a substantial portion of the opening and enclose the inner space in the off-state, and to clear the portion of the opening and fluidly communicate the inner space with the exterior in the on-state.

In another exemplary embodiment of such an aspect of this invention, a cap member may have a single cap which may be arranged to be at least partially supported by the case so as to be movably disposed inside the inner space. Such a cap may be arranged to translate, rotate, and/or pivot radially toward and away from the opening between at least one off-state and at least one on-state, to block or obstruct at least a substantial portion of the opening and to enclose the inner space in the off-state, and to clear the portion of the opening and provide fluid communication between the inner space and the exterior in the on-state.

In another exemplary embodiment of such an aspect of this invention, a cap member may have a single cap which may be arranged to be at least partially supported by the case so as to be movably disposed inside the inner space. Such a cap may be arranged to translate, rotate, and/or pivot along a circumferential or radial direction around the opening between at least one off-state and at least one on-state, to block at least a substantial portion of the opening and enclose the inner space in the off-state, and to clear the portion of the opening and fluidly communicate the inner space with the exterior in the on-state.

In another exemplary embodiment of such an aspect of this invention, a cap member may have a single cap which may be arranged to be at least partially supported by the case so as to be movably disposed inside the inner space. Such a cap may be arranged to define at least one hole therealong, to rotate and/or pivot between at least one off-state and at least one on-state, to obstruct at least a substantial portion of the opening and enclose the inner space in the off-state by misaligning the hole with the opening, and to clear the portion of the opening and fluidly communicate the inner space with the exterior in the on-state by aligning the hole with the opening.

In another exemplary embodiment of such an aspect of this invention, a cap member may have at least one track and a single cap. The track may be arranged to be defined in the inner space, while the cap may be arranged to be disposed inside the inner space, to be movably coupled to the track, to rotate, translate, and/or deform while being guided by such a track between at least one off-state and at least one on-state, to obstruct at least a substantial portion of the opening whereby enclosing such an inner space in the off-state, and to clear the portion of the opening and forming fluid communication between the inner space and exterior in the on-state.

In another exemplary embodiment of such an aspect of this invention, a cap member may have a single cap which may be arranged to be disposed inside the inner space, to rotate, translate, and/or deform between at least one off-state and at least one on-state, to block at least a substantial portion of the opening and to enclose the inner space in the off-state while defining a first shape and a first size, and to clear the portion of the opening and fluidly communicate the inner space with the exterior in the on-state while defining a second shape and a second size at least one of which is arranged to be different from the first shape and first size, respectively.

Embodiments of this aspect of the invention may include one or more of the following features.

The above cap may be arranged to fixedly couple with the case and, therefore, to be unable to be replaced by another cap. Alternatively, the above cap may be arranged to be releasably coupled to the case and to be replaceable by another cap. The cap member may include at least one absorber unit arranged to be disposed adjacent to and/or in the cap and/or opening and to absorb fluid therein, thereby minimizing presence of the liquid in the writing tool. The cap member may also include at least one recoil unit which may be arranged to bias at least a portion of the cap toward the opening in such an off-state, thereby enhancing airtight sealing between the cap and opening and isolation of the inner space from the exterior in its off-state. The cap member may be arranged to operate with at least one actuator which may be arranged to synchronize the case with the cap, where the case is arranged to move between at least one rest position and at least one use position. Thus, such an actuator may be arranged to synchronize movement of the case from one to the other of the rest and use positions with another movement of the cap from one to the other of the off- and on-states. Alternatively, such a cap member may be arranged to operate with at least one actuator arranged to synchronize the cap with the case, where the case is arranged to operate between at least one rest position and at least one use position. Accordingly, such an actuator may similarly be arranged to synchronize movement of the cap from one to the other of its off- and on-states with movement of the case from one to the other of the rest and use positions.

In another aspect of the present invention, various cap members may be arranged so that they may be capable of enclosing an inner space defined inside a case of a writing tool and isolating such an inner space from an exterior of the case when the writing tool is not in use by an user and capable of fluidly communicating the inner space with the exterior through an opening which is defined in such a case when the writing tool is in use by the user.

In one exemplary embodiment of such an aspect of this invention, a cap member may include multiple caps at least one of which may be arranged to be at least partially supported by such a case so that the cap member may be movably disposed in the inner space. At least one of such caps may be arranged to rotate, translate, and/or deform with respect to others between at least one off-state and at least one on-state, to obstruct at least a substantial portion of the opening and to enclose the inner space in the off-state, and to clear the portion of the opening and fluidly communicate the inner space with the exterior in the on-state.

In another exemplary embodiment of such an aspect of this invention, a cap member may have multiple caps at least one of which may be arranged to be at least partially supported by the case for being movably disposed in the inner space. At least one of such caps may be arranged to translate with respect to others between at least one off-state and at least one on-state across the opening, to obstruct at least a substantial portion of the opening and enclose the inner space in the off-state, and to clear the portion of the opening and fluidly communicate the inner space with the exterior in the on-state.

In another exemplary embodiment of such an aspect of this invention, a cap member may have multiple caps at least one of which may be arranged to be at least partially supported by the case for being movably disposed in the inner space. At least one of such caps may also be arranged to rotate and/or pivot with respect to the others between at least one off-state and at least one on-state along a direction which is at least partially parallel with the opening, to obstruct at least a substantial portion of the opening and enclose the inner space in the off-state, and to clear the portion of the opening and fluidly communicate the inner space with the exterior in the on-state.

In another exemplary embodiment of such an aspect of this invention, a cap member may have multiple caps at least one of which may be arranged to be at least partially supported by the case for being movably disposed in the inner space. At least one of such caps may also be arranged to rotate and/or pivot with respect to the others between at least one off-state and at least one on-state about a rotation axis defined on at least one edge of the opening, to obstruct at least a substantial portion of the opening and to enclose the inner space in the off-state, and to clear the portion of the opening and fluidly communicate the inner space with the exterior in the on-state.

In another exemplary embodiment of such an aspect of this invention, a cap member may have multiple caps at least one of which may be arranged to be at least partially supported by the case for being movably disposed in the inner space. At least one of such caps may be arranged to translate, rotate, and/or pivot with respect to the others circularly and/or circumferentially around the opening between at least one off-state and at least one on-state, to obstruct at least a substantial portion of the opening and enclose the inner space in the off-state, and to clear the portion of the opening and to fluidly communicate the inner space with the exterior in the on-state.

In another exemplary embodiment of such an aspect of this invention, a cap member may have multiple caps at least one of which may be arranged to be at least partially supported by the case for being movably disposed inside the inner space. At least one of such caps may be arranged to radially translate, rotate, and/or pivot with respect to the others toward and away from the opening between at least one off-state and at least one on-state, to obstruct at least a substantial portion of the opening and enclose the inner space in the off-state, and to clear the portion of the opening and provide fluid communication between the inner space and the exterior in the on-state.

In another exemplary embodiment of such an aspect of this invention, a cap member may have multiple caps at least one of which may be arranged to be at least partially supported by the case for being movably disposed inside the inner space. At least one of such caps may be arranged to define at least one hole therealong, to rotate and/or pivot with respect to the others between at least one off-state and at least one on-state, to obstruct at least a substantial portion of the opening and to enclose the inner space in the off-state by aligning the hole away from the opening, and to clear the portion of the opening and fluidly communicate the inner space with the exterior in the on-state by aligning such a hole with the opening.

In another exemplary embodiment of such an aspect of this invention, a cap member may have at least one track and multiple caps. The track may be arranged to be defined in the inner space, and multiple caps may be arranged to be at least partially supported by the case to be movably disposed in the inner space, while at least one of such caps may be arranged to movably couple with the track, to rotate, translate, and/or deform with respect to the others while being guided by the track between at least one off-state and at least one on-state, to obstruct or block at least a substantial portion of such an opening and enclose the inner space in the off-state, and to clear the portion of the opening and to provide fluid communication between the inner space and exterior in the on-state.

In another exemplary embodiment of such an aspect of this invention, a cap member may have multiple caps at least one of which may be arranged to be at least partially supported by the case for being movably disposed inside the inner space. At least one of such caps may be arranged to rotate, translate, and/or deform with respect to the others between at least one off-state and at least one on-state, to obstruct at least a substantial portion of the opening and enclose the inner space in the off-state while defining a first shape and a first size, and to clear the portion of the opening and to fluidly connect the inner space with the exterior in the on-state while defining a second shape and a second size at least one of which is arranged to be different from the first shape and first size, respectively.

Embodiments of this aspect of the invention may include one or more of the following features.

At least one of the above caps may be arranged to fixedly couple with the case and to not be replaceable by another cap. In the alternative, at least one of the above caps may be arranged to be releasably coupled to the case and to be replaceable by another cap. The cap member may include at least one absorber unit which may be arranged to be disposed close to and/or in at least one of such caps and/or opening and to absorb fluid therein, thereby minimizing presence of the liquid inside such a writing tool. The cap member may include at least one recoil unit which may be arranged to bias at least a portion of at least one of such caps toward the opening in the off-state, thereby enhancing an airtight sealing between the caps and opening and isolation of the inner space from the exterior in the off-state. The cap member may be arranged to operate with at least one actuator which is arranged to synchronize the case with at least one of such caps, where the case may be arranged to operate between at least one rest position and at least one use position. Such an actuator may be arranged to synchronize movement of the case from one to the other of the rest and use positions with another movement of the caps from one to the other of the off- and on-states. Alternatively, the cap member may be arranged to operate with at least one actuator which is arranged to synchronize at least one of such caps with the case, where the case is arranged to operate between at least one rest position and at least one use position. Such an actuator may be arranged to synchronize movement of such caps from one to the other of the off- and on-states with movement of the case from one to the other of the rest and use positions.

In another aspect of the present invention, various cap-actuator assemblies may be fabricated for a writing tool which includes a case having at least one case, defining an inner space therein, and defining an opening in one end thereof.

In one exemplary embodiment of such an aspect of this invention, an assembly may include at least one cap member which may in turn include at least one cap which may be arranged to translate, rotate, and/or deform between at least one off-state and at least one on-state. The cap in its off-state may be arranged to block at least a substantial portion of the opening, to enclose the inner space from an exterior of the case member, and to isolate the tip from the exterior, whereas the cap in its on-state may be arranged to clear the portion of the opening, to fluidly connect the inner space to the exterior, and to expose the tip to the exterior in the on-state.

In another exemplary embodiment of such an aspect of this invention, an assembly may have at least one cap member which may in turn include at least one cap arranged to translate between at least one off-state and at least one on-state. Such a cap in its off-state may be arranged to obstruct at least a substantial portion of the opening, to enclose the inner space from an exterior of the case, and to isolate the tip from the exterior, while such a cap in its on-state may be arranged to clear such a portion of the opening, to fluidly connect the inner space to the exterior, and to expose the tip to the exterior in the on-state.

In another exemplary embodiment of such an aspect of this invention, an assembly may have at least one cap member which may include at least one cap arranged to rotate and/or pivot between at least one off-state and at least one on-state along a direction which is at least partially parallel with the opening. Such a cap may be arranged to obstruct at least a substantial portion of the opening, to enclose the inner space from an exterior of the case, and to isolate the tip from the exterior in the off-state, and arranged to clear the portion of the opening, to form fluid communication between the inner space and the exterior, and to expose the tip to the exterior in the on-state.

In another exemplary embodiment of such an aspect of this invention, an assembly may have at least one cap member which may include at least one cap arranged to rotate and/or pivot between at least one off-state and at least one on-state about a rotation axis disposed on or along at least one edge of the opening. The cap may be arranged to block at least a substantial portion of the opening, to enclose the inner space from an exterior of the case, and to isolate the tip from the exterior in the off-state, whereas the cap may be arranged to clear the portion of the opening, to fluidly connect the inner space to the exterior, and to expose the tip to the exterior in the on-state.

In another exemplary embodiment of such an aspect of this invention, an assembly may have at least one cap member which may have at least one cap arranged to translate, rotate, and/or deform radially toward and away from the opening between at least one off-state and at least one on-state. The cap may be arranged to obstruct at least a substantial portion of the opening, to enclose such an inner space from an exterior of the case, and to isolate the tip from the exterior in the off-state, while the cap may be arranged to clear the portion of the opening, to provide fluid communication between the inner space and the exterior, and to expose the tip to the exterior in the on-state.

In another exemplary embodiment of such an aspect of this invention, an assembly may have at least one cap member which may have at least one cap arranged to translate, rotate, and/or deform circumferentially around at least a portion of the opening between at least one off-state and at least one on-state. Such a cap may be arranged to obstruct at least a substantial portion of the opening, to enclose the inner space from an exterior of the case, and to isolate the tip from the exterior in the off-state, whereas such a cap may be arranged to clear the portion of the opening, to fluidly connect the inner space and the exterior, and to expose the tip to the exterior in the on-state.

In another exemplary embodiment of such an aspect of this invention, an assembly may have at least one cap member which may in turn include at least one cap arranged to define therealong at least one hole, to translate, rotate, and/or deform between at least one off-state and at least one on-state. The cap may be arranged to block at least a substantial portion of the opening, to enclose the inner space from an exterior of the case, and to isolate the tip from the exterior in the off-state in the off-state, while such a cap may be arranged to clear such a portion of the opening, to provide a fluid communication between the inner space and the exterior, and to expose the tip to the exterior in the on-state.

In another exemplary embodiment of such an aspect of this invention, an assembly may have at least one cap member which may in turn have at least one cap arranged to translate, rotate, and/or deform circumferentially around at least a portion of the opening between at least one off-state and at least one on-state. Such a cap may be arranged to block at least a substantial portion of the opening, to enclose the inner space from an exterior of the case member, and to isolate the tip from the exterior in the off-state while defining a first shape and a first size. Such a cap may also be arranged to clear the portion of the opening, to fluidly connect the inner space with the exterior, and to expose the tip to the exterior in the on-state while defining a second shape and a second size, at least one of which is arranged to be different from the first shape and first size, respectively.

In another exemplary embodiment of such an aspect of this invention, an assembly may have at least one cap member which may include at least one track and at least one cap arranged to couple with the track, to translate, rotate, and/or deform while being guided by the track between at least one off-state and at least one on-state. Such a cap may be arranged to block at least a substantial portion of the opening, to enclose the inner space from an exterior of the case, and to isolate the tip from the exterior in the off-state, whereas such a cap may be arranged to clear the portion of the opening, to fluidly connect the inner space with the exterior, and to expose the tip to the exterior in the on-state.

In each of the foregoing embodiments of this aspect of the present invention, the cap-actuator assembly may include at least one actuator arranged to be operatively coupled to the cap, to receive input force from an user directly or indirectly, to transmit at least a portion of the input force to the cap while maintaining or changing an amplitude and/or a direction of the input force, and to operate the cap from one to the other of the off- and on-states.

In another aspect of the present invention, various cap-actuator assemblies may be fabricated for a writing tool having a case member and capable of receiving at least one cartridge member inside the case member, where the case member may form an inner space therein and define an opening in one end thereof, while the cartridge member may contain at least one marking substance therein and include a tip for dispensing the marking substance therethrough.

In one exemplary embodiment of such an aspect of this invention, an assembly may include at least one cap member and at least one actuator member. The cap member may have at least one cap which may be arranged to translate, rotate, and/or deform between at least one off-state and at least one on-state, where the cap in the off-state may be arranged to obstruct at least a substantial portion of the opening, to enclose the inner space from an exterior of the case member, and to isolate the tip from the exterior in the off-state, while the cap in the on-state may be arranged to clear the portion of the opening, to fluidly connect the inner space with the exterior, and to expose the tip to the exterior. Such an actuator member may be arranged to operatively couple with the cap, to directly receive input force from an user and to transmit at least a portion of the input force to the cap while maintaining or changing an amplitude and/or a direction of the input force, thereby moving such a cap from one to the other of the off- and on-states. Thereby, the writing tool which is provided with the cartridge member may be capable of isolating the tip from the exterior when the actuator member manipulates the cap in the off-state, and capable of exposing the tip to the exterior when the actuator member manipulates the cap in the on-state.

In another exemplary embodiment of such an aspect of this invention, an assembly may have at least one cap member which may in turn have at least one cap which may be arranged to translate, rotate, and/or deform between at least one off-state and at least one on-state. Such a cap in the off-state may be arranged to block at least a substantial portion of the opening, to enclose the inner space from an exterior of the case member, and to isolate the tip from the exterior in the off-state, while the cap in the on-state may be arranged to clear such a portion of the opening, to fluidly connect the inner space with the exterior, and to expose the tip to the exterior. In addition, such a case member may be arranged to operatively couple with the cap, to receive input force directly from an user, to transmit at least a portion of the input force to the cap while maintaining or changing an amplitude and/or direction of the input force, and to move the cap from one to the other of the off- and on-states. Thereby, such a writing tool which is provided with the cartridge member may be capable of isolating the tip from the exterior when the case member manipulates the cap in the off-state, and capable of exposing the tip to the exterior when the case member manipulates the cap in the on-state.

In another exemplary embodiment of such an aspect of this invention, an assembly may have at least one cap member which may in turn have at least one cap which may be arranged to translate, rotate, and/or deform between at least one off-state and at least one on-state. Such a cap in the off-state may be arranged to block at least a substantial portion of the opening, to enclose the inner space from an exterior of the case member, and to isolate the tip from the exterior in the off-state, while the cap in the on-state may be arranged to clear such a portion of the opening, to fluidly connect the inner space with the exterior, and to expose the tip to the exterior. In addition, the cartridge member may be arranged to be operatively coupled to the cap, to receive input force directly from an user, to transmit at least a portion of the input force to such a cap while maintaining or changing an amplitude and/or a direction of the input force supplied by the user, and to move the cap from one to the other of the off- and on-states. Thereby, the writing tool which is provided with the cartridge member may be capable of isolating the tip from the exterior when the cartridge member maintains the cap in the off-state, and capable of exposing the tip to the exterior when the case member keeps the cap in the on-state.

In another aspect of the present invention, various cap-actuator assemblies may be fabricated for a writing tool which may have a case member and which may be capable of receiving a cartridge member inside the case member, where such a case member may define an inner space therein and form an opening in one end thereof, whereas the cartridge member may contain at least one marking substance therein and include a tip capable of dispensing the marking substance therethrough. Such an assembly may be capable of receiving input force supplied by an user, enclosing the tip disposed in the inner space when the tool is not in use, and exposing the tip to an exterior of the case member while the tool is used by the user.

In one exemplary embodiment of such an aspect of this invention, an assembly may include at least one cap member and at least one actuator member. The cap member may have at least one cap which may be arranged to translate and/or deform between at least one off-state and at least one on-state. The cap may be arranged to obstruct at least a substantial portion of the opening, to enclose the inner space from an exterior of the case member, and to isolate the tip from the exterior in the off-state, whereas such a cap may be arranged to clear such a portion of the opening, to provide a fluid communication between the inner space and exterior, and to expose the tip to the exterior in the on-state. The actuator member may be arranged to be operatively coupled to the cap, to receive the input force acting along a first path which is arranged to be at least substantially linear directly or indirectly from the user, to transmit at least a portion of the input force to the cap while maintaining or changing an amplitude of the input force, and to operate the cap from one to the other of the off- and on-states along a second path which is arranged to be at least substantially linear. Thereby, such a writing tool which may be provided with the cartridge member may be capable of isolating the tip from the exterior when the actuator member manipulates the cap in the off-state, and capable of exposing the tip to the exterior when the actuator member manipulates the cap in the on-state.

In another exemplary embodiment of such an aspect of this invention, an assembly may have at least one cap member and at least one actuator member. The cap member may include at least one cap which may be arranged to rotate, pivot, and/or deform between at least one off-state and at least one on-state. Such a cap in the off-state may be arranged to obstruct at least a substantial portion of the opening, to enclose the inner space from an exterior of the case member, and to isolate such a tip from the exterior, while the cap in the on-state may be arranged to clear the portion of the opening, to provide fluid communication between the inner space and the exterior, and to expose such a tip to the exterior. Such an actuator member may be arranged to operatively couple with the cap, to receive the input force acting along a first path which may be arranged to be at least substantially linear indirectly or directly from the user, to transmit at least a portion of such input force to the cap while changing a direction of the input force and also while maintaining or varying an amplitude of the input force, and to operate such a cap from one to the other of the off- and on-states along a second path which may be arranged to at least substantially radial, circumferential, and/or curved. Thereby the writing tool which is provided with the cartridge member may be capable of isolating the tip from the exterior when such an actuator member disposes the cap in the off-state, and capable of exposing the tip to the exterior when the actuator member manipulates the cap in the on-state.

In another exemplary embodiment of such an aspect of this invention, an assembly may have at least one cap member and at least one actuator member. The cap member may include at least one cap which may be arranged to translate and/or deform between at least one on-state and at least one off-state. Such a cap in the off-state may be arranged to obstruct at least a substantial portion of the opening, to enclose the inner space from an exterior of the case member, and to isolate the tip from the exterior, while such a cap in the on-state may be arranged to clear such a portion of the opening, to provide fluid communication between the inner space and the exterior, and to expose the tip to the exterior. The actuator member may be arranged to be operatively coupled to the cap, to receive such input force acting along a first path which is arranged to be at least substantially curved, radial, and/or circumferential directly or indirectly from the user, to transmit at least a portion of the input force to the cap while maintaining or varying an amplitude and/or a direction of the input force, and to operate the cap from one to the other of the off- and on-states along a second path which may be arranged to be at least substantially linear. Thereby, such a writing tool which is provided with the cartridge member may be capable of isolating the tip from the exterior when the actuator member manipulates the cap in the off-state, and capable of exposing the tip to the exterior when the actuator member manipulates the cap in the on-state.

In another exemplary embodiment of such an aspect of this invention, an assembly may have at least one cap member and at least one actuator member. The cap member may include at least one cap which may be arranged to rotate, pivot, and/or deform between at least one off-state and at least one on-state. Such a cap in its off-state may be arranged to obstruct at least a substantial portion of the opening, to enclose the inner space from an exterior of the case member, and to isolate such a tip from the exterior, while such a cap in its on-state may be arranged to clear the portion of the opening, to fluid communicate the inner space with the exterior, and to expose the tip to the exterior. Such an actuator member may also be arranged to be operatively coupled to the cap, to receive the input force acting along a first path which may be arranged to be at least substantially circumferential, curved or radial directly or indirectly from the user, to transmit at least a portion of the input force to such a cap while maintaining or varying an amplitude and/or a direction of the input force, and to operate the cap from one to the other of the off- and on-states along a second path which may be arranged to be at least substantially linear. Thereby, such a writing tool which is provided with the cartridge member is capable of isolating the tip from the exterior when the actuator member manipulates the cap in the off-state, and capable of exposing the tip to the exterior when the actuator member manipulates the cap in the on-state.

Embodiments of the above three previous aspects of the present invention may include one or more of the following features.

The above actuator member may be arranged to receive the input force directly from the user. In the alternative, the above case member may be arranged to receive the input force directly from the user and to transmit at least a portion of the input force to the actuator member. In another alternative, the above cartridge member may be arranged to receive the input force directly from the user, and to transmit at least a portion of the input force to the actuator member. Such an actuator member may be arranged to be disposed in the case member, cap member, cartridge member, and the like.

At least one of the above caps may be arranged to fixedly couple with the case and to not be replaceable by another cap. In the alternative, at least one of the above caps may be arranged to be releasably coupled to the case and, accordingly, to be replaceable by another cap. The cap-actuator assembly may be similarly arranged to fixedly couple with the case member and to not be replaceable by another assembly. In the alternative, such an assembly may be arranged to be releasably coupled to the case and, accordingly, to be replaceable by another assembly. The cap member may include at least one absorber unit which may be arranged to be disposed close to and/or in at least one of such caps and/or opening and to absorb fluid therein, thereby minimizing presence of the liquid inside such a writing tool. The cap member may include at least one recoil unit which may be arranged to bias at least a portion of at least one of such caps toward the opening in the off-state, thereby enhancing an airtight sealing between the caps and opening and isolation of the inner space from the exterior in the off-state.

In another aspect of the present invention, various cartridge assemblies may be provided for a writing tool with a case member capable of receiving the cartridge member therethrough and arranged to form an interior therein, where the cartridge assembly may contain at least one marking substance which is capable of leaving marks onto an article.

In one exemplary embodiment of such an aspect of the present invention, a cartridge assembly may include at least one body, at least one tip, and at least one absorber unit. The body may generally be arranged to store therein a preset amount of the marking substance, while the tip may be arranged to be in fluid communication with such marking substance inside the body and to dispense the marking substance therethrough out of the body onto the article. The absorber unit may be arranged to couple with the body and to be capable of absorbing the marking substance, thereby capable of removing the marking substance leaked from the tip into the interior of the case member when the assembly may be received by the case member.

In another exemplary embodiment of this aspect of the present invention, a cartridge assembly may include at least one body, at least one tip, and at least one divider. Such a body may be arranged to store therein a preset amount of the marking substance, while the tip may be arranged to be in fluid communication with such marking substance inside the body and to dispense such marking substance therethrough out of the body onto the article. The divider may be arranged to be coupled to the body and to extend outwardly, and may be capable of forming airtight sealing around at least a substantial portion of a circumference of such a body with an inner wall of the case member, thereby forming an inner space which is arranged to amount to only a fraction of the inner space when such a cartridge assembly is received by the case member.

In another exemplary embodiment of this aspect of the present invention, a cartridge assembly may include at least one body, at least one tip, and at least one recoil unit. The body may be arranged to store therein a preset amount of the marking substance, while the tip may be arranged to be in fluid communication with the marking substance inside the body so as to dispense the marking substance therethrough out of the body onto the article. The recoil unit may be arranged to couple with the body and may be capable of biasing at least a portion of the cartridge assembly toward a preset direction when the assembly is received by the case member.

In another aspect of the present invention, various cartridge assemblies may be provided for a writing tool with a case member which is capable of receiving the cartridge member therethrough and which is arranged to define an interior therein and an opening in one end thereof, where the cartridge assembly may store at least one marking substance capable of leaving a mark onto an article.

In one exemplary embodiment of such an aspect of the present invention, a cartridge assembly may include at least one body, at least one tip, and at least one cap. Such a body may be arranged to store therein a preset amount of such marking substance, while the tip may be arranged to be in fluid communication with the marking substance inside the body so as to dispense such marking substance therethrough out of the body onto the article. The cap may be arranged to be coupled to the body, to move between at least one off-state and at least one on-state, to be capable of obstructing at least a substantial portion of the opening in the off-state, and to be capable of clearing the portion of such an opening in the on-state.

In another exemplary embodiment of this aspect of the present invention, a cartridge assembly may include at least one body, at least one tip, at least one cap, and at least one absorber unit. Such a body may be arranged to store therein a preset amount of the marking substance, while the tip may be arranged to be in fluid communication with the marking substance inside the body and to dispense the marking substance therethrough out of the body onto the article. The cap may be arranged to be coupled to the body, to move between at least one off-state and at least one on-state, to be capable of obstructing at least a substantial portion of such an opening in the off-state, and to be also capable of clearing such a portion of the opening in the on-state. The absorber unit may be arranged to couple with the body and to be capable of absorbing the marking substance, thereby capable of removing the marking substance leaked from the tip into the interior of the case member.

In another exemplary embodiment of this aspect of the present invention, a cartridge assembly may include at least one body, at least one tip, at least one cap, and at least one divider. Such a body may be arranged to store therein a preset amount of the marking substance, whereas the tip may be arranged to be in fluid communication with the marking substance inside the body and to dispense the marking substance therethrough out of the body onto the article. The cap may be arranged to couple with such a body, to move between at least one off-state and at least one on-state, to be capable of obstructing at least a substantial portion of the opening in the off-state, and to be capable of clearing the portion of the opening in the on-state. The divider may be arranged to couple with the body and to extend outwardly, and may be capable of forming airtight sealing around at least a substantial portion of a circumference of the body with an inner surface or wall of the case member, thereby forming an inner space which may amount to only a fraction of the inner space when the cartridge member may be received by the case member.

In another exemplary embodiment of this aspect of the present invention, a cartridge assembly may include at least one body, at least one tip, at least one cap, and at least one recoil unit. The body may be arranged to store therein a preset amount of the marking substance, whereas such a tip may be arranged to be in fluid communication with the marking substance inside the body and to dispense the marking substance therethrough out of the body onto the article. The cap may be arranged to be coupled to the body, to move between at least one off-state and at least one on-state, to be capable of obstructing at least a substantial portion of such an opening in the off-state, and to also be capable of clearing the portion of the opening in the on-state. The recoil unit may be arranged to be coupled to the body and capable of biasing at least a portion of the cap toward the opening when the assembly is received by the case member and the cap is disposed in the off-state. Alternatively, the recoil unit may be arranged to be coupled to the body and capable of biasing at least a portion of the cap away from the opening as the assembly is received by the case member and the cap is disposed in the on-state.

In another exemplary embodiment of this aspect of the present invention, a cartridge assembly may include at least one body, at least one tip, and at least one actuator. The body may be arranged to store therein a preset amount of the marking substance, while the tip may be arranged to be in fluid communication with the marking substance inside such a body and to dispense the marking substance therethrough out of the body onto the article. The actuator may be arranged to protrude outwardly of the body and to be capable of being disposed in multiple preset locations inside the interior when such an assembly may be received by the case member.

Embodiments of the two previous aspects of the present invention may include one or more of the following features.

At least one of the caps may be arranged to fixedly couple with the case and, therefore, to not be replaceable by another cap. In the alternative, at least one of the caps may instead be arranged to be releasably coupled to the case and to be replaceable by another cap. The cartridge assembly may be arranged to fixedly couple with the case and to not be replaceable by another cartridge assembly. In the alternative, such a cartridge assembly may be arranged to releasably couple with the case and, therefore, to be replaceable by another assembly.

In another aspect of the present invention, various methods may be provided for exposing a tip of a cartridge member of a writing tool from an inner space defined in a case of the tool to an exterior of the tool through an opening of the case and for enclosing the tip inside the inner space.

In one exemplary embodiment of this aspect of the present invention, a method may include the steps of operatively coupling at least one movable cap with the opening; blocking at least a substantial portion of the opening by moving the cap to its off-state when the tool is not used by an user, thereby isolating the tip from the exterior, minimizing evaporation of marking substances stored in the cartridge member through the tip, and preventing the tip from getting dry; and clearing the portion of the opening while moving the cap to its on-state when the tool is used by the user, thereby exposing the tip to the exterior and applying the marking substances onto an article by the tip.

In another exemplary embodiment of this aspect of the present invention, a method may include the steps of operatively coupling at least one movable cap to such an opening; movably disposing the cartridge member inside the case; enclosing the tip inside the inner space by maintaining the cartridge member in its rest position when the tool is not used by an user, thereby enclosing the tip in the inner space; obstructing at least a substantial portion of the opening by disposing the cap to its off-state, thereby isolating the tip from the exterior, minimizing evaporation of marking substances contained in the cartridge member through the tip and preventing the tip from getting dry; clearing the portion of the opening while moving the cap to its on-state when the tool is used by the user; and exposing the tip to the exterior by disposing the cartridge member in its use position when the tool is in use by the user, thereby allowing the user to apply the marking substances onto an article by the tip.

In another aspect of the present invention, various methods may be provided to enclose a tip of a cartridge member of a writing tool in an inner space defined in a case member of the writing tool and to expose the tip to an exterior of the tool through an opening of the case member so as to apply marking substances contained in the cartridge member onto an article.

In one exemplary embodiment of this aspect of the present invention, a method may include the steps of arranging the case member to be stationary; incorporating at least one cap to move between at least one off-state and at least one on-state and to obstruct and clear at least a substantial portion of the opening respectively in each of such states; and arranging the cartridge member to be operate between at least one rest position and at least one use position and to dispose the tip toward such an inner space and toward the exterior respectively in each of the positions. In one example, the method may include the ensuing steps of operatively coupling the cartridge member with the cap; disposing the cartridge member in the rest position and then maintaining the cap in the off-state as a result of the above disposing, thereby obstructing the portion of the opening by the cap and enclosing the tip in the inner space; moving the cartridge member to the use position in response to user input force and then moving the cap to the on-state as a result of the above operating, thereby clearing the portion of such an opening and exposing such a tip to the exterior through the opening; and thereafter returning such a cartridge member to its rest position and then moving the cap to the on-state as a result of the above returning, thereby obstructing the portion of the opening and again enclosing the tip in the inner space. In another example, the method may include the ensuing steps of operatively coupling the cap with the cartridge member, disposing the cap in the off-state and maintaining the cartridge member in the rest position as a result of the above disposing, thereby obstructing such a portion of the opening by such a cap and enclosing the tip in the inner space; moving the cap to the on-state in response to user input force and moving the cartridge member to the use position as a result of the above operating, thereby clearing the portion of the opening and exposing the tip to the exterior through the opening; and then returning the cap to the off-state and operating the cartridge member to the rest position as a result of the above returning, thereby obstructing such a portion of the opening and again enclosing such a tip in the inner space.

In another exemplary embodiment of this aspect of the present invention, a method may include the steps of incorporating at least one cap to operate between at least one off-state and at least one on-state and to obstruct and clear at least a substantial portion of the opening respectively in each of such states; arranging the case and cartridge members to be stationary; operatively coupling the cap with the cartridge member; disposing the cap in the off-state and maintaining the cartridge member in the rest position as a result of the above disposing, thereby obstructing the portion of the opening by the cap and enclosing the tip in the inner space; operating the cap to the on-state in response to user input force and moving such a cartridge member to the use position as a result of the above operating, thereby clearing the above portion of such an opening and exposing the tip through the opening to the exterior; and returning the cap to the off-state and moving the cartridge member to the rest position as a result of the above returning, thereby obstructing the portion of the opening and again enclosing the tip in the inner space.

In another exemplary embodiment of this aspect of the present invention, a method may include the steps of incorporating at least one cap to operate between at least one off-state and at least one on-state and to obstruct and clear at least a substantial portion of the opening respectively in each of the states; arranging the cartridge member to operate between at least one rest position and at least one use position thereof and to dispose such a tip toward the inner space and exterior respectively in each of such positions; and arranging the case member to operate between at least one rest position and at least one use position thereof. In one example, the method may also include the ensuing steps of operatively coupling the cartridge member with the cap and case member; disposing the cartridge member in its rest position and then maintaining both the cap in its off-state and the case member in its rest position as a result of such disposing, thereby blocking the portion of the opening by the cap and enclosing the tip in the inner space; operating the cartridge member to the use position in response to user input force and then both of moving the cap to the on-state and moving the case member to the use position as a result of the above operating, thereby clearing the portion of the opening as well as exposing the tip to the exterior through the opening; and returning such a cartridge member to the rest position and both of moving the cap to its on-state and moving the case member to its rest position as a result of the above returning, thereby blocking the portion of the opening and again enclosing the tip in the inner space. In another example, the method may also include the ensuing steps of operatively coupling the cap with the case and cartridge members; disposing the cap in the off-state and keeping the case and cartridge members in the rest position as a result of the disposing, thereby obstructing the portion of the opening by the cap and enclosing the tip in the inner space; operating the cap to the on-state in response to user input force and moving both of the case and cartridge members to their use positions as a result of the above operating, thereby clearing the portion of such an opening and exposing the tip to the exterior through the opening; and returning the cap to the off-state and moving both the case and cartridge members to their rest positions as a result of the above returning, thereby blocking the portion of the opening and enclosing the tip in the inner space. In another example, such a method may also include the ensuing steps of operatively coupling the case member with both of the cap and cartridge member; disposing the case member in the rest position and both of maintaining the cap in the off-state and maintaining the cartridge member in the rest position as a result of the above disposing, thereby blocking such a portion of the opening by the cap and enclosing the tip in the inner space; operating the case member to its use position in response to user input force and then both of moving the cap to the on-state and moving the cartridge member to the use position as a result of the above operating, thereby clearing the portion of the opening as well as exposing the tip to the exterior through the opening; and returning the case member to the rest position and both of moving the cap to the off-state and moving the cartridge member to the rest position as a result of the above returning, thereby blocking the portion of the opening and enclosing the tip in the inner space.

In another exemplary embodiment of this aspect of the present invention, a method may include the steps of incorporating at least one cap to operate between at least one off-state and at least one on-state and to obstruct and clear at least a substantial portion of the opening respectively in each of the states; arranging the case member to operate between at least one rest position and at least one use position; and arranging the cartridge member to be stationary. In one example, the method may include the ensuing steps of operatively coupling the case member with the cap; disposing the case member in the rest position and maintaining the cap in the off-state as a result of the above disposing, thereby obstructing the portion of the opening and enclosing the tip in the inner space; operating the case member to its use position in response to user input force and moving the cap to its on-state as a result of the above operating, thereby clearing the portion of the opening and exposing the tip to the exterior through the opening; and returning the case member to the rest position and then moving the cap to the on-state as a result of the above returning, thereby obstructing the portion of the opening and then again enclosing the tip in the inner space. In another example, the method may also include the ensuing steps of operatively coupling the cap with the case member; disposing the cap in the off-state and maintaining the case member in the rest position as a result of the above disposing, thereby obstructing the portion of the opening and enclosing the tip in the inner space; operating the cap to the on-state in response to user input force and moving the case member to its use position as a result of the operating, thereby clearing the portion of the opening and exposing the tip to the exterior through the opening; and returning the cap to the off-state and moving the case member to the rest position as a result of the returning, thereby obstructing such a portion of the opening and again enclosing the tip in the inner space.

In another aspect of the present invention, various methods may be provided for enclosing a tip of a cartridge member of a writing tool in a case member thereof and exposing the tip to an exterior of the tool through an opening of the case member for applying a marking substance contained inside the cartridge member onto an article, while preventing or minimizing leakage of the marking substance out of the case member.

In one exemplary embodiment of this aspect of the present invention, a method may include the steps of operatively coupling at least one movable cap to or around the opening; obstructing at least a substantial portion of the opening by the cap as the writing tool is not used by an user; clearing such a portion of the opening by removing the cap therefrom in response to input force supplied to the case member, cap member, and/or cartridge member when the tool is in use by the user; and absorbing the marking substance leaked from the tip to an interior of the case member before the marking substance escapes to the exterior, thereby minimizing the above leakage.

In another exemplary embodiment of this aspect of the present invention, a method may include the steps of operatively coupling at least one movable cap to or around the opening; blocking at least a substantial portion of the opening by the cap as the writing tool is not used by an user; receiving user input force by the case member and moving the cap away from the opening as a result of the above receiving, thereby clearing the portion of the opening and exposing the tip to the exterior when the tool is uses by the user; and absorbing the marking substance which leaks from the tip to an interior of the case member before the marking substance escapes to the exterior during the above obstructing and receiving, thereby minimizing the above leakage.

In another exemplary embodiment of this aspect of the present invention, a method may include the steps of operatively coupling at least one movable cap to or around the opening; blocking at least a substantial portion of the opening by the cap as the writing tool is not used by an user; moving the cap away from the opening in response to user input force, thereby clearing such a portion of the opening and exposing the tip to the exterior when the tool is uses by the user; and then absorbing the marking substance which leaks from the tip to an interior of the case member before such marking substance may escape to the exterior during the obstructing and moving, thereby minimizing the above leakage.

In another exemplary embodiment of this aspect of the present invention, a method may include the steps of operatively coupling at least one movable cap to or around the opening; blocking at least a substantial portion of the opening by the cap as the writing tool is not used by an user; receiving user input force by the cartridge member and then moving the cap away from the opening as a result of the above receiving, thereby clearing the portion of the opening and exposing the tip to the exterior when the tool is uses by the user; and absorbing the marking substance leaked from such a tip to an interior of the case member before the marking substance escapes to the exterior during the obstructing and receiving, thereby minimizing the above leakage.

In another exemplary embodiment of this aspect of the present invention, a method may include the steps of operatively coupling at least one movable cap to or around the opening; blocking at least a substantial portion of the opening by the cap as the writing tool is not used by an user; receiving user input force by an actuator member and then disposing the cap away from the opening as a result of the above receiving, thereby clearing such a portion of the opening and exposing the tip to the exterior as the tool is uses by the user; and absorbing the marking substance leaks from the tip to an interior of the case member before the marking substance escapes to the exterior during the obstructing and receiving, thereby minimizing the above leakage.

In another aspect of the present invention, various methods may be provided for enclosing a tip of a cartridge member of a writing tool in a case member thereof and exposing the tip to an exterior of the tool through an opening of the case member for applying a marking substance stored inside the cartridge member onto an article, while preventing or minimizing evaporation of the marking substance during a period of nonuse.

In one exemplary embodiment of this aspect of the present invention, a method may include the steps of operatively coupling at least one movable cap to or around the opening; partitioning an interior of the case member into a smaller inner space; obstructing at least a substantial portion of the opening by the cap as the writing tool is not used by an user during the period of the nonuse; disposing the tip in the inner space, thereby preventing or minimizing such evaporation; and then clearing the portion of the opening by removing the cap therefrom in response to input force supplied onto the case member, cap member, and/or cartridge member as the tool is in use by the user.

In another exemplary embodiment of this aspect of the present invention, a method may include the steps of operatively coupling at least one movable cap to or around such an opening; partitioning an interior of the case member into a smaller inner space; obstructing at least a substantial portion of the opening by the cap when the writing tool is not used by an user during the period of the nonuse; disposing the tip in the inner space, thereby preventing or minimizing such evaporation; and receiving user input force by the case member and operating the cap away from the opening as a result of the above receiving, thereby clearing the portion of the opening as well as exposing the tip to the exterior when the tool is uses by the user.

In another exemplary embodiment of this aspect of the present invention, a method may include the steps of operatively coupling at least one movable cap to or around such an opening; partitioning an interior of the case member into a smaller inner space; obstructing at least a substantial portion of the opening by the cap when the writing tool is not used by an user during the period of the nonuse; disposing the tip in the inner space, thereby preventing or minimizing the evaporation; and moving the cap away from the opening in response to user input force, thereby clearing such a portion of such an opening and exposing the tip to the exterior when the tool is uses by the user.

In another exemplary embodiment of this aspect of the present invention, a method may include the steps of operatively coupling at least one movable cap to or around such an opening; partitioning an interior of the case member into a smaller inner space; obstructing at least a substantial portion of the opening by the cap when the writing tool is not used by an user during the period of the nonuse; disposing the tip in the inner space, thereby preventing or minimizing such evaporation; and receiving user input force by the cartridge member and then moving the cap away from the opening as a result of the above receiving, thereby clearing the portion of the opening and exposing the tip to the exterior when the tool is uses by the user.

In another exemplary embodiment of this aspect of the present invention, a method may include the steps of operatively coupling at least one movable cap to or around such an opening; partitioning an interior of the case member into a smaller inner space; obstructing at least a substantial portion of the opening by the cap when the writing tool is not used by an user during the period of the nonuse; disposing the tip in the inner space, thereby minimizing the evaporation; and receiving user input force by an actuator member and then disposing the cap away from the opening as a result of the above receiving, thereby clearing the portion of the opening and exposing the tip to the exterior when the tool is uses by the user.

In another aspect of the present invention, various methods may be provided to enclose a tip of a cartridge member of a writing tool in an inner space defined in a case member of the writing tool and to expose the tip to an exterior of the tool through an opening of the case member so as to apply marking substances contained in the cartridge member onto an article.

In one exemplary embodiment of this aspect of the present invention, a method may include the steps of operatively coupling at least one movable cap to such an opening; providing at least one track along which at least a portion of the cap is arranged to move; placing the tip in the inner space when the tool is not in use; blocking at least a substantial portion of the opening by the cap during the above placing, thereby enclosing such a tip inside the inner space and isolating such a tip from the exterior, minimizing evaporation of the marking substances through the tip, and preventing the tip from getting dry; and moving the cap away from the opening along the track as the tool is used, thereby clearing the portion of the opening and allowing the tip to be exposed to the exterior through the opening.

In another exemplary embodiment of this aspect of the present invention, a method may include the steps of operatively coupling at least one movable cap to such an opening; movably disposing the cartridge member inside the case; providing at least one track along which at least a portion of the cap and/or cartridge member is arranged to move; placing the tip in the inner space when the tool is not in use; blocking at least a substantial portion of the opening by the cap during the above placing, thereby enclosing the tip in the inner space and isolating the tip from the exterior, minimizing evaporation of the marking substances through the tip, and preventing the tip from getting dry; moving the cap away from the opening along the track when the tool is used, thereby clearing such a portion of the opening and exposing the tip to the exterior; and thereafter moving the cartridge member, thereby allowing the tip to be exposed through the opening to the exterior.

In another exemplary embodiment of this aspect of the present invention, a method may include the steps of operatively coupling at least one movable cap to the opening; placing such a tip inside the inner space when the tool is not in use; obstructing at least a substantial portion of the opening by the cap having a preset shape and a size during the above placing, thereby enclosing the tip in the inner space, isolating the tip from the exterior, minimizing evaporation of the marking substances through the tip, and preventing the tip from getting dry; and moving the cap away from the opening when the tool is used, thereby clearing such a portion of the opening and exposing the tip to the exterior through the opening, while varying the preset shape and/or size of the cap during at least a portion of the above moving, thereby facilitating disposition of the cap one of inside and out of the case member when the tool is used.

In another exemplary embodiment of this aspect of the present invention, a method may include the steps of operatively coupling at least one movable cap to such an opening; movably disposing the cartridge member inside the case; placing such a tip inside the inner space when the tool is not in use; blocking at least a substantial portion of the opening by the cap with a preset shape and a size during the above placing, thereby enclosing the tip inside the inner space, isolating the tip from the exterior, minimizing evaporation of the marking substances through the tip, and preventing the tip from getting dry; moving the cap away from the opening when the tool is used, thereby clearing the portion of the opening while changing the preset shape and/or size of the cap during at least a portion of the above moving, thereby facilitating disposition of the cap one of inside and out of the case member; and then displacing the cartridge member toward the opening after the above moving, thereby allowing the tip to be exposed to the exterior through the opening.

In another aspect of the present invention, various methods may be provided for enclosing a tip of a cartridge member of a writing tool in a case member of the tool and for exposing such a tip to an exterior of the tool through an opening of the case member in order to apply marking substances stored in the cartridge member onto an article in response to input force applied to the tool by an user.

In one exemplary embodiment of this aspect of the present invention, a method may include the steps of arranging the case member to be stationary; operatively coupling at least one movable cap to and/or around the opening; movably disposing the cartridge member in the case member; disposing the tip inside the case member; and obstructing the opening by the cap, thereby isolating the tip from the exterior. In one example, the method may include the ensuing steps of moving the cap away from the opening by the input force to clear the opening and displacing the cartridge member by such input force as well so as to expose the tip to the exterior. In another example, the method may include the ensuing steps of moving the cap away from the opening by the input force to clear the opening; and displacing the cartridge member by the cap to expose the tip to the exterior as a result of the moving. In another example, the method may include the ensuing steps of displacing the cartridge member by the input force in order to expose the tip to the exterior; and moving the cap away from the opening by the cartridge member in order to clear the opening as a result of the displacing.

In another exemplary embodiment of this aspect of the present invention, a method may include the steps of arranging such a case member to be stationary; operatively coupling at least one movable cap to and/or around the opening; arranging the cartridge member to be stationary in the case member while placing the tip also inside the case member; obstructing the opening by the cap, thereby isolating the tip from the exterior; and moving the cap away from the opening by the input force so as to clear the opening and to expose the tip to the exterior.

In another exemplary embodiment of this aspect of the present invention, a method may include the steps of arranging at least a portion of the case member to move with respect to the rest of such a case member; operatively coupling at least one movable cap to and/or around the opening; movably disposing such a cartridge member inside the case member, disposing the tip inside the case member; obstructing the opening by the cap, thereby isolating the tip from the exterior; and receiving such input force by the actuator member. In one example, the method may include the ensuing steps of actuating the portion of the case member by the input force; moving the cap away from the opening by the input force and/or the portion of the case member so as to clear the opening; and displacing the cartridge member by such a portion of the case member, cap, and/or input force along with the moving in order to expose the tip to the exterior. In another example, such a method may include the ensuing steps of actuating the portion of the case member by the input force; moving the cap away from the opening by the input force and/or such a portion of the case member so as to clear the opening as a result of the above actuating; and displacing the cartridge member by the cap, case member, and/or input force to expose the tip to the exterior as a result of the above moving. In another example, the method may include the ensuing steps of actuating the portion of the case member by such input force; displacing the cartridge member by such a portion of the case member and/or input force in order to expose the tip to the exterior as a result of the actuating; and moving the cap away from the opening by the case and/or cartridge members and/or input force in order to clear the opening as a result of the displacing. In another example, the method may include the ensuing steps of actuating such a portion of the case member by the input force; moving the cap away from the opening by such input force along with the actuating in order to clear the opening; and displacing the cartridge member by the cap, case member, and/or input force to expose the tip to the exterior as a result of the above actuating and moving.

Still referring to the same exemplary embodiment of this aspect of the present invention and in another example, the method may also include the ensuing steps of actuating the portion of the case member by the input force; moving the cap away from the opening by the input force, such a portion of the case member, and/or input force in order to clear the opening as a result of the actuating; and displacing the cartridge member by the cap, case member, and/or input force in order to expose the tip to the exterior as a result of the moving. In another example, the method may also include the ensuing steps of moving the cap away from such an opening by the input force to clear the opening; actuating such a portion of the case member by the cap and/or input force as a result of the above moving; and displacing the cartridge member by the cap, case member, and/or input force in order to expose its tip to the exterior as a result of the above actuating. In another example, the method may also include the ensuing steps of actuating the portion of the case member by the input force; displacing the cartridge member by the input force along with the above actuating so as to expose the tip to the exterior; and moving the cap away from the opening by the case and/or cartridge members and/or input force so as to clear the opening as a result of the above actuating and/or displacing. In another example, the method may include the ensuing steps of actuating the portion of the case member by the input force; displacing the cartridge member by such a portion of the case member and/or input force in order to expose the tip to the exterior as a result of the above actuating; and moving the cap away from such an opening by the case and/or cartridge members and/or input force in order to clear the opening as a result of the above displacing.

Still referring to the same exemplary embodiment of this aspect of the present invention and in another example, the method may include the ensuing steps of displacing the cartridge member by the input force to move the cartridge member and its tip toward the opening; actuating the portion of such a case member by the cartridge member and/or input force as a result of the displacing; and moving such a cap away from the opening by the case and/or cartridge members and/or input force in order to clear the opening as a result of the above actuating. In another example, the method may include the ensuing steps of moving the cap away from the opening by such input force to clear the opening; displacing the cartridge member by the cap and/or input force along with the above moving in order to expose the tip to the exterior; and actuating such a portion of the case member by the cap, cartridge member, and/or input force as a result of the above moving and/or displacing. In another example, the method may include the ensuing steps of moving the cap away from the opening by the input force in order to clear the opening; displacing such a cartridge member by the cap and/or input force so as to expose the tip to the exterior as a result of the foregoing moving; and similarly actuating the portion of the case member by the cap, cartridge member, and/or input force as a result of the above displacing. In another example, the method may include the ensuing steps of displacing the cartridge member by the input force to move the cartridge member and its tip toward the opening; moving such a cap away from the opening by the cartridge member and/or input force so as to clear the opening as a result of the above displacing; and actuating such a portion of the case member by the cap, cartridge member, and/or input force as a result of the above moving.

In another exemplary embodiment of this aspect of the present invention, a method may include the steps of arranging at least a portion of the case member to move with respect to the rest thereof; operatively coupling at least one movable cap with and/or around the opening; arranging the cartridge member to be stationary inside the case member while placing the tip inside the case member as well; and obstructing the opening by the cap, thereby isolating the tip from the exterior. In one example, the method may include the ensuing steps of actuating the portion of the case member by the input force; and moving the cap away from the opening by the input force along with the above actuating in order to clear the opening and to expose the tip to the exterior. In another example, the method may include the ensuing steps of actuating the portion of the case member by the input force; and moving the cap away from the opening by such a portion of the case member and/or input force in order to clear such an opening and to expose the tip to the exterior as a result of the actuating. In another example, such a method may include the ensuing steps of moving the cap away from the opening by the input force to clear the opening; and actuating the portion of the case member by the cap and/or input force so as to expose the tip to the exterior as a result of the above moving.

In another aspect of the present invention, various methods may be provided for enclosing a tip of a cartridge member of a writing tool in a case member of the tool and for exposing the tip to an exterior of the tool through an opening of the case member so as to apply marking substances stored in the cartridge member onto an article in response to input force applied to an actuator member of the tool by an user.

In one exemplary embodiment of this aspect of the present invention, a method may include the steps of arranging the case member to be stationary; operatively coupling at least one movable cap to and/or around the opening; movably disposing the cartridge member in the case member; disposing the tip inside the case member; obstructing the opening by the cap, thereby isolating the tip from the exterior; and receiving the input force by the actuator member. In one example, the method may have the ensuing step of moving the cap away from the opening by the actuator member so as to clear the opening and moving the cartridge member to expose the tip to the exterior. In another example, such a method may also include the ensuing steps of moving the cap away from the opening by the actuator member to clear the opening; and moving the cartridge member by the actuator member and/or cap in order to expose the tip to the exterior. In another example, the method may include the ensuing steps of moving the cartridge member and the tip by the actuator member toward the opening; and moving the cap away from the opening by the actuator and/or cartridge members in order to clear the opening and to allow the tip to be exposed to the exterior through the opening.

In another exemplary embodiment of this aspect of the present invention, a method may include the steps of arranging such a case member to be stationary; operatively coupling at least one movable cap one of to and around the opening; arranging the cartridge member to be stationary inside the case member while placing the tip inside the case member as well; blocking the opening by the cap, thereby isolating the tip from the exterior; receiving the input force by the actuator member; and moving such a cap away from the opening by the actuator member to clear the opening so as to expose the tip to the exterior.

In another exemplary embodiment of this aspect of the present invention, a method may include the steps of arranging at least a portion of the case member to move with respect to the rest thereof; operatively coupling at least one movable cap to and/or around the opening; movably disposing such a cartridge member inside the case member; disposing the tip inside the case member, obstructing such an opening by the cap, thereby isolating the tip from the exterior; and receiving such input force by the actuator member. In one example, the method may have the ensuing steps of actuating such a portion of the case member by the actuator member, moving the cap away from the opening by the actuator member and/or the portion of the case member so as to clear the opening; and displacing the cartridge member by the actuator member and such a portion of the case member along with the above moving so as to expose the tip to the exterior. In another example, the method may include the ensuing steps of actuating the portion of the case member by the actuator member; moving the cap away from such an opening by the actuator member and/or the portion of the case member so as to clear the opening as a result of the above actuating; and displacing such a cartridge member by the cap and/or actuator member to expose the tip to the exterior as a result of the moving. In another example, such a method may include the ensuing steps of actuating the portion of the case member by the actuator member; displacing the cartridge member by the actuator member and/or such a portion of the case member in order to expose the tip to the exterior as a result of the above actuating; and moving such a cap away from the opening by the actuator and/or cartridge members in order to clear the opening as a result of the above displacing. In another example, the method may also include the ensuing steps of actuating such a portion of the case member by the actuator member; moving the cap away from the opening by the actuator member along with the above actuating so as to clear the opening; and displacing the cartridge member by the case and/or actuator members and/or cap so as to expose such a tip to the exterior as a result of the above actuating and/or moving.

Still referring to the same exemplary embodiment of this aspect of the present invention and in another example, the method may instead include the ensuing steps of actuating such a portion of the case member by the actuator member; moving the cap away from the opening by the actuator member and/or the portion of the case member in order to clear the opening as a result of the above actuating; and displacing the cartridge member by the actuator member and/or cap so as to expose the tip to the exterior as a result of the above moving. In another example, the method may also include the ensuing steps of moving the cap away from the opening by the actuator member in order to clear the opening; actuating such a portion of the case member by the cap as a result of the moving; and then displacing the cartridge member to expose its tip to the exterior as a result of the actuating. In another example, the method may include the ensuing steps of actuating the portion of the case member by the actuator member; displacing the cartridge member by the actuator member along with the foregoing actuating in order to expose the tip to the exterior; and moving the cap away from such an opening by the case, cartridge, and/or actuator members so as to clear the opening as a result of the above actuating and displacing. In another example, the method may include the ensuing steps of actuating such a portion of the case member by the actuator member; displacing the cartridge member by the actuator member and/or such a portion of the case member in order to expose the tip to the exterior as a result of the above actuating; and moving the cap away from the opening by the cartridge and actuator members in order to clear the opening as a result of the displacing.

Still referring to the same exemplary embodiment of this aspect of the present invention and in another example, the method may include the ensuing steps of displacing the cartridge member by the actuator member to move the cartridge member and the tip thereof toward the opening; actuating such a portion of the case member by the cartridge and/or actuator members as a result of such displacing; and moving the cap away from the opening by the case and/or actuator members in order to clear the opening as a result of the actuating. In another example, the method may include the ensuing steps of moving the cap away from the opening by the actuator member so as to clear the opening; displacing the cartridge member by the cap and/or the actuator member along with the above moving in order to expose the tip to the exterior; and then actuating the portion of the case member by the cap, cartridge member, and/or actuator member as a result of the above moving and displacing. In another example, the method may include the ensuing steps of moving the cap away from the opening by the actuator member in order to clear the opening; displacing the cartridge member by the cap and/or the actuator member to expose the tip to the exterior as a result of the above moving; and actuating the portion of the case member by the cartridge and/or actuator members as a result of the foregoing displacing. In another example, the method may include the ensuing steps of displacing the cartridge member by the actuator member to move the cartridge member and the tip thereof toward the opening; moving such a cap away from the opening by the actuator and/or cartridge members so as to clear the opening as a result of the above displacing; and actuating the portion of the case member by the actuator member and/or cap as a result of the above moving.

In another exemplary embodiment of this aspect of the present invention, a method may include the steps of arranging at least a portion of the case member to move with respect to the rest of such a case member, operatively coupling at least one movable cap to and/or around the opening; arranging the cartridge member to be stationary in the case member while disposing its tip in the case member; obstructing the opening by the cap, thereby isolating the tip from the exterior; and receiving such input force by the actuator member. In one example, the method may include the ensuing steps of actuating the portion of the case member by the actuator member; and moving the cap away from the opening by the actuator member along with the above actuating in order to clear the opening and to expose the tip to the exterior. In another example, the method may include the ensuing steps of actuating such a portion of the case member by the actuator member; and then moving the cap away from the opening by the actuator member and/or such a portion of the case member in order to clear the opening and to expose the tip to the exterior as a result of the actuating. In another example, the method may include the ensuing steps of moving the cap away from the opening by the actuator member in order to clear the opening; and actuating the portion of the case member by the cap and/or actuator member in order to expose the tip to the exterior as a result of the above moving.

In another aspect of the present invention, various methods may be provided for blocking and forming fluid communication from an exterior to an inner space of a writing tool defined inside a case member of the tool through an opening provided on one end of the case member during nonuse and use of such a tool, respectively.

In one exemplary embodiment of this aspect of the present invention, a method may include the steps of arranging a single cap capable of moving at least a portion thereof between the nonuse and use; and implementing the cap across at least a substantial portion of the opening during the nonuse, thereby obstructing the opening and the fluid communication by the cap. In one example, the method may include the ensuing steps of moving the cap away from the portion of the opening during the use, thereby clearing the portion of such an opening and forming the fluid communication therethrough; and moving the cap back and across the portion of the opening after the use. In another example, such a method may include the ensuing steps of translating the cap away from such a portion of the opening during the use, thereby clearing such a portion of the opening and forming such fluid communication through the opening; and translating the cap back and across the portion of the opening after the use. In another example, the method may also include the ensuing steps of rotating and/or pivoting the cap away from the portion of the opening along a direction at least partially parallel therewith during such use, thereby clearing the portion of the opening and forming the fluid communication therethrough; and rotating and/or pivoting the cap back and across such a portion of the opening thereafter. In another example, the method may include the ensuing steps of one of rotating and pivoting the cap away from the portion of the opening around an axis of rotation disposed along at least one edge thereof during the use, thereby clearing the portion of the opening and forming the fluid communication therethrough; and rotating and/or pivoting the cap back and across the portion of the opening thereafter. In another example, the method may also include the ensuing steps of moving the cap away from the portion of the opening in a radial direction during the use, thereby clearing the portion of the opening and forming the fluid communication therethrough; and radially moving the cap toward and across such a portion of the opening after the use. In another example, the method may instead include the ensuing steps of moving the cap circumferentially and away from such a portion of the opening during the use, thereby clearing the portion of the opening and forming the fluid communication therethrough; and moving the cap back and across the portion of the opening after the use.

In another exemplary embodiment of this aspect of the present invention, a method may include the steps of providing such a tool with at least one cap capable of changing at least one configuration between the nonuse and use of such a tool, where such a configuration may include a shape, a size, a disposition, a location, an orientation thereof, and so on; arranging the cap to have a nonuse or rest configuration; and implementing the cap across at least a substantial portion of the opening during the nonuse, thereby obstructing the opening and the fluid communication by the cap. In one example, the method may include the ensuing steps of moving the cap away from the portion of the opening while arranging the cap to have an use configuration which may be different from the nonuse configuration during the use, thereby clearing such a portion of the opening and providing such fluid communication through the opening; and moving back the cap across the portion of the opening while arranging such a cap to restore the nonuse configuration after such use. In another example, the method may include the ensuing steps of translating the cap away from the portion of the opening while arranging the cap to have an use configuration different from the nonuse configuration during the use, thereby clearing the portion of the opening and forming the fluid communication therethrough; and translating the cap back and across the portion of the opening while arranging the cap to have the nonuse configuration after the use. In another example, the method may have the ensuing steps of rotating and/or pivoting the cap away from the portion of the opening along a direction at least partially parallel therewith while arranging the cap to have an use configuration which may be different from the nonuse configuration during the use, thereby clearing the portion of the opening and also providing the fluid communication through; and rotating and/or pivoting back the cap across the portion of the opening while arranging the cap to restore the nonuse configuration thereafter.

Still referring to the same exemplary embodiment of this aspect of the present invention and in another example, the method may instead include the ensuing steps of rotating and/or pivoting such a cap away from the portion of the opening about an axis of rotation which is provided on at least one edge thereof while arranging the cap to have an use configuration which is different from the nonuse configuration during the use, thereby clearing the portion of the opening and also providing such fluid communication therethrough; and rotating and/or pivoting back the cap across the portion of such an opening while making the cap restore the nonuse configuration thereafter. In another example, such a method may include the ensuing steps of moving the cap away from such a portion of the opening in a radial direction while arranging the cap to have an use configuration which may be different from the nonuse configuration during the use, thereby clearing the portion of the opening and forming the fluid communication; and radially moving the cap toward and across the portion of such an opening while arranging the cap to restore the nonuse configuration after the use. In another example, the method may include the ensuing steps of moving the cap circumferentially and away from the portion of such an opening while arranging the cap to have an use configuration which is different from the nonuse configuration during the use, thereby clearing the portion of the opening and also providing such fluid communication; and moving back the cap across the portion of the opening while arranging the cap to restore the nonuse configuration after the use.

In another exemplary embodiment of this aspect of the present invention, a method may include the steps of implementing into the tool a plurality of caps at least one of which is arranged to change at least one configuration including a shape, size, disposition, and orientation thereof between the use and nonuse; and disposing multiple caps which may define nonuse configurations and which may be disposed over, below, and/or across at least a substantial portion of the opening during such nonuse, thereby obstructing the opening and blocking the fluid communication by the cap. In one example, the method may include the ensuing steps of moving the at least one of the caps away from the portion of the opening while arranging the cap to define an use configuration which is different from the nonuse configuration during the use, thereby clearing the portion of the opening and also providing such fluid communication; and moving back such a cap over, below, and across the opening while arranging the cap to restore such nonuse configuration after the use, thereby blocking the opening and obstructing the fluid communication thereafter. In another example, the method may include the ensuing steps of translating such a cap away from such a portion of the opening while arranging the cap define an use configuration different from the nonuse configuration during the use, thereby clearing such a portion of the opening and forming the fluid communication; and translating back the cap over, below, and/or across the opening while arranging the cap to restore the nonuse configuration after the use, thereby obstructing the opening and blocking such fluid communication thereafter. In another example, such a method may have the ensuing steps of rotating and/or pivoting such a cap away from such a portion and along a direction at least partially parallel with the opening while arranging the cap to have an use configuration different from the nonuse configuration during the use, thereby clearing such a portion of the opening and forming the fluid communication; and rotating and/or pivoting back such a cap over, below, and/or across the opening while arranging the cap to restore such nonuse configuration after the use, thereby obstructing the opening and blocking the fluid communication thereafter.

Still referring to the same exemplary embodiment of this aspect of the present invention and in another example, the method may instead include the ensuing steps of rotating and/or pivoting such a cap away from the portion and around a rotation axis defined along at least one edge of the opening while arranging the cap to define an use configuration different from the nonuse configuration during the use, thereby clearing the portion of the opening and forming the fluid communication; and rotating and/or pivoting back such a cap across, below, and/or over the opening while arranging such a cap to restore the nonuse configuration after such use, thereby obstructing the opening and blocking such fluid communication thereafter. In another example, the method may also include the ensuing steps of moving such a cap away from the portion of the opening circumferentially and/or radially while making the cap define an use configuration different from the nonuse configuration during such use, thereby clearing the portion of the opening and forming the fluid communication; and moving back such a cap over, below, and/or across the opening while arranging the cap to restore such nonuse configuration after the use, thereby blocking the opening and also obstructing the fluid communication thereafter. In another example, the method may include the ensuing steps of moving such a cap away from such a portion of the opening in a centripetal direction while arranging the cap to define an use configuration which is different from the nonuse configuration during the use, thereby clearing such a portion of the opening and forming the fluid communication; and moving back such a cap over, below, and/or across the opening while making the cap restore the nonuse configuration after the use, thereby blocking the opening and obstructing the fluid communication thereafter.

In another aspect of the present invention, various methods may be provided for blocking and forming fluid communication from an exterior to an inner space of a writing tool defined inside a case member of the tool through an opening provided on one end of the case member during nonuse and use of the tool, respectively.

In one exemplary embodiment of this aspect of the present invention, a method may include the steps of arranging at least one cap to move at least a portion thereof between such nonuse and use; providing at least one guide capable of guiding the cap during movement thereof; implementing the cap across at least a substantial portion of the opening during the nonuse, thereby obstructing the opening and the fluid communication by the cap; and guiding the cap along the track and away from the portion of the opening during the use, thereby clearing the portion of the opening and also providing such fluid communication therethrough; and guiding the cap back and across the portion of the opening along the track after the use.

In another exemplary embodiment of such an aspect of this invention, a method may have the steps of arranging at least one cap to move at least a portion thereof between the nonuse and use; defining at least one hole along the cap; disposing the cap across at least a substantial portion of the opening while aligning the hole away from the opening during the nonuse, thereby obstructing such an opening and blocking the fluid communication by the cap; moving the cap while aligning such a hole across the portion of the opening during the use, thereby clearing the portion of the opening and also forming the fluid communication therethrough; and moving the cap back and across the portion of the opening after the use.

In another exemplary embodiment of such an aspect of the present invention, a method may include the steps of arranging at least one cap to move at least a portion thereof between the nonuse and use; implementing the cap across at least a substantial portion of the opening during the nonuse, thereby obstructing the opening and the fluid communication by the cap; and moving such a cap away from the portion of the opening while not changing its shape and size during the use, thereby clearing the portion of the opening and providing the fluid communication therethrough; and moving such a cap back and across the portion of the opening after the use.

In another exemplary embodiment of such an aspect of this invention, a method may include the steps of arranging at least one cap to move at least a portion thereof between such nonuse and use; implementing the cap across at least a substantial portion of such an opening during the nonuse, thereby obstructing the opening and the fluid communication by the cap; moving the cap away from the portion of the opening during the use while varying at least one of its shape and size to conform to at least a portion of the tool, thereby clearing the portion of the opening and also providing such fluid communication therethrough; and moving the cap back and across the portion of the opening after the use.

In another aspect of the present invention, various methods may be provided for enclosing and exposing a tip of a cartridge member of a writing tool in and out of a case member of the tool through an opening formed in one end of the case member during nonuse and use of the tool, respectively.

In one exemplary embodiment of this aspect of the present invention, a method may include the steps of providing the writing tool with at least one movable cap; implementing the cap across at least a substantial portion of the opening during such nonuse, thereby obstructing the opening and blocking the fluid communication through the cap; and receiving input force from the user by at least one of the members for the use. In one example, the method may include the ensuing steps of moving the cap away from the portion of the opening in response to the input force while at least partially maintaining a direction along which the input force acts onto the at least one of the members, thereby clearing the portion of the opening and forming the fluid communication through the opening; and moving back the cap across the portion of the opening after the use, thereby obstructing the opening and blocking the fluid communication thereafter. In another example, the method may also include the ensuing steps of moving the cap away from such a portion of the opening in response to the input force while at least substantially changing a direction in which the input force acts onto the at least one of the members, thereby clearing the portion of the opening and forming the fluid communication through the opening; and moving back the cap across the portion of the opening after the use, thereby obstructing such an opening and blocking the fluid communication thereafter.

In another exemplary embodiment of this aspect of the present invention, a method may include the steps of providing the tool with at least one movable cap; implementing the cap across at least a substantial portion of the opening during the nonuse, thereby obstructing the opening and blocking the fluid communication by the cap; and receiving input force from the user by the cap for the use. In one example, the method may include the ensuing steps of moving the cap away from the portion of such an opening in response to the input force along a direction which is at least partially similar to that in which the input force acts thereonto, thereby clearing the portion of the opening and forming the fluid communication through the opening; and moving back the cap across the portion of the opening after the use, thereby obstructing the opening and blocking the fluid communication thereafter. In another example, the method may include the ensuing steps of moving the cap away from the portion of such an opening in response to the input force along a direction at least substantially different from that in which the input force acts thereonto, thereby clearing the portion of the opening and forming the fluid communication through the opening; and moving back the cap across the portion of the opening after the use, thereby obstructing the opening and blocking the fluid communication thereafter.

Embodiments of the previous three aspects of the present invention may further include one or more of the following features.

The method may include the step of fixedly coupling at least one of the caps with the case to not be replaceable by another cap. In the alternative, the method may include the steps of releasably coupling at least one of the caps with the case; and replacing the at least one of the caps by another cap. Such a method may include the steps of disposing at least one absorber unit adjacent to and/or in at least one of such a cap and/or opening; and absorbing fluid leaked into the tool by the absorber unit, thereby minimizing presence of the liquid in the tool.

The method may also include the step of biasing at least a portion of at least one of such caps toward the opening in the nonuse, thereby enhancing airtight sealing between the at least one of the caps and opening and isolation of the inner space from the exterior in the nonuse. The method may include the steps of synchronizing movement of at least one of the caps with that of at least a portion of the case member; and arranging the cap to have the nonuse and use configurations as the portion of the case member is displaced to a nonuse position and an use position, respectively, in response to input force supplied by an user.

Various product-by-process claims may be constructed by combining preambles of the above apparatus claims with bodies of the above method claims. In addition, embodiments of these aspects of the present invention regarding various processes may further include one or more features which have been discussed hereinabove as well as which will be described hereinafter in conjunction with various members, various units thereof, and/or various methods to control various aspects of those members and/or units of the present invention.

Other details of the case members, cap members, cartridge members, and/actuator members and their units of various writing tools of the present invention have been provided in the co-pending applications entire portions of which are incorporated herein by reference.

As used herein, the term “opening” refers to an aperture defined on a case of a case member of a writing tool. Through such an “opening,” a tip of a cartridge member of the writing tool is exposed out of the case when in use so as to allow an user to apply a marking substance such as an ink over an article such as a paper. In general, such an “opening” is arranged to have a fixed shape and size, unless at least a portion of such a case may be arranged to move and to create and destroy such an “opening.”

As used herein, the term “conduit” refers to an aperture defined by two or more caps of a cap member of the writing tool. Such a “conduit” may generally be arranged to be created and destroyed (or closed) by at least one of such caps and, therefore, defines variable shapes and/or sizes. It is to be understood that, in a majority of exemplary aspects and/or embodiments of various writing tools of this invention, the “conduit” of the cap member is arranged to be in a complementary relation with the “opening” of the cap member. In one example, the cap member is disposed adjacent to the “opening” such that the formation and destruction of such a “conduit” result in clearance and obstruction of the “opening,” respectively. In another example, the cap member is disposed at a preset distance but not proximate to the “opening” and aligned across an inner space of a case member of the writing tool so that the formation and destruction of such a “conduit” respectively result in formation and destruction of fluid communication between the inner space and an exterior of the case member of the writing tool and, therefore, indirectly result in clearance and obstruction of the “opening,” respectively. In another example, such a “conduit” may be arranged to have a fixed shape and/or size, but to move in relation to the “opening” such that alignment of such a “conduit” relative to the “opening” result in clearance or obstruction of the “opening.”

A “capping surface” is a portion of a surface of a cap of a cap member of a writing tool which may be disposed within, around, over, on, beneath, below, and/or proximate to the opening and which also contributes to at least one of forming and blocking fluid communication between an interior and an exterior of a case member of the writing tool through such an opening. That is, the “capping surface” refers to those portions of the cap and/or cap member which participate in obstructing and/or clearing of the opening and/or in creating and/or closing a conduit. Therefore, the “capping surface” does not include other portions of the cap and/or cap member which do not participate in the obstructing and/or clearing of the opening and/or creating and/or destroying the conduit. Such a “capping surface” may define a planar surface, a curved surface, and the like.

As used herein, the verb “move” includes various other verbs examples of which may include, but not be limited to, translate along a curvilinear (i.e., a linear and/or curved) path, reciprocate along a similar path, rotate or pivot about a point and/or a rotation axis, rotate or pivot angularly and/or radially, deform at least a portion of a moving subject, and the like.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIGS. 1A to 1F show schematic cross-sectional diagrams of exemplary writing tools exposing tips of their cartridge members out of their case members in their use positions and enclosing the tips inside their case members in their rest positions using different mechanisms according to the present invention;

FIGS. 2A to 2O are schematic top views of exemplary cap members having a single or multiple caps each of which defines a planar capping surface and moves at least substantially parallel with an opening between its off- and on-states according to the present invention;

FIGS. 3A to 3H are schematic top views of exemplary cap members having a single or multiple caps each of which defines a planar capping surface and moves at least substantially transverse to an opening between its off- and on-states according to the present invention;

FIGS. 4A to 4H are schematic top views of exemplary cap members having a single or multiple caps each of which defines a non-planar capping surface and moves at least substantially parallel or transverse to an opening between its off- and on-states according to the present invention;

FIGS. 5A to 5O are schematic top views of exemplary cap members having a single or multiple caps each of which is disposed away from an opening and inside an inner space of a case member and defines a planar or non-planar capping surface between its off- and on-states according to the present invention;

FIGS. 6A to 6J are schematic diagrams of exemplary writing tools for receiving input force and for transmitting such force through various members thereof according to the present invention;

FIGS. 7A to 7L are schematic cross-sectional views of exemplary case members and actuator members for receiving input forces through different arrangements according to the present invention;

FIGS. 8A to 8P are schematic cross-sectional views of exemplary cartridge members moving between rest and use positions thereof and exemplary cap members operating between their off- and on-states thereof according to the present invention;

FIGS. 9A to 9P are schematic cross-sectional views of exemplary cartridge members directly or indirectly actuating cap members and/or caps thereof to operate between their off- and on-states according to the present invention;

FIGS. 10A to 10P are schematic cross-sectional views of exemplary cartridge members fixedly or movably incorporating cap members thereinto to actuate such cap members and/or caps thereof to operate between their off- and on-states according to the present invention;

FIGS. 11A to 11H are schematic cross-sectional views of exemplary cap members directly or indirectly actuating cartridge members to move between their rest- and use-positions according to the present invention; and

FIGS. 12A to 12H are schematic cross-sectional views of exemplary recoil units coupling with and actuating cap members between their off- and on-states according to the present invention.

### DETAILED DESCRIPTION OF THE PREFERRED EMBODIMENTS

The present invention generally relates to writing tools for applying volatile marking substances over articles but not including removable caps in one ends thereof to prevent drying of their tips. More particularly, the present invention generally relates to writing tools incorporated with one or more caps which fixedly or movably couple with such tools, operate between off-states and on-states, obstruct openings of such writing tools in order to prevent drying of their tips in the off-states, and clear such openings so as to expose their tips through the openings in the on-states. Such caps of the present invention are preferably synchronized to the tips of the tools so that the caps may clear the openings of the tools as the tips move and become exposed out of the openings and that the caps may obstruct such openings when such tips move back to their original positions after use. In addition, the present invention relates to various members of the writing tools such as, e.g., case members, cap members, cartridge members, actuator members, and so on, as well as to various units of these members such as, e.g., absorber units for absorbing the marking substances spilling through the tips and recoil units for providing driving force for movement of those caps. The present invention also relates to various methods of preventing drying of such tips of the writing tools without having to use removable caps, those of incorporating various caps into the writing tools and obstructing and clearing the openings of the writing tools thereby, those of exposing and enclosing such tips of the writing tools between use and rest positions while preventing or minimizing leaking of the marking substances out of the writing tools, those of and so on. The present invention further relates to various processes of providing any of the above writing tools, their members, and/or their units.

Various exemplary aspects and/or embodiments of capless writing tools and methods therefor of the present invention will now be described more particularly with reference to the accompanying drawings and/or text, where such aspects and embodiments may only represent different forms. The capless writing tools and methods therefor of the present invention, however, may also be embodied in many other different forms and, therefore, should not be limited to those aspects and embodiments set forth herein. Rather, various exemplary aspects and embodiments described herein are provided such that this disclosure will be thorough and complete and fully convey the scope of this invention to one skilled in the relevant art.

Unless otherwise specified, it is to be understood that various members, units, elements, and parts of the writing tools of the present invention are not generally drawn to scales and/or proportions for ease of illustration. It is also to be understood that such members, units, elements, and/or parts of the writing tools of the present invention designated by the same numerals may typically represent the same, similar, and/or functionally equivalent members, units, elements, and parts thereof, respectively

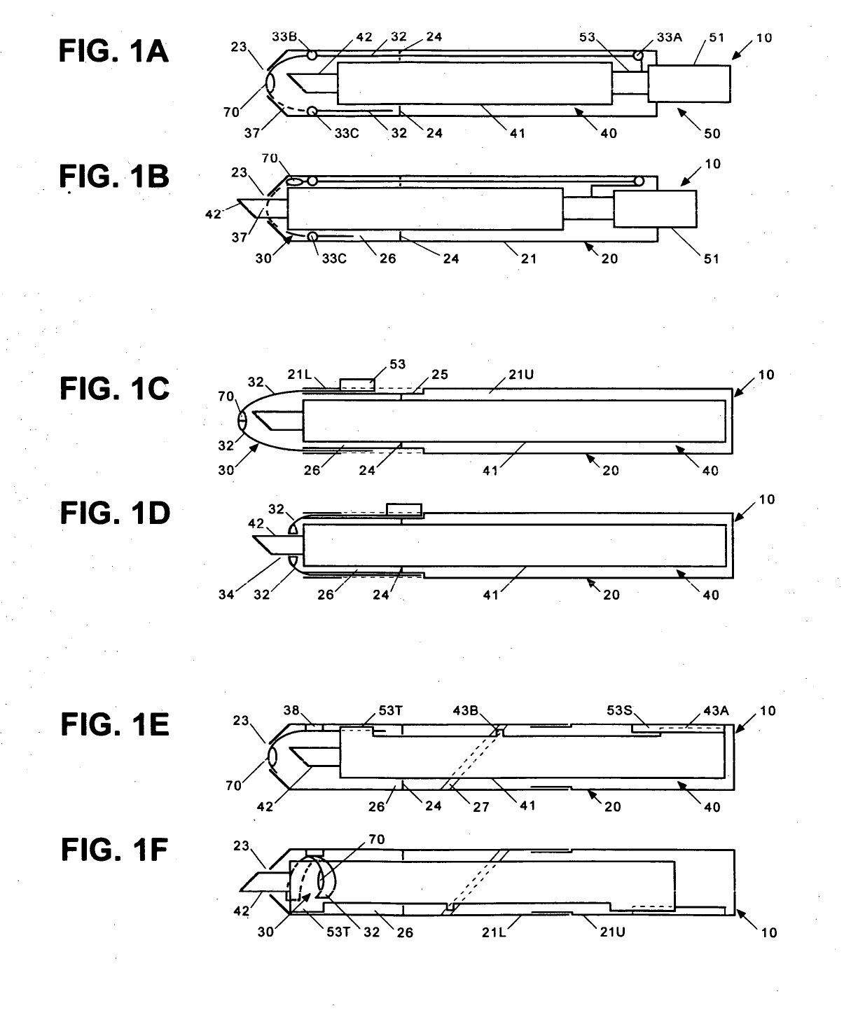

FIGS. 1A to 1F show schematic cross-sectional diagrams of exemplary writing tools exposing tips of their cartridge members out of their case members in their use positions and enclosing the tips inside their case members in their rest positions using different mechanisms according to the present invention.

In one aspect of the present invention, a writing tool may include a cartridge member of which a tip may be arranged to be retracted inside an inner space of a case member and pushed out of such a case member, while a cap of a cap member may be arranged to be coupled to the cartridge member, to operate between its off- and on-states, respectively, and to obstruct and to clear an opening of the case member, respectively, such that the tip of the case member may be exposed as the cap member is in its on-state and enclosed inside the inner space as the cap member is in its off-state.

FIG. 1A is a schematic cross-sectional diagram of an exemplary writing tool which includes a translating actuator member, a translating cartridge member coupling with the actuator member, and a translating cap member coupling with the actuator member and which is disposed in its rest position, whereas FIG. 1B shows a schematic cross-sectional diagram of the exemplary writing tool of FIG. 1A disposed in its use position according to the present invention. An exemplary writing tool 10 generally includes at least one case member 20, at least one cap member 30, at least one cartridge member 40, and at least one actuator member 50, where each member 20-50 in turn includes various units and/or parts as will be described below in greater detail. It is to be understood, in all of the following figures, that an upper portion of any of these members 20-50 generally represents such a portion away from an opening of the case member 20, while a lower portion thereof generally represents such a portion proximate to the opening.

The case member 20 includes a case 21, an opening 23, and a divider 24. The case 21 forms a generally oblong shape and is arranged to couple with a handle 51 of the actuator member 50 in one end, while to define the single opening 23 in an opposite end thereof. The case 21 is typically shaped and/or sized so as to movably receive a body 41 of the cartridge member 40 therein and to also allow reciprocating movement of the body 41 therethrough along a longitudinal axis (not shown in the figure) of the case 21. The opening 23 is generally shaped and/or sized to allow movement of a tip 42 of the cartridge member 40 therethrough and typically transverse to the longitudinal axis of the case 21. The divider 24 is preferably arranged to be disposed inside the case 21 and to snugly fit a circumference of a body 41 of the cartridge member 40 in order to define an inner space 26 which typically amounts to only a fraction of an entire void space which would have been defined inside the case 21 without such a divider 24. As will be described in greater detail below, incorporation of such a divider 24 may offer an advantage of decreasing or minimizing a void or dead space which has to be filled by volatile marking substances evaporating from the tip 42 of the cartridge member 40.

The cap member 30 includes a cap 32 and multiple identical, similar or different supports 33. A first support 33A may couple with the case 21 and disposed adjacent to the handle 51 of the actuator member 50, a second support 33B may also be coupled to the case 21 and disposed near the opening 23, while a third support 33C may also be coupled to the case 21 and disposed next to the opening 23 but on an opposite side of the case 21. The cap 32 is generally shaped and/or sized as a rectangular strip and is movably coupled to and supported by the supports 33A-33C. Such a cap 32 also extends through those supports 33A-33C so that one end of the cap 32 extends beyond the third support 33C, that a middle portion of the cap 32 extends through the second support 33B, and that an opposite end of the cap 32 extends beyond the first cap 33A and fixedly couple with the actuator member 50. The cap 32 also defines a hole 37 of which a characteristic dimension may be similar to or slightly greater (or smaller) than that of the opening 23 such that the tip 42 of the cartridge member 40 may move into or out of the case 21.

The cartridge member 40 includes the body 41 and tip 42, where the body 41 includes marking substances therein and where the tip 42 delivers such substances therethrough so that an user may apply the marking substances over an article (e.g., paper) by contacting such a tip 42 with the article. One end of the cartridge member 40 opposite to the other end with the tip 41 is generally arranged to be in contact with the actuator member 50 in order to transmit input force supplied by the user as will be described below. The body 41 may be arranged to have any shapes and/or sizes but preferably conform to the inner space 26 so as to maximize an amount of the marking substances stored therein. Similarly, the tip 42 may be arranged to have any shapes and/or sizes as long as the user may apply the marking substances over the article.

The actuator member 50 includes the handle 51 and an actuator 53, where at least a portion of the handle 51 may be preferably exposed through one end of the case 21 in order to receive the input force supplied by the user thereby, while the actuator 53 is arranged to operatively couple with such a handle 51 in order to transmit the input force and/or to convert an amplitude and/or direction of such input force. The actuator 53 may employ any conventional mechanisms which may extend and retract or may vary its length in response to such user input force, where a typical example is a conventional toggling mechanism.

The writing tool 10 also includes an absorber unit 70 which is made of and/or include materials capable of physically (or chemically) absorbing (or adsorbing) the marking substances which may be present in the inner space 26 of the case 21 due to leaking thereof through the tip 42 of the cartridge member 40. The absorber unit 70 may be disposed in any locations inside or outside the case 21 but desirably in the inner space 26 and adjacent to the tip 42 of the cartridge member 40 so as to absorb and remove the leaked marking substances.

In operation, the cartridge member 40 is disposed in its rest position, while the cap member 20 is disposed in its off-state so that the tip 42 of the cartridge member 40 is disposed in the inner space 26 and the cap 32 of the cap member 30 obstructs the opening 23 of the case member 20. Therefore, the tip 42 of the cartridge member 40 may be sealed or isolated from an exterior of the tool 10, thereby preventing or minimizing evaporation of the marking substances therefrom. As the user wants to use the tool 10, he or she pushes, rotates or otherwise manipulates the handle 51 and delivers such input force to the actuator member 50. In response thereto, the actuator 53 may then change its length and may move or translate the entire cartridge member 40 toward the opening 23 of the case member 20. Because one end of the cap 32 of the cap member 30 is fixedly coupled to the actuator 53, one end of such a cap 32 is also pulled by such an actuator 53 while being guided by the first support 33A when the actuator 53 moves or translates away from the rest position and toward the use position of such a cartridge member 40. Therefore, the middle and opposite end portions of the cap 32 are also pulled away from the opening 23, while positioning its hole 37 over, on top of or next to the opening 23 of the case member 20 and enabling the tip 42 of the cartridge member 40 to be exposed therethrough. As the user is finished with writing or drawing, he or she pushes, presses or otherwise manipulates the handle 51 and delivers similar or different input force to the actuator member 50. In response thereto, the actuator 53 may restore its length and may move or translate the entire cartridge member 40 away from the opening 23, while the cap 32 may also move back to its rest position by repositioning the hole 37 away from the opening 23. Accordingly, the tip 42 of the cartridge member 40 may then be sealed or isolated again from the exterior of the tool 10, thereby preventing or minimizing evaporation of such marking substances therefrom when the tool 10 is not in use.

Regardless of the operating states of the cap 32 of the cap member 30 and/or positions of the tip 42 of the cartridge member 40, the divider 24 is arranged to snugly fit the exterior of the body 41 of the cartridge member 40. By disposing the divider 24 as close to the tip 42 as possible, the volume of the inner space 26 may be minimized and the amount of the marking substances evaporating into such inner space 26 may also be minimized, thereby preventing or minimizing buildup of residues or clumps of the marking substances onto or over the tip 42. In addition, by installing the absorber unit 70 inside the inner space 26 or adjacent to the tip 42, any marking substances leaking from the tip 42 due to any pressure changes and/or mechanical impact may be absorbed by such an unit 70, thereby preventing or minimizing smudging or leaking of such substances out of the case 21 of the tool 10.

In another aspect of the present invention, a writing tool may include a case member at least a portion of which may be arranged to expose a tip of a cartridge member in its on-state and to enclose the tip in its off-state. In the alternative, such a writing tool may instead include a cap member having one or multiple caps at least one of which may be arranged to be exposed in its off-position, and then to serve as a part of the case member and retain the tip therein in its off-position.

FIG. 1C is a schematic cross-sectional diagram of an exemplary writing tool which includes a translating actuator member, a stationary cartridge member, and a translating cap member which may be coupled to the actuator member and disposed in its rest position, and FIG. 1D is a schematic cross-sectional diagram of the exemplary writing tool of FIG. 1D and disposed in its use position according to the present invention. Similar to that of FIGS. 1A and 1B, an exemplary writing tool 10 includes at least one case member 20, at least one cap member 30, at least one cartridge member 40, and at least one actuator member 50, where each member has various units and/or parts as will be described below.

The case member 20 includes an upper case 21U, a lower case 21L, a guide 25, and a divider 24. The upper case 21U may define a typically oblong shape and retain an upper portion of a body 41 of a cartridge member 40 therein, while the lower case 21L may be arranged to movably couple with and to be movably disposed over the upper case 21U near a tip 42 of the cartridge member 40. More particularly, a lower portion of the upper case 21U is recessed and arranged to serve as the guide 25 for an actuator as described below. Similar to that of FIGS. 1A and 1B, the divider 24 is also provided inside the upper case 21U and defines an inner space 26 for decreasing or minimizing a void or dead space which is to be filled by volatile marking substances evaporating from the tip 42 of the cartridge member 40.

The cap member 30 may include at least two caps 32. More particularly, lower portions of the caps 32 are arranged to match or overlap each other in their off-state in order to encircle the tip 42 of the cartridge member 40 and to seal such a tip 42 from the exterior of the tool 10 in their off-state. To the contrary, upper portions of the caps 32 are arranged to be movably disposed on or over the lower portion of the case 21 so that the caps 32 may translate along the guide 25 of the case member 20. In addition, the caps 32 are arranged to move apart from each other in their on-states by a characteristic dimension so that the tip 42 of the cartridge member 40 may be exposed through a conduit 34 defined between the caps 32. It is to be understood that such caps 32 according to such an embodiment may also be classified as parts of the case member 20 such as, e.g., a movable lower case.

The cartridge member 40 includes the body 41 and tip 42, where the body 41 similarly includes marking substances and where the tip 42 delivers such marking substances therethrough. An upper end of the cartridge member 40 may be arranged to contact an upper part of the upper case 21U or, in the alternative, to be disposed at a preset distance from such a part. The body 41 may be arranged to have any shapes and/or sizes so as to maximize an amount of the marking substances stored therein. Similarly, the tip 42 may be arranged to have any shapes and/or sizes as long as the user may easily apply the marking substances over the article.

The actuator member 50 includes an actuator 53 which is arranged to be movably disposed on the upper portion of the upper portion of the lower case 21L and to receive the input force supplied by the user. Such an actuator 53 is also arranged to be coupled to each upper end of the caps 32 and to translate (or rotate when desirable) along the guide 25 defined on the lower portion of the upper body 21U. The actuator 53 may employ any conventional mechanisms which may translate (or rotate) and vary its location with respect to the tip 42 of the cartridge member 40.

The writing tool 10 also includes an absorber unit 70 similar or identical to that of FIGS. 1A and 1B which may also be disposed in any locations inside or outside the case lower 21L but desirably in the inner space 26 and adjacent to the tip 42 of the cartridge member 40 so as to absorb and remove the leaked marking substances. In the above embodiment where the cap member 30 includes multiple caps 32, the absorber unit 70 may consist of multiple parts as well each of which may be disposed in each of such caps 32.

In operation, the cap member 20 is disposed in its off-state where its caps 32 are exposed out of the lower case 21L and enclose the tip 42 of the cartridge member 40 in the inner space 26 defined by such caps 32 and divider 24. Accordingly, the tip 42 may be sealed or isolated from the exterior of the tool 10, thereby preventing or minimizing evaporation of the marking substances therefrom. When the user wants to use the writing tool 10, he or she delivers input force to the actuator member 50 by, e.g., translating, rotating or otherwise moving the actuator 53 from its rest position to its use position. Because the caps 32 are coupled thereto, the actuator 53 moves to its use position while pulling such caps 32 upward along the guide 25, disposing the upper portions of the caps 32 between the lower portions of the lower case 21L, and creating the conduit 34 between the lower ends of such caps 32. Accordingly, application of the input force may result in exposing the tip 42 of the cartridge member 40 through the conduit 34 and enabling the user to apply the marking substances stored in the body 41 of the cartridge member 40 onto the article. When the user is finished with writing or drawing, he or she translates, rotates or otherwise moves the actuator 53 back to its rest position. In response thereto, the cap 32 are pulled downward and exposed out of the lower case 21L, while closing the conduit 34 and sealing and/or isolating the tip 42 again from the exterior of the writing tool 10, thereby minimizing or preventing evaporation of the marking substances therefrom when the user is not using the tool 10. Similar to that of FIGS. 1A and 1B, the divider 24 is arranged to snugly fit the exterior of the body 41 of the cartridge member 40, thereby minimizing the volume of the inner space 26 and the amount of such marking substances evaporating into such inner space 26 and preventing and/or minimizing buildup of residues or clumps of the marking substances onto or over the tip 42. In addition, the absorber unit 70 is also arranged to absorb the marking substances leaked from the tip 42 as described above, thereby preventing or minimizing smudging or leaking of such substances out of the tool 10.

In another aspect of the present invention, a writing tool may instead have a cartridge member of which a tip may be arranged to be retracted in an inner space of a case member and rotated out of the case member, while a cap of a cap member may be arranged to couple with an actuator member, to operate between its off- and on-states, respectively, and to obstruct and to clear an opening of the case member, respectively, so that the tip of the case member may be pulled out of the case member and exposed when the cap member is in its on-state and pulled back into the inner space as the cap member is in its off-state.

FIG. 1E is a schematic cross-sectional diagram of an exemplary writing tool which includes a rotating case member, a rotating cartridge member coupling with the case member, and a rotating cap member coupling with the case member and which is disposed in its rest position, whereas FIG. 1F is a schematic cross-sectional diagram of the exemplary writing tool shown in FIG. 1E which is disposed in its use position according to the present invention. Similar to those described in FIGS. 1A to 1D, an exemplary writing tool 10 includes at least one case member 20, at least one cap member 30, at least one cartridge member 40, and at least one actuator member 50, where each member includes various units and/or parts as will be described below.

The case member 20 includes an upper case 21U, a lower case 21L, a divider 24, and a track 27. The upper case 21U may define an oblong shape and retain therein an upper portion of a body 41 of a cartridge member 40, whereas the lower case 21L may movably couple with the upper case 21U and retain therein a lower portion of the body 41 including a tip 42 of the cartridge member 40. Such a lower case 21L also defines in its lower portion a single opening 23 which is generally shaped and/or sized to allow movement of the tip 42 therethrough and aligned transverse to a longitudinal axis of the lower case 21U. Similar to those of FIGS. 1A to 1D, the divider 24 is further provided in such a lower case 21L so as to define an inner space 26 therein. The track 27 is typically provided on an inner wall of the lower case 21L, desirably along a spiral path or at an angle with respect to the longitudinal axis of the lower case 21L in order to guide a guide 43B of the cartridge member 40 as will be described in greater detail below.

The cap member 30 includes a single caps 32 and a rotation axis 38. Such a cap 32 generally defines a shape of a strip and is movably coupled to the rotation axis 38 in order to rotate thereabout between its off- and on-states. More particularly, a lower portion of the cap 32 is arranged to match and cover the opening 23 in its off-state in order to encircle the tip 42 of the cartridge member 40 and to seal such a tip 42 from the exterior of the tool 10. In addition, the cap 32 is arranged to move away from the opening 23 and to be disposed radially along the inner wall of the lower case 21L as the cap 32 rotates about the rotation axis 38 and clears the opening 23 in its on-state. Accordingly, the tip 42 of the cartridge member 40 may be exposed through the opening 23 when the cap 32 moves to its on-state.

The cartridge member 40 includes the body 41 and the tip 42 and defines a pair of guides 43A, 43B therealong. Similar to those of FIGS. 1A to 1D, the body 41 similarly contains marking substances therein, and the tip 42 delivers such marking substances therethrough. An upper end of such a body 41 is protruded out to form the first guide 43A, while a lower end of the body 41 is similarly protruded to form the second 43B. As will be described below, such guides 43A, 43B are shaped and/or sized to receive and to transmit the input force, respectively. An upper end of the cartridge member 40 may be arranged to contact an inner and upper end of the upper case 21U or, alternatively, to be disposed at a preset distance from such an end. Such a body 41 may be arranged to have any shapes and/or sizes so as to maximize an amount of the marking substances stored therein, whereas the tip 42 may also be arranged to define any shapes and/or sizes as long as the user may easily apply the marking substances over the article.

The actuator member 50 includes a pair of actuators 53S, 53T, where the first actuator 53S is fixedly disposed over the inner wall of the upper portion of the upper case 21U, whereas the second actuator 53T is fixedly disposed over the lower portion of the body 41 of the cartridge member 40. In particular, the first actuator 53S is shaped and/or sized or protruded inward to contact the first guide 43A, while the second actuator 53T is shaped and/or sized or protruded outward to contact an upper end of the cap 32. Thus, the actuators 53S, 53T may respectively rotate the body 41 of the cartridge member 40 and the cap 32 of the cap member 30 in response to the input force. It is to be understood that those actuators 53S, 53T according to such an embodiment may also be classified as parts of the case member 20 and cartridge member 40, respectively.

The writing tool 10 also includes an absorber unit 70 similar or identical to those of FIGS. 1A to 1D which may also be disposed in any locations inside or outside the case lower 21L but desirably in an inner surface of the cap 32 and adjacent to the tip 42 of the cartridge member 40 in order to absorb and remove the leaked marking substances.

In operation, the cartridge member 40 is disposed in its rest position, while the cap member 20 is disposed in its off-state so that the tip 42 of the cartridge member 40 is disposed in the inner space 26, the cap 32 of the cap member 30 obstructs the opening 23 of the case member 20, and the tip 42 of the cartridge member 40 is sealed or isolated from an exterior of the tool 10, thereby preventing or minimizing evaporation of the marking substances therefrom. As the user wants to use the tool 10, he or she rotates or otherwise manipulates the upper case 21U to deliver such input force to the actuator member 50. In response thereto, the actuator 53 pivots the entire cartridge member 40 by transmitting the input force to the body 41 thereof through the first actuator 53S. Because the second guide 43B is movably retained by or within the track 27 of the case member 20, rotation of the upper case 21U (or cartridge member 40) from its rest position to its use position also results in translation of the body 41 toward the opening 23. In addition, the second actuator 53T which is installed on the lower portion of the body 41 radially pivots the cap 32 of the cap member 30 about the axis of rotation 38 along the inner wall of the lower case 21L as the body 41 rotates in response to the input force. Therefore, as the cartridge member 40 rotates and moves forward or downward toward the opening 23, the cap 32 pivots away from and clears the opening 23, thereby exposing the tip 42 through the opening 23. As the user is done with writing or drawing, he or she rotates or otherwise manipulates the upper case 21U in a reverse direction, which also results in another rotation of the entire cartridge member 40 in a reverse direction and translation thereof away from the opening 23. In addition, the cap 32 also pivots back toward and obstructs the opening 23. Accordingly, the tip 42 of the cartridge member 40 may be sealed or isolated from the exterior of the tool 10. Similar to those of FIGS. 1A through 1D, the divider 24 is arranged to snugly fit the exterior of the body 41 of the cartridge member 40, thereby minimizing the amount of such marking substances evaporating into such inner space 26 and minimizing buildup of residues or clumps of the marking substances onto or over the tip 42. In addition, the absorber unit 70 is arranged to absorb the marking substances leaked from the tip 42 as described above, thereby preventing or minimizing smudging or leaking of such substances out of the tool 10.

As exemplified in these figures, various cap members including a single or multiple caps having a variety of shapes and/or sizes may be incorporated into the writing tools of the present invention. In general, the cap members, caps, and/or at least portions thereof may be installed inside and/or outside various cases of the case member. Such cap members, caps, and/or at least portions thereof may be disposed away from, near, over, below, and/or across an opening of the case member, and may also fixedly or movably couple with and/or may be supported by various members of the writing tools such as, e.g., the case, cartridge, and/or actuator members. As will be described in detail below, such cap members, caps, and/or at least portions thereof may preferably be arranged to seal and isolate tips of the cartridge members from the exterior in their off-states, and to allow such tips to be exposed out of the case members in their on-states. Although not mandatory, at least portions of the cap members or their caps may be disposed inside the case members for aesthetic reasons or outside such members in order to attract attention. Similarly, at least portions of the cap members or their caps may also be disposed inside the case members so as to protect such portions or to minimize mechanical damages thereto. Conversely, if at least portions of the cap members or caps may have to be disposed outside the case members, such portions may preferably have sturdy and foolproof configuration.

Various cap members for the writing tools of the present invention may be classified based on various configurational and/or operational characteristics of various parts of the writing tools such as, e.g., presence or absence of openings provided on the case members, shapes and/or sizes of such openings, geometry of capping surfaces of such caps, movement patterns of such caps and/or their capping surfaces, and the like. For example, such cap members may be classified into those of a first class which may be suited for openings which are generally stationary and/or has a fixed shape, and those of a second class which may be suited for other openings at least portions of which may move and/or vary their shapes and/or sizes.

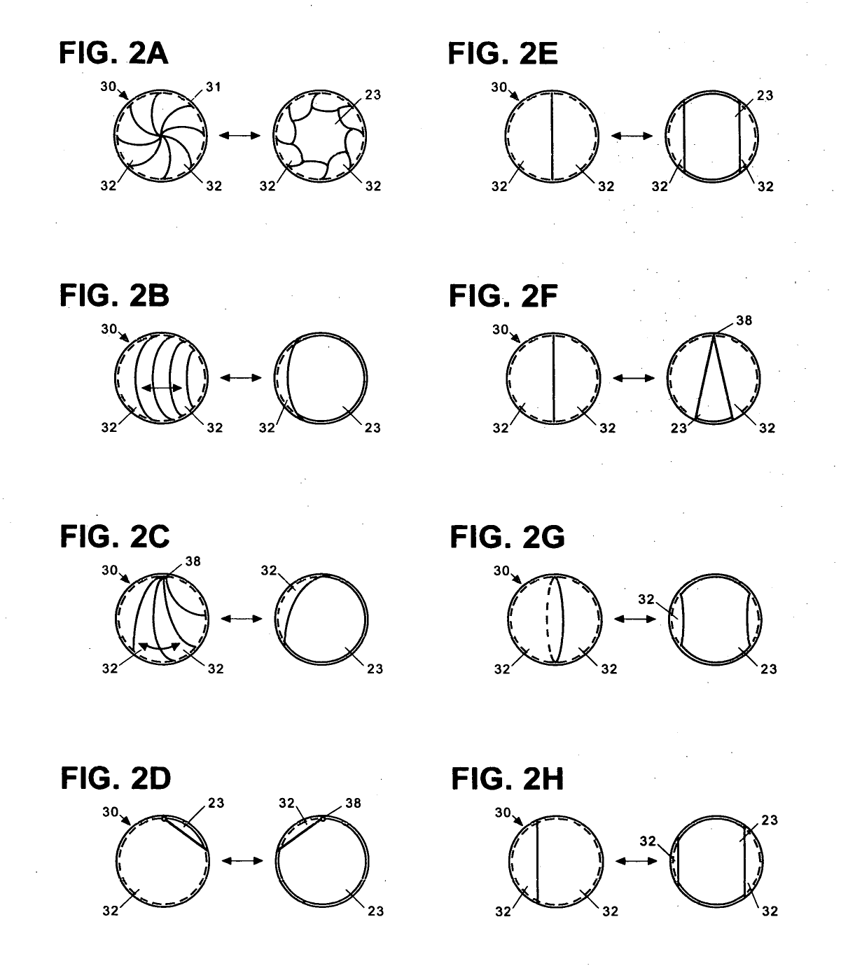

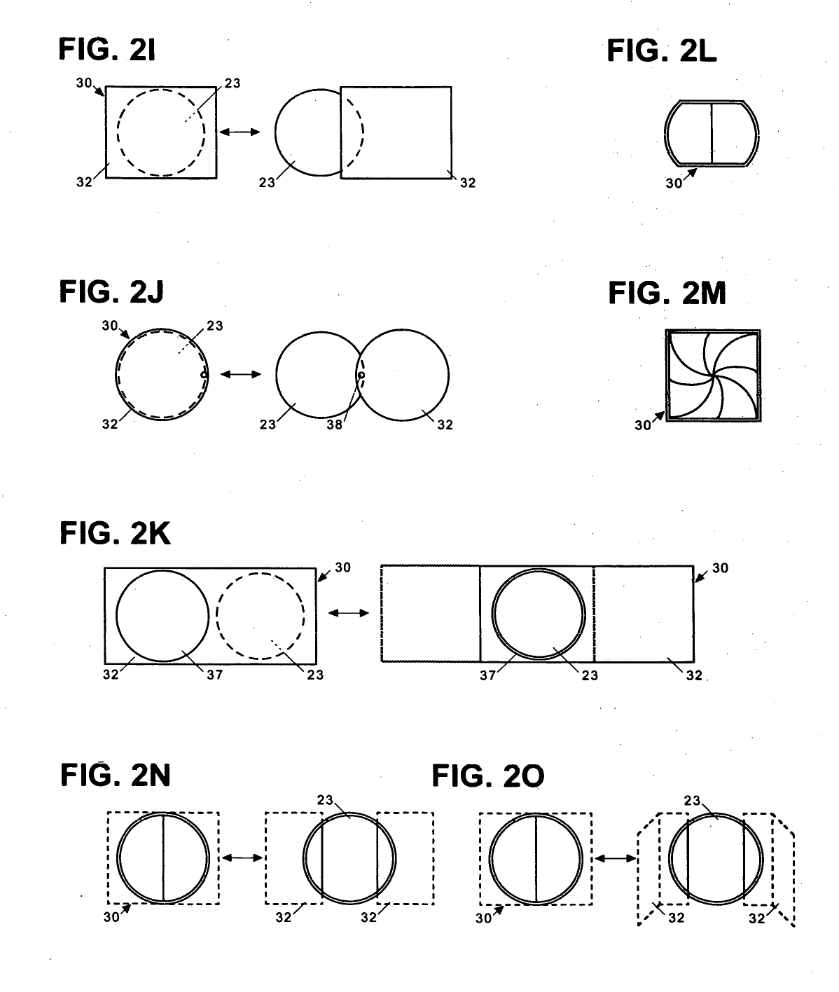

The cap members of the foregoing first class may further be subclassified into those of a first subclass which are arranged to be disposed adjacent to such openings and to respectively obstruct and clear the openings between their off- and on-states, and into those of a second subclass which are arranged to be disposed away from the openings and to respectively create and close conduits in their off- and on-states. In general, any cap members of such a first subclass may be characterized by their disposition adjacent to the openings and/or their operative couplings with the openings. Such cap members may also be characterized by movements or operations of their caps between their off- and on-states in order to respectively obstruct and clear at least substantial portions of the openings. Accordingly, at least portions of the caps of such cap members may preferably be disposed on, over, below or across the openings or, in the alternative, away from such openings but not at a significant distance. The caps may also be arranged to directly contact the openings in their off-states or, in the alternative, to indirectly contact such openings in their off-states through any interposing articles such as, e.g., ferules, o-rings, and other conventional sealing articles. In contrary, any cap members of the foregoing second subclass may be characterized by their disposition away from the openings and/or by their movements or operations of creating and closing conduits between their on- and off-states in order to respectively expose the tips out of the case members and seal such tips from the exterior of the writing tools. Thus, at least portions of such caps are typically arranged to not directly contact the openings of the case members. In addition, the cap members of the above first subclass may further be classified into those of a first type having planar capping surfaces and into those of a second type having non-planar capping surfaces. FIGS. 2A to 2O, FIGS. 3A to 3H, FIGS. 4A to 4H, and FIGS. 5A to 5H exemplify some cap members and their caps falling into some of the above classifications.

In another aspect of the present invention, various cap members may be arranged to include at least one cap which is arranged to define a planar capping surface and to operate or otherwise move between its on- and off-states along a direction which is at least substantially parallel with an opening of a case member and/or at least substantially transverse or normal to a longitudinal axis of the case member. FIGS. 2A to 2O depict schematic top views of exemplary cap members including a single or multiple caps each of which forms a planar capping surface and which moves at least substantially in parallel with an opening between its off-states and on-states according to the present invention. It is appreciated that the exemplary cap members of these figures may typically be classified into those of the first type of the first subclass of the first class as described above. It is further to be understood that exemplary embodiments of various cap members of FIGS. 2A to 2O are only intended to illustrate various examples of such an aspect of this invention, but not to limit the scope of this invention. It is to be understood that only portions of various caps in the following figures may be identified when they are disposed in an area above or below the opening, whereas other portions of such caps disposed outside of such an area may be ignored for simplicity of illustration.

In one exemplary embodiment of the above aspect of the present invention, multiple caps may be arranged to radially move or rotate inwardly and outwardly. FIG. 2A is a schematic top view of an exemplary cap member including multiple caps with planar capping surfaces and moving centrifugally and centripetally toward their off- and on-states, respectively, according to the present invention. An exemplary cap member 30 includes a frame 31 and multiple caps 32, where the frame 31 has a shape of an annular ring, while the caps 32 are movably disposed with respect to the frame 21 and shaped and/or sized similar to an iris diaphragm of a conventional reflex camera. Accordingly, such caps 32 are generally identical to each other, and arranged to obstruct an opening 23 when they are disposed adjacent to each other in their off-states and to clear such an opening 23 in their on-states when they move apart from each other outwardly and/or along the centripetal direction. It is appreciated that the caps 32 of such an embodiment may begin to clear the opening 23 from a center of the frame 31 while moving centrifugally from their off- to on-states, and then to obstruct the opening 23 from a periphery of the frame 31 while moving centripetally from their on- to off-states.

In related exemplary embodiments of this aspect of the present invention, FIG. 2B represents a schematic top view of another exemplary cap member including multiple caps forming planar capping surfaces and translating horizontally between its off- and on-states, while FIG. 2C is a schematic top view of another exemplary cap member which has multiple caps having planar capping surfaces and pivoting about an axis of rotation between its off- and on-states according to the present invention. In general, exemplary cap members 30 include frames 31 similar to that of FIG. 2A and multiple caps 32 which may be identical or similar to each other. However, the caps 32 shown in FIG. 2B are arranged to move or translate sideways similar to a side portion of a conventional conveyer belt, while those 32 of FIG. 2C are arranged to rotate or pivot about an axis of rotation 38 similar to a corner portion of the conventional conveyer belt. Accordingly, such caps 32 may obstruct an opening 23 in their off-states and clear the opening 23 in their on-states. It is appreciated that those caps 32 of these embodiments may begin to clear the opening 23 from one to the other end of the frame 31 by moving from their off- to on-states, and then to obstruct the opening 23 in a reverse direction by moving from their on- to off-states.

In another exemplary embodiment of such an aspect of this invention, a cap member may have a single cap which may be arranged to translate or rotate across an opening between its off- and on-states in order to respectively obstruct and clear the opening. FIG. 2D depicts a schematic top view of another exemplary cap member having a single cap forming a planar capping surface and pivoting about a rotation axis between its off- and on-states according to the present invention. An exemplary cap member 30 includes a frame and a single cap 32 arranged to rotate or pivot about a rotation axis 38 disposed on an edge of the frame. Such a cap 32 generally clears an opening 23 from one to the other end of the frame, and obstructs such an opening 23 in a reverse direction similar to conventional sliding gates. It is appreciated that the cap member 30 exemplified in FIGS. 1E and 1F may correspond to such caps 32 according to this embodiment.

In a related exemplary embodiment of such an aspect of the present invention, a cap member may include multiple caps arranged to move or to rotate toward and away from each other in order to respectively obstruct and clear an opening between their off- and on-states. FIG. 2E is a schematic top view of another exemplary cap member with a pair of caps forming planar capping surfaces and translating toward and away from each other respectively between its off- and on-states according to the present invention. An exemplary cap member 30 includes a frame and a pair of caps 32 which match each other in a center of the frame and obstruct an opening 23 in their off-states. The caps 32 are arranged to translated away from each other toward their on-states and, accordingly, to clear the opening 23 in their on-states, similar to a pair of conventional sliding gates. FIG. 2F is a schematic top view of another exemplary cap member including a pair of caps forming planar capping surfaces and pivoting about a rotation axis toward and away from each other respectively between its off- and on-states according to the present invention. An exemplary cap member 30 includes a frame and a pair of caps 32 which are similar to those of FIG. 2E but arranged to rotate or pivot about a rotation axis 38 between their off- and on-states. The caps 32 of both embodiments may clear the opening 23 from a center of the frame, and obstruct the opening 23 in a reverse direction, similar to conventional rotating and/or sliding gates. It is to be understood that the cap member 30 exemplified in FIGS. 1C and 1D may correspond to such caps 32 according to this embodiment.

In another exemplary embodiment of this aspect of the present invention, multiple caps may be arranged to overlap at least portions of each other in their off-states. FIG. 2G is a schematic top view of another exemplary cap member similar to that of FIG. 2E but having a pair of caps overlapping each other in their off-states and moving away from each other in their on-states according to the present invention. An exemplary cap member 30 has a frame and two caps 32 translating toward and away from each other respectively in their on- and off-states similar to those of FIG. 2E. However, the caps 32 are arranged to overlap each other so as to provide better sealing therethrough or therebetween in their off-states. It is noted that the cap member 30 exemplified in FIGS. 1C and 1D may correspond to such caps 32 according to this embodiment. Other configurational and/or operational characteristics of the caps 32 of FIG. 2G are similar or identical to those of FIG. 2E.

In another exemplary embodiment of this aspect of the present invention, multiple caps may be arranged to have asymmetric shapes and/or sizes. FIG. 2H shows a schematic top view of another exemplary cap member similar to that of FIG. 2E but including a pair of asymmetric caps according to the present invention. An exemplary cap member 30 includes an annular circular frame and a pair of caps 32 which are arranged to match (or overlap) each other and to obstruct an opening 23 in an off-center portion of the frame in their off-states, and then to translate away from each other toward their on-states. It is appreciated that the cap member 30 exemplified in FIGS. 1C and 1D may correspond to such caps 32 according to this embodiment. Other configurational and/or operational characteristics of the caps 32 shown in FIG. 2G are similar or identical to those of FIG. 2E.

In other exemplary embodiments of such an aspect of the present invention, a single cap may be arranged to translate or rotate across an opening, and to obstruct and clear the opening in its off- and on-states, respectively. FIG. 2I shows a schematic top view of another exemplary cap member with a single cap having a planar capping surface and translating toward and away over an opening between its off- and on-states according to the present invention. An exemplary cap member 30 has a single cap 32 which is shaped and sized enough to obstruct an opening 23 in its off-state, and then translates across the opening 23 thereover, thereunder or therebetween to its on-state. Although not shown in the figure, the cap member 30 may include a track along which such a cap 32 may translate between its off- and on-positions. It is to be understood that such a cap 32 tends to clear the opening 23 from one to an opposite end thereof and to obstruct the opening 23 in a reverse direction. FIG. 2J shows a schematic top view of another exemplary cap member having a single cap forming a planar capping surface and pivoting about a rotation axis on an edge of an opening between its off- and on-states according to the present invention. An exemplary cap member 30 has a single cap 32 which is similar to that of FIG. 2I but arranged to rotate or pivot about a rotation axis 38 provided on an edge of an opening 23. Therefore, the cap 32 may rotate from one to the other of its off- and on-states, while obstructing and clearing such an opening 23 provided thereover, thereunder or therebetween. Other configurational and/or operational characteristics of the caps 32 of FIG. 2G may be similar or identical to those of FIG. 2I.

In another exemplary embodiment of such an aspect of this invention, a cap member may have one or multiple caps at least one of which may be arranged to define a hole therein and to align such a hole with an opening in order to obstruct and clear the opening. FIG. 2K shows a schematic top view of another exemplary cap member including a single cap forming a planar capping surface defining a hole and translating on an opening between its off- and on-states according to the present invention. An exemplary cap member 30 includes a single cap 32 defining a hole 37 therealong. Portions of the cap 32 away from the hole 37 are typically shaped and sized enough to obstruct an opening 23, while the hole 37 is shaped and sized to at least similarly match a characteristic dimension, e.g., its diameter, of the opening 23. Such a cap member 30 is preferably arranged to position the cap 32 and to align its hole 37 with respect to the opening 23 such that the portions away from the hole 37 may be disposed over, below or between such an opening 23 in its off-state, and that the hole 37 may be aligned with the opening 23 in its on-state. Accordingly, the cap 32 may obstruct the opening 23 with its portions away from the hole 37 in its off-state and may clear the opening 23 through the hole 37 in its on-state. It is to be understood that the cap member 30 exemplified in FIGS. 1A and 1B may correspond to such caps 32 according to this embodiment.

In other exemplary embodiments of such an aspect of the present invention, cap members may include frames having various shapes different from those exemplified in FIGS. 2A to 2K. FIG. 2L is a schematic top view of another exemplary cap member similar to those of FIGS. 2E and 2F but defined within a frame having a shape of a truncated annular ring, while FIG. 2M shows a schematic top view of another exemplary cap member similar to that of FIG. 2A but defined within a frame of a rectangular shape according to the present invention. Other configurational and/or operational characteristics of the cap members 30 of FIGS. 2L and 2M may be similar or identical to those of FIGS. 2A to 2K.

In other exemplary embodiments of such an aspect of the present invention, various caps may be arranged to maintain shapes and/or sizes of their planar capping surfaces beyond and/or out of an area of an opening or, in the alternative, to change or reduce their shapes and/or sizes beyond and/or out of the opening. FIG. 2N shows a schematic top view of another exemplary cap member similar to that of FIG. 2E, where caps of the cap member maintain their planar configurations beyond an opening according to the present invention. An exemplary cap member 30 has two caps 32 translating toward and away from each other in their off- and on-states, respectively. More particularly, the caps 32 are arranged to maintain their planar capping surfaces not only in a region on or below an opening 23 but also in other regions outside of the opening 23. Accordingly, such caps 32 keep their planar shapes not only in their off-states but also in their on-states. To the contrary, FIG. 2O is a schematic top view of another exemplary cap member similar to that of FIG. 2E, where caps of the cap member change or vary their planar configurations beyond an opening according to the present invention. An exemplary cap member 30 includes two caps 32 similar to that of FIGS. 2E and 2N but arranged to be bent, rolled, folded, stacked or otherwise deformed while moving to their on-states. Therefore, such caps 32 may maintain their planar capping surfaces in a region over or below an opening 23 but undergo changes in their configurations in other regions outside of and/or beyond the opening 23. Both of the foregoing embodiments typically have their pros and cons. For example, the first embodiment in which the caps 32 may always maintain their planar shapes may offer the benefit of employing a simpler mechanism for moving the caps 32 between their off- and on-states, for the planar capping surfaces of the caps 32 may be either pulled or pushed. However, such an embodiment may suffer from a drawback that the caps 32 may require a significant space for their planar movements. To the contrary, the second embodiment where the caps 32 may change their configurations beyond the opening 23 may offer the benefit of less space requirement for the movements of the caps 32, for such caps 32 may be rolled, folded, stacked, bent or otherwise deformed to a more compact structure in their on-states. Such an embodiment may also offer the benefit of minimizing or at least reducing a space of the inner space as well, thereby minimizing the amount of the marking substances to be evaporated from the tip and to fill such an inner space when not in use. However, this second embodiment may require more complex mechanisms to move such caps 32 between their off- and on-states. Selection of either embodiment may depend on various factors such as, e.g., shapes and/or sizes of the cases of the case member, shapes and/or sizes of the bodies of the cartridge member, operational characteristics of the actuator member and/or disposition thereof, and so on, although such selection is generally a matter of choice of one of ordinary skill in the art.

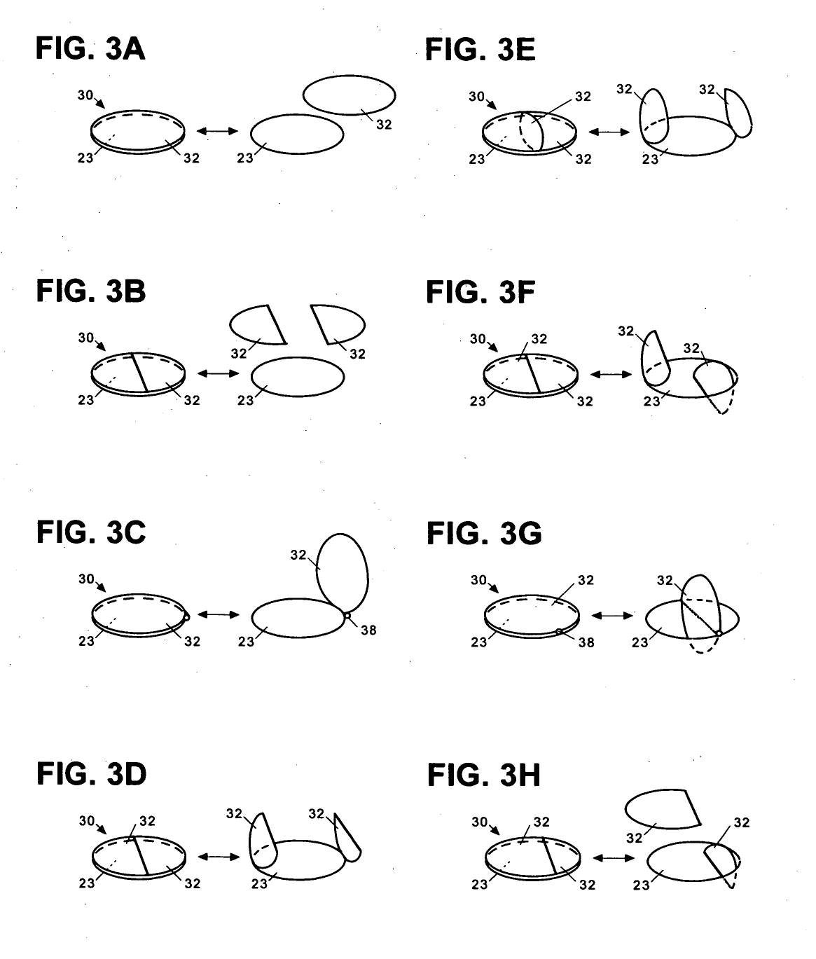

In another aspect of the present invention, various cap members may be arranged to include at least one cap which is arranged to define a planar capping surface and to operate or otherwise move between its on- and off-states in a direction which is at least substantially transverse or normal to an opening of a case member and/or which is at least substantially parallel with a longitudinal axis of the case member. In general, any of the above cap members exemplified in FIGS. 2A to 2O may be varied or modified so that their caps may not move in a direction parallel with an opening and/or transverse to a longitudinal axis of the case member but along a direction transverse or normal to the opening and/or in parallel with the longitudinal axis of the case member. FIGS. 3A to 3H show schematic top views of some exemplary cap members with a single or multiple caps each of which defines a planar capping surface and at least one of which may moves at least substantially transverse to an opening and/or at least substantially in parallel with a longitudinal axis of a case member between its off- and on-states according to the present invention. It is appreciated that the exemplary cap members of the following figures may generally be classified into those of the first type of the first subclass of the first class as described hereinabove. It is also appreciated that exemplary embodiments of various cap members of FIGS. 3A to 3H are only intended to illustrate various examples of this aspect of the present invention, but not to limit the scope of the present invention. It is to be understood that only portions of various caps in the following figures may be identified when disposed in an area above or below the opening, whereas other portions of the caps disposed outside of such an area may be ignored for simplicity of illustration.

In one exemplary embodiment of this aspect of the present invention, a cap member may have one or more cap members which may translate or may be repositioned along a direction transverse to an opening of a case member. In one example, FIG. 3A shows a schematic top view of an exemplary cap member having a single cap which forms a planar capping surface and translates in a transverse direction relative to an opening between its off- and on-states according to the present invention. An exemplary cap member 30 includes a single cap 32 shaped and sized enough to obstruct an opening 23 in its off-position. The cap 32 is also arranged such that an entire portion thereof may be disposed away from the opening 23 toward its on-state by, e.g., an user, actuator member, and the like. In this context, the cap 32 may obstruct and clear the opening 23, not starting from a specific portion thereof but along an entire or a substantial portion of its periphery. In another example, FIG. 3B is a schematic top view of another exemplary cap member having a pair of caps having planar capping surfaces and translating toward and away from each other in a transverse direction from an opening to its off- and on-states, respectively, according to the present invention. An exemplary cap member 30 has a pair of caps 32 which may be shaped and/or sized enough to obstruct an opening 23 in their off-positions, and may be disposed away from the opening 23 while being separated apart from each other toward their on-states. Such caps 32 tends to clear the opening 23 from its center portion and to obstruct the opening 23 from opposing ends thereof. As described above, the cap member 30 of FIG. 3A may also be constructed by modifying some embodiments of FIGS. 2A through 2M and/or may also be applied to modify some of such embodiments, e.g., those of FIGS. 2D and 2I, while the cap member 30 of FIG. 3B may be provided by modifying some of such embodiments and/or may also be used to modify some of such embodiments, e.g., those of FIGS. 2E, 2F, 2G, 2H, and 2L.

In another exemplary embodiment of such an aspect of this invention, a cap member may have one or more cap members which may rotate or pivot about a rotation axis along a direction transverse to an opening of a case member. In one example, FIG. 3C describes a schematic top view of another exemplary cap member including a single cap forming a planar capping surface and pivoting about an axis of rotation provided on an edge of an opening along a transverse direction from the opening to its off- and on-states according to the present invention. An exemplary cap member 30 includes a single cap 32 which is shaped and sized enough to obstruct an opening 23 in its off-position and to rotate or pivot about an axis of rotation 38 in a direction away from such an opening 23, similar to conventional pivoting gates. Such a rotation axis 38 may be typically provided on one edge of the opening 23 or at a preset distance therefrom, where an exact disposition of such a rotation axis 38 may not be material to the scope of this invention as long as the cap 32 may be able to pivot and to properly obstruct and clear such an opening 23. In another example, FIG. 3D is a schematic top view of another exemplary cap member similar to that shown in FIG. 3C but including a cap pivoting about a rotation axis provided across opposing edges of an opening along a transverse direction from the opening to its off- and on-states according to the present invention. An exemplary cap member 30 includes a pair of caps 32 similar to those of FIG. 3B but arranged to rotate or pivot in opposite directions toward their on-states. Accordingly, such caps 32 may clear the opening 23 from its center portion and obstruct the opening 23 along a reverse direction. As described above, the cap member 30 of FIG. 3C may be provided by modifying some embodiments of FIGS. 2A to 2M and/or may be applied to modify some of the previous embodiments, e.g., those of FIGS. 2D and 2I, while the cap member 30 of FIG. 3D may be provided by modifying some of such embodiments and/or may be used to modify some of such embodiments, e.g., those of FIGS. 2E, 2F, 2G, 2H, and 2L.

In another exemplary embodiment of such an aspect of this invention, a cap member may have multiple caps at least two of which overlap each other in their off-states. FIG. 3E shows a schematic top view of another exemplary cap member similar to that shown in FIG. 3D but having a pair of caps overlapping each other in its off-state according to the present invention. An exemplary cap member 30 includes a pair of caps 32 similar to those of FIG. 3D but arranged to overlap each other in their off-states, thereby ensuring better sealing therebetween. Because of the overlap, the caps 32 may have to rotate or pivot interposed by at least a non-negligible temporal difference in order to avoid collision during simultaneous rotating or pivoting movements thereof. As described above, the cap member 30 of FIG. 3E may be fabricated by modifying some embodiments of FIGS. 2A to 2M and/or may be applied to modify some of such embodiments, e.g., those shown in FIGS. 2E, 2F, 2G, and 2H.

In another exemplary embodiment of such an aspect of this invention, a cap member may have multiple caps at least two of which may translate, rotate or pivot between their off- and on-states but along different or opposite directions. FIG. 3F shows a schematic top view of another exemplary cap member similar to that of FIG. 3D and including a pair of caps pivoting about similar rotation axes but in opposite transverse directions between its off- and on-states according to the present invention. An exemplary cap member 30 includes a pair of caps 32 similar to those of FIG. 3D but arranged to rotate or pivot in opposite directions such as, e.g., one cap 32 pivoting upwardly or inwardly into the case to its on-state, while the other cap 32 pivoting downwardly or outwardly from the case to its on-state. As described above, the cap member 30 of FIG. 3F may be provided by modifying some embodiments of FIGS. 2A to 2M and/or may be applied to modify some of such embodiments, e.g., those of FIGS. 2E, 2F, 2G, and 2H.

In another exemplary embodiment of such an aspect of this invention, a cap member may have one or multiple caps at least one of which may rotate or pivot between their off- and on-states about an axis of rotation provided across an opening. FIG. 3G is a schematic top view of another exemplary cap member having a pair of caps defining planar capping surfaces and pivoting about a rotation axis provided across an opening in a transverse direction from the opening between its off- and on-states according to the present invention. An exemplary cap member 30 has a single cap 32 similar to those of FIGS. 3A and 3C, but arranged to pivot about a rotation axis 38 extending from one to another edge of an opening 23. Accordingly, different portions of the cap 32 disposed opposite to each other with respect to the rotation axis 38 are arranged to move into different directions toward their on-states so that one portion moves inwardly and the other portion moves outwardly with respect to the case. As described above, the cap member 30 of FIG. 3G may be provided by modifying some embodiments of FIGS. 2A to 2M and/or may be used to modify some such embodiments, e.g., those of FIGS. 2E, 2F, 2G, and 2H.

In another exemplary embodiment of such an aspect of this invention, a cap member may have multiple caps at least two of which move between their off- and on-states according to two different embodiments of FIGS. 3A through 3G. FIG. 3H shows a schematic top view of another exemplary cap member including a pair of asymmetric caps which has planar capping surfaces and which translates and/or pivots between their off- and on-states according to the present invention. An exemplary cap member 30 includes two caps 32 with different shapes and sizes but arranged to obstruct an opening 23 in their off-states. One of the caps 32 is then arranged to move to its on-state by translating away from the opening 23 similar to that of FIG. 3A, while the other 32 thereof is arranged to rotate or pivot away from the opening similar to that of FIG. 3F. As described above, the cap member 30 of FIG. 3H may be provided by modifying and/or combining some embodiments of FIGS. 2A to 2M and/or may also be applied to modify some of such embodiments, e.g., those of FIGS. 2D, 2E, 2G, and 2H.

In other exemplary embodiments of such an aspect of the present invention, various caps may be arranged to maintain shapes and/or sizes of their planar capping surfaces beyond and/or out of an area over, below, projected upward, and/or projected downward an opening or, in the alternative, to change or to reduce their shapes and/or sizes beyond and/or out of the area. Various caps provided by such embodiments may also have configurational and/or operational characteristics similar to those described in conjunction with FIGS. 2N and 2O.

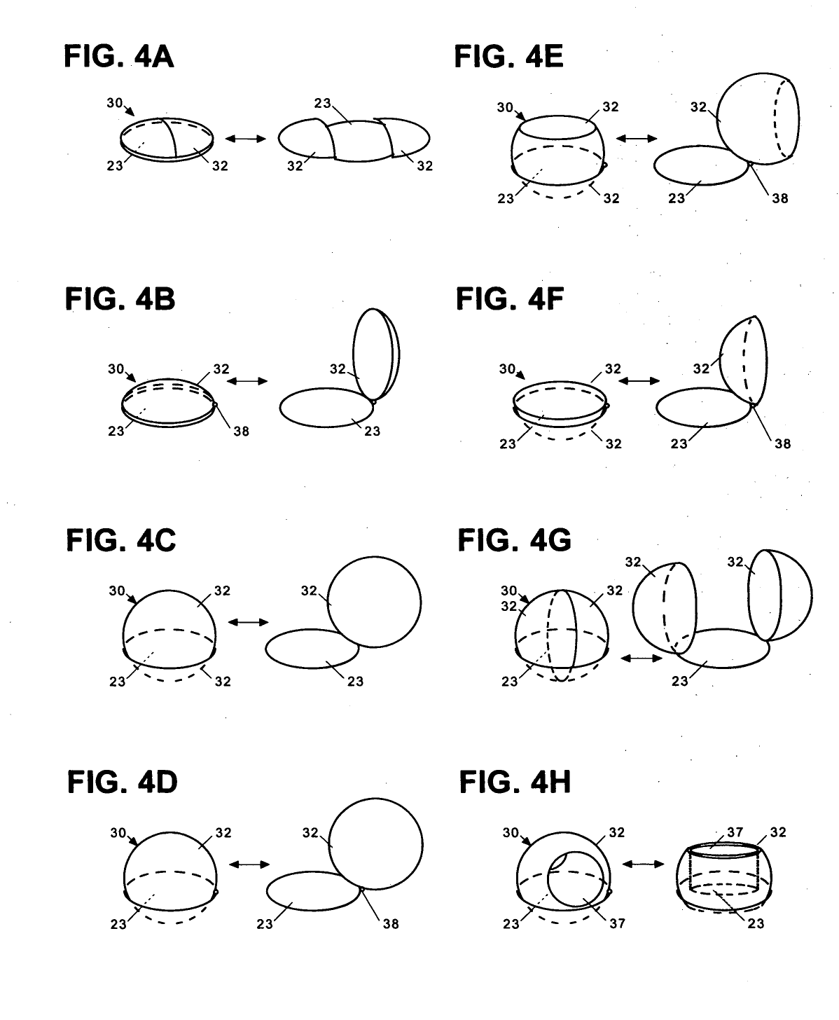

In another aspect of the present invention, various cap members may be arranged to include at least one cap which is arranged to define a non-planar capping surface and to operate or otherwise move between its on- and off-states along at least one curvilinear direction which may be transverse, normal or parallel with an opening of a case member or which may be parallel, transverse or normal to a longitudinal axis of the case member. In general, any of the above cap members exemplified in FIGS. 2A to 2O and FIGS. 3A to 3H may be varied or modified to construct cap members of this aspect of the present invention, e.g., by arranging at least a portion of at least one cap thereof to be convex inward or outward with respect to an opening and/or case of a case member. FIGS. 4A to 4H are schematic top views of some exemplary cap members with a single or multiple caps at least one of which forms a non-planar capping surface and moves between its off- and on-states along at least one curvilinear directions according to the present invention. It is appreciated that the exemplary cap members of the following figures may generally be classified into those of the second type of the first subclass of the first class as described hereinabove. It is further appreciated that exemplary embodiments of various cap members of FIGS. 4A through 4H are only intended to illustrate various examples of this aspect of the present invention, but not to limit the scope thereof. It is to be understood that only portions of the caps in the following figures may be identified when disposed in an area above or below the opening, whereas other portions of the caps disposed outside of such an area may be ignored for simplicity of illustration.

In one exemplary embodiment of this aspect of the present invention, a cap member may have multiple caps which translates toward and away from each other in their off- and on-states. FIG. 4A shows a schematic top view of an exemplary cap member including a pair of caps forming non-planar capping surfaces and translating toward and away from each other from one to the other of their off- and on-states according to the present invention. An exemplary cap member 30 may have two caps 32 similar to those of FIG. 2E but having curvature of being concave upward or downward, matching each other and shaped and sized to obstruct an opening 23 in their off-states. The caps 32 are then arranged to move away from each other along parallel but opposite directions toward their on-states in order to clear such an opening 23. As described above, the cap member 30 shown in FIG. 4A may be provided by modifying the caps of some of the above embodiments and/or may be used to modify some of such embodiments, e.g., those of FIGS. 2E, 2G, 2H, and 3B.

In another exemplary embodiment of such an aspect of this invention, a cap member may have another single cap arranged to rotate or pivot toward and away from an opening between its off- and on-states. FIG. 4B shows a schematic top view of another exemplary cap member including a single cap forming a non-planar capping surface and pivoting about a rotation axis on an edge of an opening between its off- and on-states according to the present invention. An exemplary cap member 30 has a single opening similar to that of 3C but having curvature of being concave upward or downward in order to obstruct an opening 23 in its off-position. Other configurational and/or operational features of such a cap member 30 are similar or identical to those of FIG. 3C. As described hereinabove, the cap member 30 of FIG. 4B may be provided by modifying the caps of some of the previous embodiments, and/or may be applied to modify some of such embodiments, e.g., those of FIGS. 2D, 2I, 2J, and 3C.

In other exemplary embodiments of such an aspect of this invention, a cap member may have a ball-shaped cap arranged to move around an opening between its off- and on-states. FIG. 4C is a schematic top view of another exemplary cap member including a single spherical cap forming a non-planar capping surface and rolling toward and away from an opening between its off- and on-states, whereas FIG. 4D represents a schematic top view of another exemplary cap member having a single spherical cap similar to that of FIG. 4C but pivoting about an axis of rotation on an edge of an opening between its off- and on-states according to the present invention. Both exemplary cap members 30 include a spherical cap 32 which is arranged to be shaped and/or sized to obstruct an opening 23 in their off-states. Such a cap 32 is arranged to roll away from the opening 23 along a preset direction while being optionally guided along a track (not shown in the figure) toward its on-position in FIG. 4C, whereas the cap 32 is arranged to rotate or pivot about an axis of rotation 38 toward its on-position in FIG. 4D. Thus, such caps 32 may clear the opening 23 in their on-states. As described above, such cap members 30 of FIGS. 4C and 4D may be provided by modifying the caps of some of the previous embodiments, e.g., those of FIGS. 2D, 2I, 2J, 3A, 3C, and 3G. In particular, the cap 32 of FIG. 4D may be modified similar to that of FIG. 2G, e.g., by providing the rotation axis 38 at a distance from such an opening 23 and arranging such an axis 38 through opposing sides of the spherical cap 32 so that the cap 32 may translate not only laterally but also vertically between its off- and on-states.

In another exemplary embodiment of such an aspect of this invention, a cap member may have a cap with a shape of a truncated ball and translating or rotating between its off- and on-states. For example, FIG. 4E shows a schematic top view of another exemplary cap member similar to that of FIG. 4D but having a single spherical cap with a truncated top portion and pivoting about an axis of rotation disposed on an edge of an opening between its off- and on-states, while FIG. 4F shows a schematic top view of another exemplary cap member similar to that of FIG. 4D but having a single cap defining a shape of only a bottom portion of a sphere and pivoting about a rotation axis on an edge of an opening between its off- and on-states according to the present invention. In each embodiment, an exemplary cap member 30 have a cap 32 which may correspond to only a portion of a spherical ball, but may be shaped and sized to completely obstruct an opening 23 in its off-position. Other configurational and/or operational characteristics of such cap members 30 of FIGS. 4E and 4F are similar or identical to those of FIGS. 4C and 4D. It is appreciated that the caps 32 of these embodiments offer the benefit of using an inner space more efficiently, for the truncated caps 32 may require less space in their off- and on-states.

In another exemplary embodiment of such an aspect of this invention, a cap member may have multiple caps arranged to match each other to form a shape of a sphere and to move away from each other in their off- and on-states, respectively. FIG. 4G is a schematic top view of another exemplary cap member similar to those shown in FIGS. 4C and 4D but having two matching caps moving toward and away from each other between their off- and on-states according to the present invention. An exemplary cap member 30 is similar to that shown in FIGS. 4C and 4D, except that it includes a pair of caps 32 which are arranged to be assembled into a spherical ball and obstruct an opening 23 in their off-state, and then to be disassembled into two hemispherical caps 32 while moving toward their on-states. As described above, the cap member 30 of FIG. 4A may be provided by modifying the caps of some of the previous embodiments and/or may be applied to modify some of such embodiments, e.g., those of FIGS. 2E to 2J, 3A, 3C, and 3D.

In another exemplary embodiment of such an aspect of this invention, a cap member may have one or more caps defining one or more holes therethrough and varying its alignment during its off- and on-states. FIG. 4H shows a schematic top view of another exemplary cap member including a single spherical cap defining a hole and moving around an opening to align its hole with an opening between its off- and on-states according to the present invention. An exemplary cap member 30 has a single cap 32 generally having a spherical shape and defining a hole 37 along its long axis. Such a cap 32 is generally arranged to be disposed to align the hole 37 transverse to an opening 23 and to obstruct the opening 23 in its off-state. Thereafter, the cap 32 is arranged to rotate or pivot to align such a hole 37 with the opening 23 in its on-state such that a tip of a cartridge member may be exposed through such a hole 37 and opening 23. As described hereinabove, the cap member 30 of FIG. 4A may be provided by modifying the caps of some of the previous embodiments and/or may be applied to modify some of the previous embodiments, e.g., that of FIG. 2K.

In other exemplary embodiments of such an aspect of the present invention, various caps may be arranged to maintain shapes and/or sizes of their planar capping surfaces beyond and/or out of an area over, below, projected upward, and/or projected downward an opening or, in the alternative, to change or to reduce their shapes and/or sizes beyond and/or out of the area. Various caps provided by such embodiments may also have configurational and/or operational characteristics similar to those described in conjunction with FIGS. 2N and 2O.

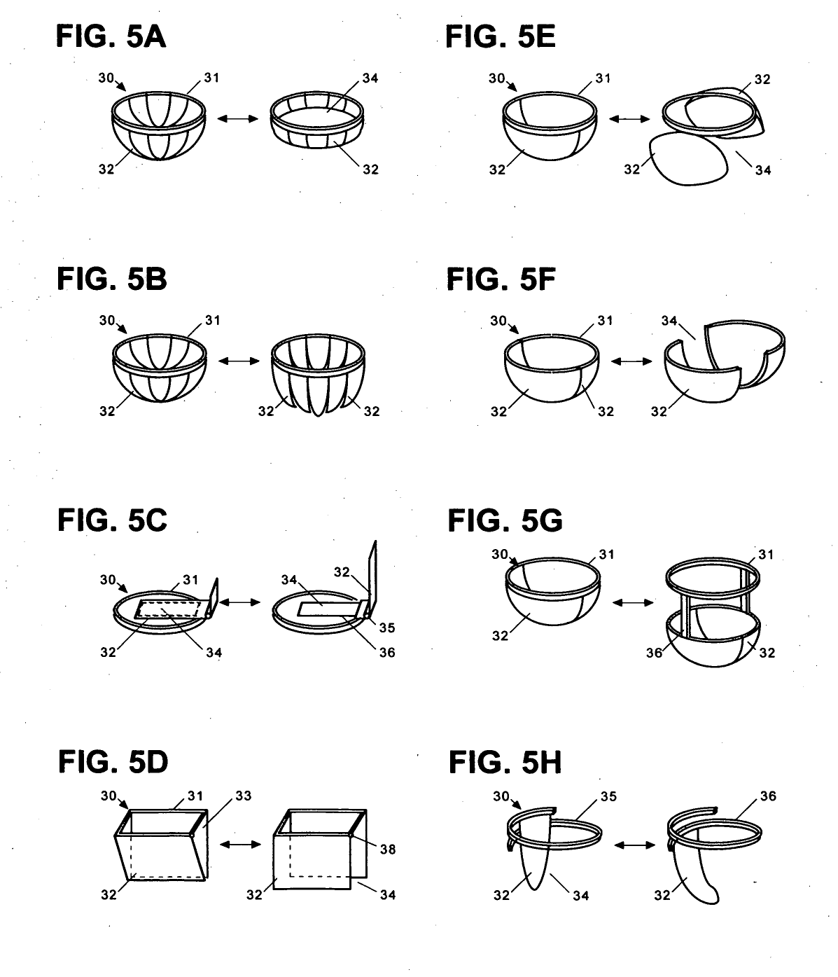

Configurational and/or operational variations and/or modifications of the above embodiments of the exemplary systems and various modules thereof described in FIGS. 5A through 5H also fall within the scope of this invention.

Because various caps of such an aspect of this invention are curved inward or outward, the caps may have to be disposed to avoid or at least minimize collision with an edge of an opening of the case member and/or with a frame of the cap member. Various arrangements may be provided to this end. For example, the caps are oriented in such a way that a concave upward into the case may be aligned in order to have their concave side to be inside the case and their convex sides to contact the edge of the opening, while those concave downward out of the case may be aligned in order to have their concave side to be outside the case and their convex side to contact the edge of the opening. In the alternative, such caps may be disposed away from the opening at a preset distance as far as the caps may be able to obstruct and to clear such an opening in their off- and on-states, respectively. In another alternative, the caps may be arranged to be made of and/or include elastic and/or deformable material such that they may deform and yield to the edge of the opening to some extend while moving between their off- and on-states. In another alternative, the entire cap member may also be arranged to swivel or otherwise vertically translate to some extent in order to avoid the caps from getting stuck during their movements by the edge of the opening.

Although the foregoing exemplary embodiments of FIGS. 4C through 4H only involve spherical or hemispherical caps, such caps may be arranged to have different curvatures. For example, such caps may be shaped along semi- and/or quasi-spherical curvatures, ellipsoidal curvatures, hyperbolic curvatures, and other three-dimensional curvilinear curvatures. As long as such caps may be able to obstruct and clear the opening in their off- and on-states, exact curvatures thereof are not material to the scope of the present invention. Similarly, the holes provided through or across the caps may also have various shapes and/or sizes, as long as they may allow the tips of the cartridge members to be exposed therethrough.

In another aspect of the present invention, various cap members may be arranged to include at least one cap which is arranged to define a planar or a non-planar capping surface and to operate or otherwise move between its on- and off-states along at least one curvilinear direction which may be transverse, normal or parallel with an opening of a case member or which may be parallel, transverse or normal to a longitudinal axis of the case member. It is to be understood, however, that various cap members of this aspect of the invention are preferably disposed at a preset distance from an opening. Accordingly, the caps of this aspect of the invention are generally not to be disposed adjacent to and do not generally contact the opening. Rather, such caps preferably form and destroy conduits in their on- and off-states, respectively, and tips of cartridge members are exposed through such conduits in the on-states. Any of the foregoing cap members exemplified in FIGS. 2A to 2O, 3A to 3H, and 4A to 4H may be varied or modified to provide cap members of this aspect of the present invention, e.g., by disposing their caps away from the opening and arranging the caps to respectively form and destroy the conduits in their on- and off-states. FIGS. 5A to 5O show schematic top views of exemplary cap members having a single or multiple caps each of which is disposed away from an opening and in an inner space of a case member and defines a planar or non-planar capping surface between its off- and on-states according to the present invention. It is appreciated that the exemplary cap members of the following figures may typically be classified into those of the second subclass of the first class as described hereinabove. It is further appreciated that exemplary embodiments of various cap members of FIGS. 5A to 5H are only intended to illustrate various examples of such an aspect of this invention, but not to limit the scope thereof. It is to be understood that only portions of the caps in the following figures may be identified when disposed in an area above or below the opening, while other portions of the caps disposed outside of such an area may be ignored for simplicity of illustration.

In one exemplary embodiment of such an aspect of this invention, a cap member may include multiple caps arranged to translate centrifugally and centripetally between their off- and on-states so as to respectively form and destroy a conduit therebetween. FIG. 5A is a schematic top view of an exemplary cap member including multiple caps having non-planar capping surfaces and respectively translating or sliding centrifugally and centripetally in order to form and destroy a conduit in its off- and on-states according to the present invention. An exemplary cap member 30 includes a frame 31 with a shape of an annular ring and multiple caps 32 arranged radially along a circumference of the frame 31. Such caps 32 may abut or overlap each other in order to enclose an entire area inside the frame 31 in their off-states, and translate apart from each other and over or across the frame 31 in order to form a conduit 34 therebetween and in a center part of the frame 31 in their on-states. As described hereinabove, the cap member 30 shown in FIG. 5A may be provided by modifying some of the above embodiments and/or may also be applied to modify some of the previous embodiments, e.g., those of FIGS. 2A to 2C and 2M.

In another exemplary embodiment of such an aspect of this invention, a cap member may have multiple caps which are arranged to expand and then retract or, in the alternative, to contract and then expand between their off- and on-states so as to form and destroy a conduit therebetween. FIG. 5B shows a schematic top view of another exemplary cap member having multiple caps with non-planar capping surfaces and respectively expanding and retracting in order to form and destroy a conduit in its off- and on-states according to the present invention. An exemplary cap member 30 has a frame 31 similar to that of FIG. 5A and multiple caps 32 arranged along a circumference of the frame 31. In one example, the caps 32 may be arranged to have elastic property and to be in an unstressed state so that the caps 32 abut or overlap each other and enclose an entire area inside the frame 31 in their off-states. By applying input force thereto, such caps 32 are arranged to expand into their stressed state and to form a conduit 34 therebetween (not shown in the figure) in their on-state. Upon removal of such input force, the caps 32 are arranged to retract to their unstressed state and to destroy such a conduit 34 by abutting or overlapping each other in their off-state. In another example, the caps 32 may instead be arranged to have elastic property and to be compressed to a stressed state such that the caps 32 abut or overlap each other so as to enclose an entire area inside the frame 31 in their off-states. By removing the compression input force therefrom, such caps 32 are arranged to expand to their unstressed state while forming a conduit 34 therebetween into their on-state. By applying such compression input force thereafter, such caps 32 are arranged to contract to their stressed state and to destroy the conduit 34 by abutting or overlapping each other in their off-state. As described above, the cap member 30 of FIG. 5B may be provided by modifying some previous embodiments and/or may be applied to modify some of the previous embodiments, e.g., those of FIGS. 2A to 2C and 2M.

In another exemplary embodiment of such an aspect of this invention, a cap member may have one or more caps arranged to translate along a preset track to form and destroy a conduit therealong. FIG. 5C is a schematic top view of another exemplary cap member including a single cap with a planar capping surface and reciprocating to form and destroy a conduit respectively in its off- and on-states according to the present invention. An exemplary cap member 30 has a frame 31 and a single cap 32, where the frame 31 is arranged to have an enclosed interior, to define an aperture in a center portion thereof, and to form a track 36 along edges of such an aperture, and where the cap 32 is arranged to reciprocate along such a track 36. Accordingly, the cap 32 may form a conduit 34 within the frame 31 by translating away from the aperture toward its on-position along the track 36, and may then destroy the conduit 34 in its off-state by translating back into its original position and block the aperture. It is to be understood that the track 36 may be arranged to movably couple with the cap 32, to movably retain the cap 32 therein, and so on, in order to ensure airtight sealing between the cap 32 and aperture. As described hereinabove, the cap member 30 of FIG. 5C may also be provided by modifying some of the previous embodiments and/or may also be applied to modify some of such embodiments, e.g., those of FIGS. 2D, 2I, 2J, 3A, 3C, 4C to 4F, and 5A.

In another exemplary embodiment of such an aspect of this invention, a cap member may have one or multiple caps translating and/or rotating between their on- and off-states and arranged to form and destroy a conduit, respectively. FIG. 5D shows a schematic top view of another exemplary cap member having a single cap defining a planar capping surface and pivoting toward and away from a frame so as to form and destroy a conduit in its off- and on-states according to the present invention. An exemplary cap member 30 includes an annular rectangular frame 31, a cap, 32, and a support 33, where the cap 32 may be arranged to rotate or pivot about a rotation axis 38 between its on- and off-states. In particular, a lower end of the cap 32 is arranged to pivot away from the support 33 and to create a conduit 34 in its on-state and, thereafter, such an end of the cap 32 is arranged to pivot back toward the support 33 and to destroy the conduit 34 in its off-state. Accordingly, a tip of the cartridge member may be exposed through the conduit 34 in the on-state, and enclosed between such a cap 32 and support 33 in the off-state. It is to be understood that an inner wall of a case of a case member may be arranged to serve as the support 33. As described above, the cap member 30 of FIG. 5D may also be provided by modifying some of the above embodiments, and/or may further be used to modify some of such embodiments, e.g., those of FIGS. 2D, 2I, 2J, 3A, 3C, and 4C to 4F.

In another exemplary embodiment of such an aspect of this invention, a cap member may have multiple caps which define non-planar capping surfaces and translate and/or pivot toward and away from each other between their off- and on-states. In one example, FIG. 5E is a schematic top view of another exemplary cap member with a pair of quarter-spherical caps pivoting toward and away from each other respectively to form and close a conduit in its off- and on-states according to the present invention. An exemplary cap member 30 includes an annular circular frame 31 and a pair of caps 32 defining non-planar or spherical capping surfaces. The caps 32 movably couple with opposing ends of the frame 31, and are arranged to rotate or pivot toward and away from each other about axes of rotation (not shown in the figure) so as to respectively destroy and form a conduit 34 therebetween. In another example, FIG. 5F shows a schematic top view of another exemplary cap member similar to that of FIG. 5E with its quarter-spherical caps translating toward and away from each other in order to respectively form and close a conduit in its off- and on-states according to the present invention. An exemplary cap member 30 may not include a frame but may include a pair of caps 32 arranged to translate toward and away from each other in their off- and on-states so as to respectively form and destroy a conduit 34 therebetween. When desirable, such a cap member 30 may also include a frame so that such caps 32 may be arranged to translate along a track provided on such a frame. In another example, FIG. 5G is a schematic top view of another exemplary cap member similar to that of FIG. 5E but having a pair of caps translating along a track and pivoting toward and away from each other to respectively form and destroy a conduit in their off- and on-states according to the present invention. An exemplary cap member 30 includes a frame 31 and a pair of non-planar caps 32 similar to those of FIG. 5E. The cap member 30 also defines a pair of tracks 36 disposed on opposing ends of the frame 31 and extending vertically and downwardly away from a case member and toward an exterior of the writing tool. The caps 32 are then arranged to vertically translate along the tracks 36 and to translate toward and away from each other respectively between their off- and on-states in order to form and destroy a conduit therebetween. It is to be understood that the caps 32 of this example may translate not only laterally but also vertically and, therefore, may offer the benefit of minimizing space required for disposing the cap members and/or their caps, for movements thereof, and the like. As described above, the cap member 30 of FIGS. 5E to 5G may also be provided by modifying some of the previous embodiments and/or may also be applied to modify some of the previous embodiments, e.g., those of FIGS. 2E, 2F, 2G, 2H, 2L, 3B, 3D to 3F, 3H, 4A, and 4G.

In another exemplary embodiment of such an aspect of this invention, a cap member may have one or multiple caps arranged to rotate or pivot while translating vertically upwardly and downwardly to form and destroy a conduit in their off- and on-states. FIG. 5H is a schematic top view of another exemplary cap member having a single cap circling along a curvilinear track so as to form and destroy a conduit in its off- and on-states according to the present invention. An exemplary cap member 30 includes a single cap 32 and a curvilinear guide 35 having a spiral arrangement of multiple loops. The cap 32 is movably coupled to or supported by the track 36 and arranged to move along the track 36 in order to form a conduit 34 when the cap 32 is pulled upward and to destroy such a conduit 34 when such a cap 32 is pulled downward. As described hereinabove, the cap member 30 of FIG. 5H may be provided by modifying some of the above embodiments and/or may be applied to modify some of such embodiments, e.g., those of FIGS. 2D, 2I, 2K, 3A, 3G, and 4C.

In other exemplary embodiments of such an aspect of the present invention, various caps may be arranged to maintain shapes and/or sizes of their planar capping surfaces beyond and/or out of an area over, below, projected upward, and/or projected downward the frame and/or opening or, in the alternative, to change or to reduce their shapes and/or sizes beyond and/or out of the aforementioned area. Various caps provided by these embodiments may also have configurational and/or operational characteristics similar to those described in conjunction with FIGS. 2N and 2O.

Configurational and/or operational variations and/or modifications of the above embodiments of the exemplary systems and various modules thereof described in FIGS. 5A through 5H also fall within the scope of this invention.

First of all, any exemplary cap members discussed in conjunction with FIGS. 2A to 4H may be disposed away from the opening of the case member by a preset distance and arranged to form and destroy the conduit similar to those of FIGS. 5A to 5H. The only difference between the cap members of FIGS. 2A through 4H from those exemplified in FIGS. 5A to 5H lies in whether the caps of such cap members may directly obstruct and clear such an opening by covering and uncovering such (those of FIGS. 2A to 4H) or may indirectly open and close the opening by creating and destroying the conduit at a distance from such an opening. Accordingly, the above cap members may be interchangeably used to manipulate the opening depending upon detailed configurations of the writing tools.

The frames of the cap members may be incorporated into various locations with respect to the opening and/or case member. For example, such frames may be disposed adjacent to the opening or at a preset distance from the opening but inside the case of the case member. When desirable, such frames may also be disposed outside the case, where the caps of the cap member may be arranged to move between their off- and on-states while acting as parts of the case member. It is appreciated that exact shapes and/or sizes of the frames may at least partly determine shapes and/or sizes of the conduits formed by the caps. In order to optimize and/or use a space of the case member, the frames may be arranged to have the shapes and/or sizes which conform to those of the opening. Therefore, such frames may be arranged to allow the caps to form the conduit which may be greater than, equal to or less than such an opening. For example, for the tip having an upper portion thicker than a lower portion, the conduit may have to be greater than the opening. However, when the writing tool needs the opening which is desirably to be at least somewhat greater than the tip for preventing contact of the tip with edges of the opening, the conduit may be arranged to be smaller than the opening.

It is to be understood that such cap members described in conjunction with FIGS. 5A to 5H may generally offer the benefit of providing better mechanical protection of the cap members, for at least a significant portion of such a cap member and caps thereof are to be disposed inside the case and to be less prone to suffer from mechanical damages and to malfunction therefrom. In addition, such cap members may also be arranged to serve as parts of the case member, for some caps thereof may be exposed to the exterior of the writing tool in their off-states anyway. However, a downside of such embodiments may be that such cap members may require a greater space inside the case of the case member for installation and/or operation thereof.

Configurational and/or operational variations and/or modifications of the above embodiments of the exemplary systems and various modules thereof described in FIGS. 2A through 5H also fall within the scope of this invention.

First of all, the frames of the foregoing cap members may be arranged to have various shapes and/or sizes which may be fixed or may vary according to the operational states of the caps thereof. Such shapes and/or sizes of the frames may determine at least in part the shapes and/or sizes of the caps and/or other parts of the cap members as well. Such a frame may be arranged to be comprised of multiple parts or may consist of a single article. The frames may also be fixedly or movably coupled to various members and/or parts of the writing tools, as far as such coupling allows proper operation of the caps of the cap members and/or proper movements of the bodies of the cartridge members. In addition, the frames may be disposed in almost any arbitrary location in and/or around the writing tools such as, e.g., inside or outside the case member, over or below the openings, and the like, as long as such disposition does not obstruct proper operations of the cap and/or cartridge members.

Secondly, various supports of the above cap members may also be arranged to have various shapes and/or sizes as far as such supports allow proper operation of the caps. The supports may be arranged to fixedly and/or movably couple with the caps in order to respectively allow movements of the caps therewith and movements of the caps with respect thereto. Such supports may also be coupled to and/or may be supported by various members and/or parts of the writing tools, as long as such coupling may allow proper operation of the caps and/or proper movements of the bodies of the cartridge members. Disposition of such supports and/or a number thereof incorporated into the cap members may not be material to the scope of this invention, as far as such supports may allow proper operation of the caps and/or proper movements of the bodies of the cartridge members.

Thirdly, various foregoing cap members and there caps exemplified hereinabove are classified primarily based upon configurational characteristics of their capping surfaces. For example, those of FIGS. 2A through 3H exemplify the caps defining planar capping surfaces, whereas those of FIGS. 4A through 5H exemplify the caps defining non-planar capping surfaces. Accordingly, remaining portions of the cap members of either classification may be arranged to define either planar or non-planar non-capping surfaces.

The above cap members may include a single or multiple caps which may define planar and/or non-planar capping surfaces may be arranged to be made of and/or include at least one rigid, elastic, and/or deformable material. As described above, an exact number of caps per each cap member may not be material to the scope of the present invention, for any of the foregoing caps may be divided into multiple caps and, conversely, for any two or more caps described herein may be integrated to form a single cap. When the cap member includes multiple caps, the caps may be arranged to be identical or similar to each other, to be symmetric or asymmetric with each other, and so on. As described above, multiple caps may be arranged to match or overlap each other in their off-states so as to obstruct the opening and/or to destroy the conduit therebetween. For either embodiment, edges of such caps may also be arranged to have various curvilinear shapes in order to ensure proper sealing therebetween. When the cap member includes multiple caps, at least one of such caps may further be arranged to be stationary and/or fixedly coupled to various members of the writing tools, while at least one of the rest of the caps may be arranged to move between its off- and on-states. It is to be understood that some parts of other members such as, e.g., the case, cartridge, and actuator members, may serve as such a stationary cap as well. Conversely, at least one part of the cap member may be arranged to serve as a part of other members as well.

Various provisions may be made to ensure appropriate sealing between the caps in their off-states. In one example, edges of such caps participating in obstructing the opening and/or closing the conduit may be arranged to match each other in their off-states. In another example, such edges may be arranged to overlap at least a portion of each other in the off-states. When desirable, conventional sealing articles, elastic materials, and/or deformable materials may be incorporated into and/or around such edges to prevent formation of leak therebetween.

The above caps may be arranged to move according to various patterns along various paths. For example, the caps may be arranged to move above, over, across, between, beneath or below the frame and/or opening, when their capping surfaces are arranged to move in parallel with the opening and/or in a direction transverse to the longitudinal axis of the case. In another example, the caps may be arranged to move into or out of the case, when their capping surfaces are arranged to move along a direction transverse to the opening and/or in parallel with the longitudinal axis of the case. The caps may be arranged to translate, reciprocate, rotate, pivot, and/or otherwise move between their off- and on-states along the paths which may be linear or curved, two- or three-dimensional, and so on. Such caps may also be arranged to move along the tracks, optionally being guided by the guides.

As described above, various caps may be arranged to move from their off-states to their on-states by clearing the opening and/or creating the conduit from a center portion of the opening and/or conduit or from an edge portion thereof. The first embodiment may generally be suitable for the tips of the cartridge member which have pointed ends in their center and/or for the symmetric tips, whereas the second embodiment may be suitable for the asymmetric tips having the pointed ends in their left or right sides. It is appreciated, however, that either embodiment may be employed for any of the above caps as long as movements of such caps between their off- and on-states do not require such tips to move in a specific temporal sequence according thereto.

As exemplified in FIGS. 2N and 2O, any caps of this invention may be arranged to maintain their shapes and/or sizes in their on-states or to change their shapes and/or sizes in their on-states in the areas beyond the opening. In particular, various caps according to the latter embodiment may change their shapes and/or sizes by various modes. For example, such caps may be bent or realigned within the inner space while moving from their off- to on-states in order to clear the opening and/or to create the conduit. In another example, such caps may be folded, stacked, and/or rolled in a preset pattern in order to clear the opening and/or to form the conduit while moving toward their on-states. In another example, the caps may instead be deformed to some extent so as to clear the opening and/or create the conduit while moving toward their on-states. It is appreciated, however, that the above caps may be arranged to change their shapes and/or sizes beyond the area of opening according to any of the above examples, as long as such caps do not interfere movements and/or exposure of the tips out of the opening of the case member and/or out of the conduit formed by such caps.

It is to be understood that two-dimensional views of various cap members of FIGS. 2A through 2O and schematic views of various cap members of FIGS. 3A through 3H may also be interpreted as projected views of three-dimensional cap members as exemplified in FIGS. 5A through 5H. Therefore, those cap members shown in FIGS. 2A to 3H exemplify various cap members which may define three-dimensional capping surfaces, which may move along two- or three-dimensional paths, and so on.

Although most of the above figures exemplify the caps made of and/or including rigid, elastic, and/or non-deformable materials, such caps may also be made of and/or include deformable materials. Therefore, all cap members and/or caps thereof exemplified in the above figures may be arranged to be deform in response to the input force and/or movements of the cartridge members in order to clear and obstruct the opening and/or in order to form and destroy the conduit.

The writing tool with any of the above exemplary cap members may be arranged to include at least one recoil unit which may be arranged to store at least a portion of mechanical energy which is associated with the input force supplied by the user and to release the stored portion of the energy. In one example, the recoil unit may be used to store the portion of the energy for moving at least one cap from one to the other of its off- and on-states, and to release the stored portion for moving such a cap from the other to the one of such states. In this embodiment, the user has to apply the input force only once in order to either clear (or obstruct) the opening (or alternatively, in order to form or destroy the conduit), while the recoil unit utilizes the stored energy in order to obstruct (or clear) the opening (alternatively, in order to destroy or form the conduit). It is to be understood, in this embodiment, that the user may apply such input force to the cap directly or indirectly through the case, cartridge, and/or actuator members, and that the recoil unit may be arranged to release the stored energy onto the cap directly or indirectly through the case, cartridge, and/or actuator members. In another example, such a recoil unit may instead be employed to store the portion of the energy for moving at least one of the case, cap, cartridge, and actuator members, and then to release the stored energy to ensure sealing between the caps and/or between the cap and opening, e.g., by applying force to manipulate the cap to contact and seal the edges between the caps and/or the edges between the cap and opening. In another example, the recoil unit may be employed to be moved to its stressed state when the cap is in its off-state so that the recoil unit may apply its recoil force onto the cap and may ensure such sealing as described above. When desirable, the writing tool may include multiple recoil units to perform more than one of the above functions.

It is appreciated that the writing tool of the present invention may include various cap members having various configurational and/or operational characteristics as described hereinabove. It is also appreciated that such a writing tool may be constructed by interchangeably employing different caps and their configurational and/or operational features, regardless of their classes, subclasses, types, and so on. Accordingly, the writing tool of this invention may include one or more caps which may be arranged to have different capping surfaces, to move along different paths, and the like.

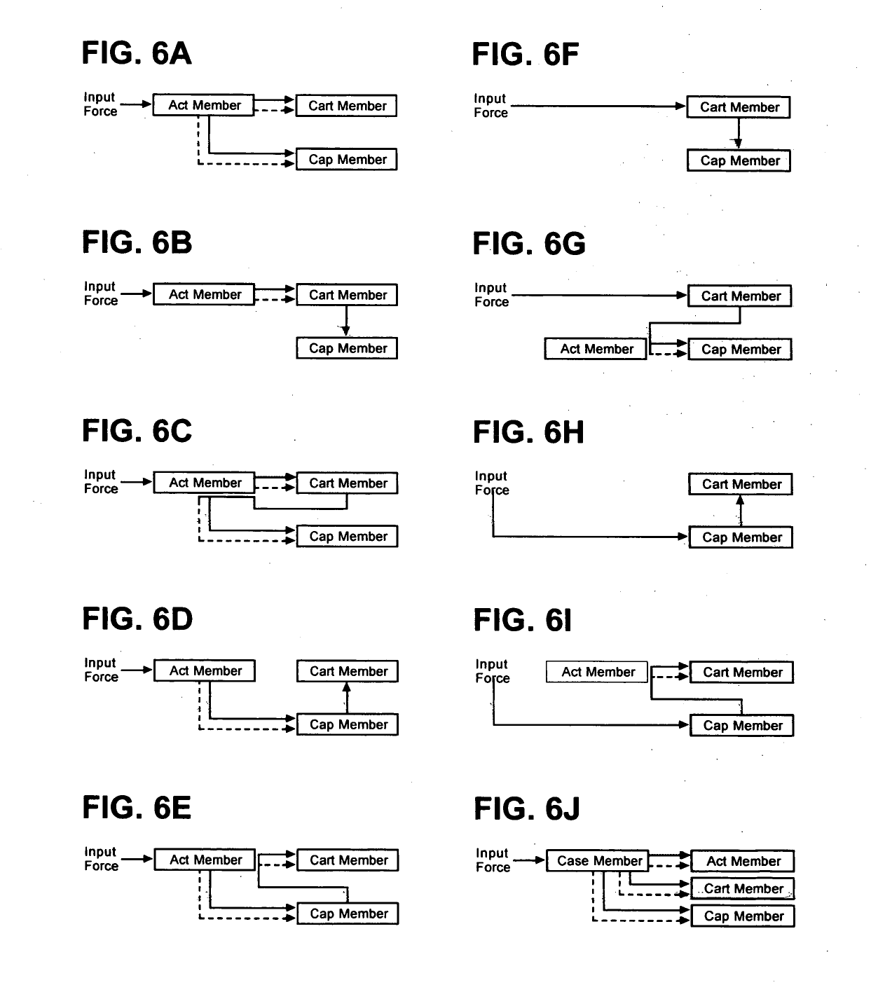

In another aspect of the present invention, a writing tool may also be arranged to receive input force by one or more of its various members and/or to transmit such input force from one to the other members in one of various sequences. FIGS. 6A to 6J are schematic diagrams of exemplary writing tools for receiving input force and transmitting such force through various members thereof according to the present invention, where solid lines represent paths for direct transmission of such input force (i.e., transmission of such force without altering an amplitude and a direction of such force), whereas dotted lines rather represent paths for indirect transmission of such input force (i.e., transmission of such force while and/or after altering at least one of its amplitude and direction). It is appreciated that, in both of the direct and indirect transmissions of such input force, lengths and paths of movements of a first member of the writing tool which receives the input force from the user and those of a second member thereof which receives such force from the first member may or may not be identical to each other. It is also appreciated that the following exemplary embodiments about various force receiving and/or transmitting mechanisms are only intended to illustrate various examples of this aspect of the present invention and not to limit the scope of this invention.

In one exemplary embodiment of such an aspect of the present invention, a writing tool may be arranged to receive the input force by its actuator member which may then transmit such input force to two or more members. FIG. 6A represents a schematic block diagram of an exemplary writing tool receiving user input force by an actuator member and manipulating both of a cartridge member and a cap member by the actuator member according to the present invention. An actuator member may be arranged to directly transmit the input force to both cartridge and cap members or, in the alternative, to indirectly transmit such force to at least one of the cartridge and cap members while or after altering the amplitude and/or direction of the input force. It is appreciated that this embodiment also includes a case in which the actuator member transmits such force to only one of the cartridge member and the cap member.

In another exemplary embodiment of this aspect of the present invention, a writing tool may be arranged to receive the input force by its actuator member which may then transmit such input force to a cartridge member. In one example, FIG. 6B is a schematic block diagram of an exemplary writing tool arranged to receive user input force by an actuator member, to manipulate a cartridge member by the actuator member, and to manipulate a cap member through the cartridge member according to the present invention. Upon receiving the input force therethrough, an actuator member may be arranged to either directly or indirectly transmit the input force to the cartridge member which may then directly transmit such force to the cap member. In another example, FIG. 6C is a schematic block diagram of an exemplary writing tool receiving user input force by an actuator member, manipulating a cartridge member by the actuator member, and manipulating a cap member by the cartridge member through the actuator member according to the present invention. An exemplary force receiving and/or transmitting mechanism of FIG. 6C is similar to that of FIG. 6B, except that a cartridge member may either directly or indirectly transmit such force to a cap member through an actuator member.

In another exemplary embodiment of this aspect of the present invention, a writing tool may be arranged to receive the input force by its actuator member which may then transmit such input force to a cap member. In one example, FIG. 6D shows a schematic block diagram of an exemplary writing tool receiving input force by an actuator member, manipulating a cap member by the actuator member, and manipulating a cartridge member directly by the cap member according to the present invention. Upon receiving the input force therethrough, an actuator member may be arranged to either directly or indirectly transmit the input force to the cap member which may then directly transmit the input force to the cartridge member. In another example, FIG. 6E shows a schematic block diagram of an exemplary writing tool which receives user input force by an actuator member, manipulates a cap member by the actuator member, and manipulates a cartridge member indirectly by the cap member according to the present invention. An exemplary force receiving and/or transmitting mechanism of FIG. 6E is similar to that of FIG. 6D, except that a cap member may either directly or indirectly transmit such input force to a cartridge member through an actuator member.

In another exemplary embodiment of this aspect of the present invention, a writing tool may be arranged to receive the input force by its cartridge member which may then transmit such input force to a cap member. In one example, FIG. 6F shows a schematic block diagram of an exemplary writing tool receiving user input force by a cartridge member and directly manipulating a cap member by such a cartridge member according to the present invention. Upon receiving the input force therethrough, a cartridge member may be arranged to directly transmit such force to the cap member. Therefore, this embodiment may not require any separate actuator member. In another example, FIG. 6G represents a schematic block diagram of an exemplary writing tool receiving user input force by a cartridge member and indirectly manipulating a cap member by the cartridge member according to the present invention. An exemplary force receiving and/or transmitting mechanism of FIG. 6G is similar to that shown in FIG. 6F, except that a cartridge member may either directly or indirectly transmit such input force to a cap member through an actuator member. It is appreciated that such an embodiment also includes a case in which the input force is applied to the cartridge member but neither directly nor indirectly to the cap member.

In another exemplary embodiment of this aspect of the present invention, a writing tool may be arranged to receive the input force by its cap member which may then transmit such input force to a cartridge member. In one example, FIG. 6H is a schematic block diagram of an exemplary writing tool receiving user input force by a cap member and then manipulating a cartridge member directly by the cap member according to the present invention. Upon receiving such input force therethrough, a cap member may be arranged to directly transmit the input force to the cartridge member. Therefore, this embodiment may not require any separate actuator member. In another example, FIG. 6I represents a schematic block diagram of an exemplary writing tool receiving user input force by a cap member and then manipulating a cartridge member indirectly by the cap member according to the present invention. An exemplary force receiving and/or transmitting mechanism of FIG. 6I is similar to that shown in FIG. 6H, except that a cap member may either directly or indirectly transmit such input force to a cartridge member through an actuator member. It is appreciated that such an embodiment also includes a case in which the input force is applied to the cap member but neither directly nor indirectly to the cartridge member.

It is to be understood that the foregoing embodiments of the previous aspect of this invention in FIGS. 6A through 6I typically apply to a writing tool with a case member an entire portion of which may be stationary and/or at least a portion of which may be mobile. When such a writing tool may include a case member with at least one mobile part, however, it may be arranged that the mobile part may be arranged to translate, rotate, pivot or otherwise move in response to the input force. Accordingly, in another exemplary embodiment of this aspect of the present invention, a writing tool may be arranged to receive the input force through at least one mobile part of its case member which then transmits the input force to other members. FIG. 6J shows a schematic block diagram of an exemplary writing tool receiving user input force by a case member and manipulating other members directly or indirectly by the case member according to the present invention. An exemplary case member may be arranged to receive input force and then to transmit such input force directly and/or indirectly to one or more of the case, cap, cartridge, and/or actuator members. In this context, such an embodiment may correspond to FIGS. 6A to 6I which are modified by incorporating a box of “case member” immediately on the right side of “input force” and/or which are modified by replacing the actuator member by the case member.

Various parts of the writing tool of the present invention may be arranged to move in response to the input force which is supplied by the user. As described in detail below, one, two, three or more members of the writing tool may be arranged to be involved in force transmitting mechanisms, while a single member is arranged to receive the input force from the user. When desirable, however, one or more members may also be arranged to receive the input force independently (or redundantly) and/or in corporation therebetween.

In one exemplary embodiment, a single member of the writing tool may be arranged to receive the input force and to move in response thereto. For example, a cartridge member may be arranged to receive the input force and to translate or rotate downward so as to expose its tip out of an opening of a case member, and to translate or rotate upward so as to enclose the tip inside a case of the case member. Such a cartridge member may generally be arranged to apply force to caps of a cap member to move such caps to their on-states, and then to apply another force or resort to a recoil unit in order to position the caps back to their off-states. In another example, the case member may be arranged to receive such input force and to move at least a portion thereof to its use position to define an opening therebetween and to expose the tip therethrough, and then to position such a portion back to its rest position so as to destroy the opening and to enclose the tip by such a portion. In another example, the cap member may be arranged to receive the input force and to move at least one of its caps to its on-state so as to expose the tip therethrough and/or through the opening, and then to position the cap to its off-state to enclose the tip therein.

In another exemplary embodiment, one member of the writing tool may be arranged to receive the input force and then to move another member in response thereto, as exemplified in FIGS. 6F, 6H, and 6J. Regarding the embodiment of FIG. 6J, the case member may be arranged to receive the input force and to move at least one cap of the cap member to its on-state and expose the tip therethrough, and then to position such a cap back to its off-state in order to destroy the opening and to enclose the tip by the cap member. In another example, the case member may be arranged to receive such input force and to move the cartridge member to its use position to expose the tip through the opening, and then to move the cartridge member back to its rest position to dispose the tip inside the case member.

In another exemplary embodiment, a first member of the writing tool may be arrange to receive the input force from the user, a second member of such a tool may be arranged to directly or indirectly transmits such force to a third member of the tool, and such a third member may be arranged to move between its off- and on-states and/or to move between its rest and use positions so as to expose the tip to the exterior of the tool. FIGS. 6A to 6E, 6G, 6I, and 6J exemplify such embodiments.

It is appreciated that such members of the writing tool may be arranged to move in proportion with the input force which may be applied to the same and/or different member of such a tool. In such an embodiment, the moving member may move between its off- and on-states or between its rest and use positions as much as or in proportion with an amount and/or duration of the input force applied to the force receiving member. Accordingly, when the amount and/or duration of the input force may not amount to those required to complete movements of such a moving from one to the other states and/or positions, the moving member may be positions inbetween such states and/or positions. Similar cases may happen when the input force ceases to apply before a sufficient amount and/or duration of such input force may be applied to the force receiving member. In another embodiment, the moving member may be arranged to move from one to the other of the off- and on-states and/or rest and use positions when an amount and/or duration of the input force may exceed a threshold amount and/or duration. In such an embodiment, the moving member may typically be arranged to not move at all, until the amount and/or duration of the input force may reach their threshold values. Thus, such a moving member may move or may not move at all depending upon the amount and/or duration of such input force. It is to be understood that the force receiving member and the moving member may be the same member when only one member is arranged to receive the force and to move in response thereto.

The writing tool according to the latter embodiment of the previous paragraph may be arranged to include at least one recoil unit arranged to store at least a portion of mechanical energy such as the input force supplied by the user. The writing tool may also include at least one release unit which may be operatively coupled to the recoil unit and to manipulate the recoil unit to release the stored energy in a preset temporal pattern, e.g., releasing the stored energy instantaneously with or without any limit in its peak force, releasing the stored energy at a preset rate with or without such a limit, and the like. In this embodiment, the user may supply a command signal to the release unit which may then manipulate the recoil unit to release the stored energy, which may cause a movement of the case, cap, cartridge, and/or actuator members from one to the other of their off- and on-states and/or from one to the other of their rest and use positions.

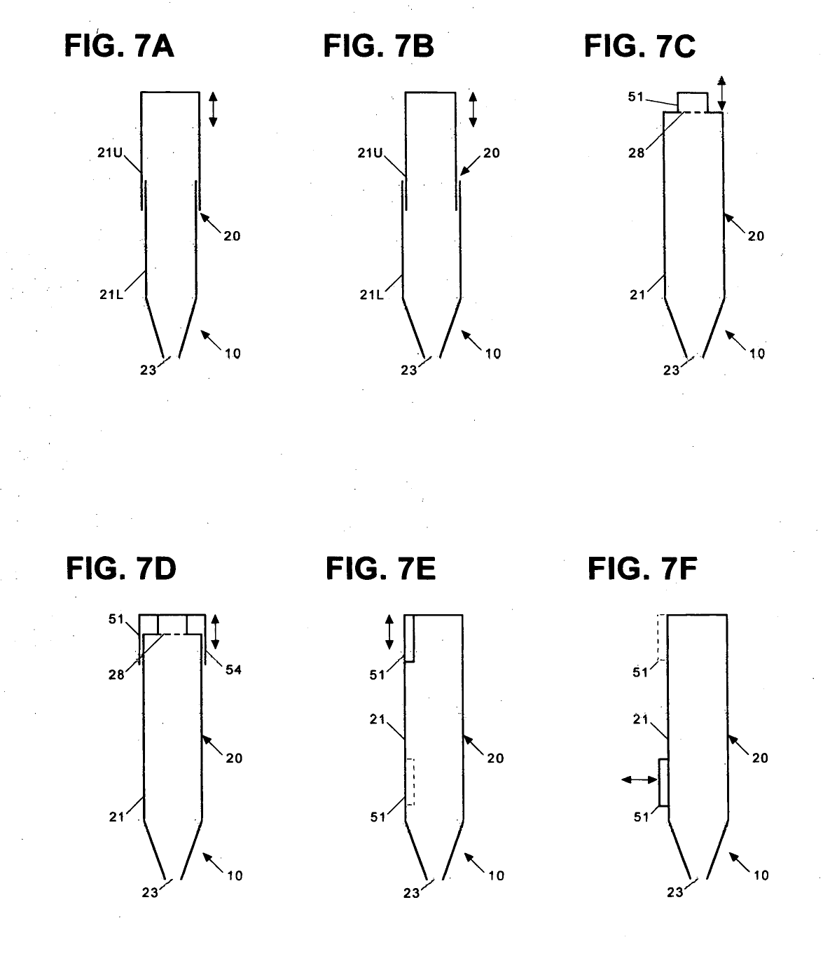

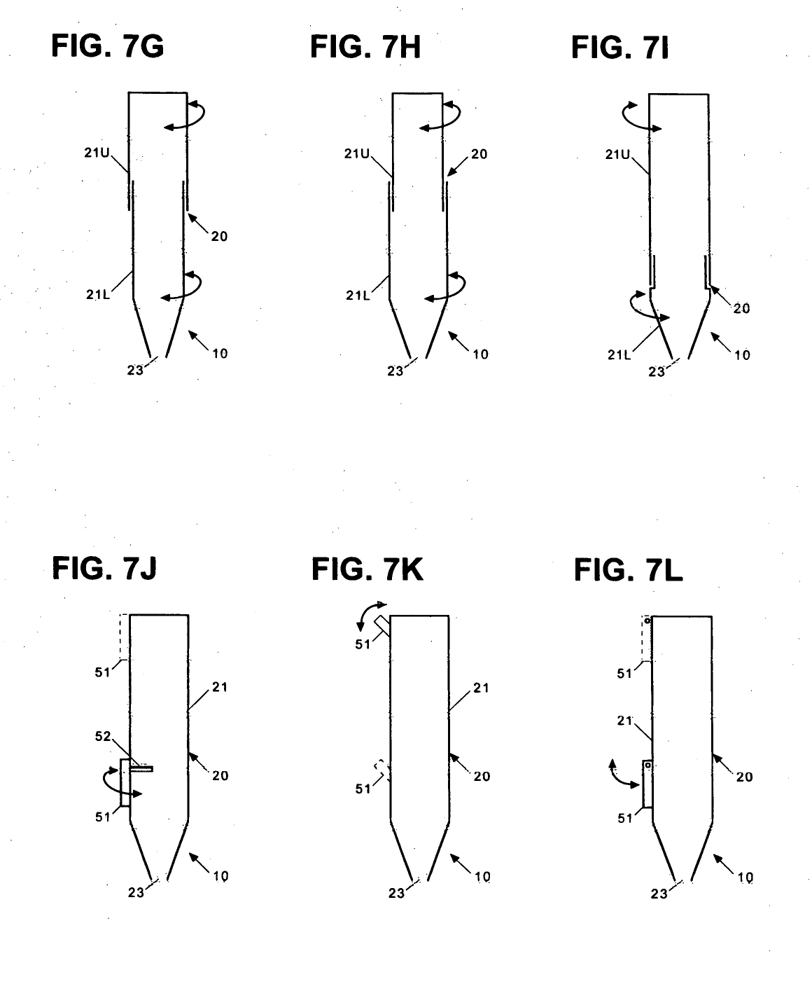

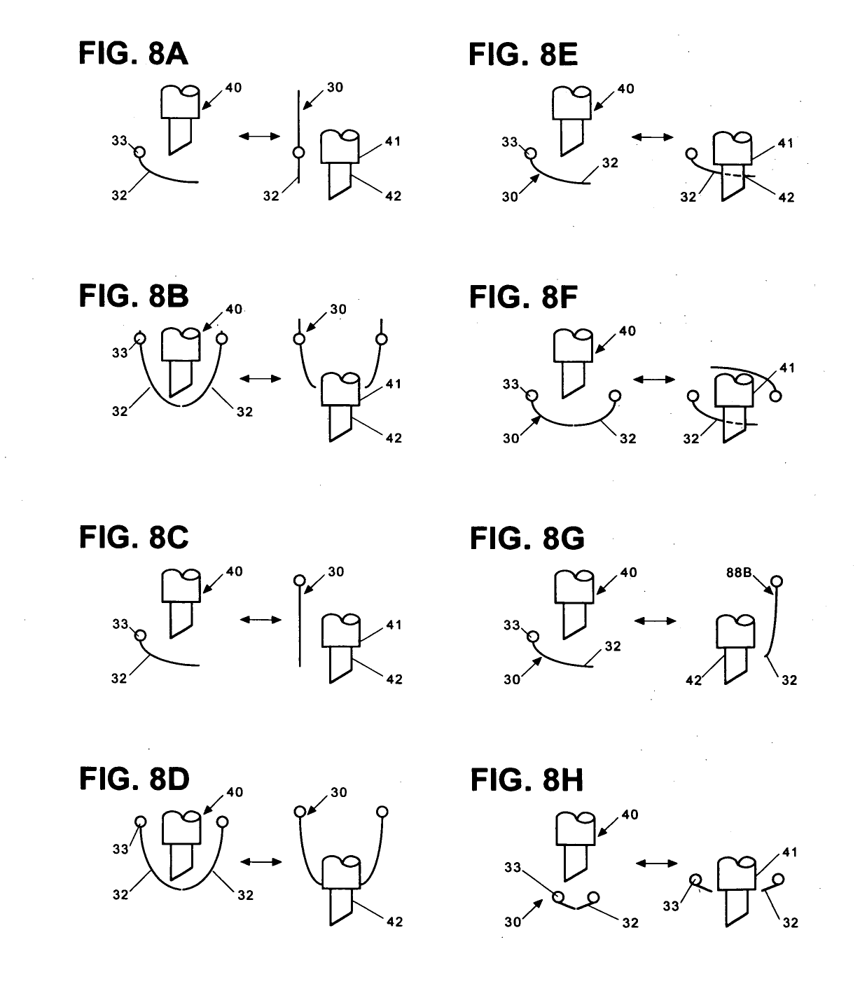

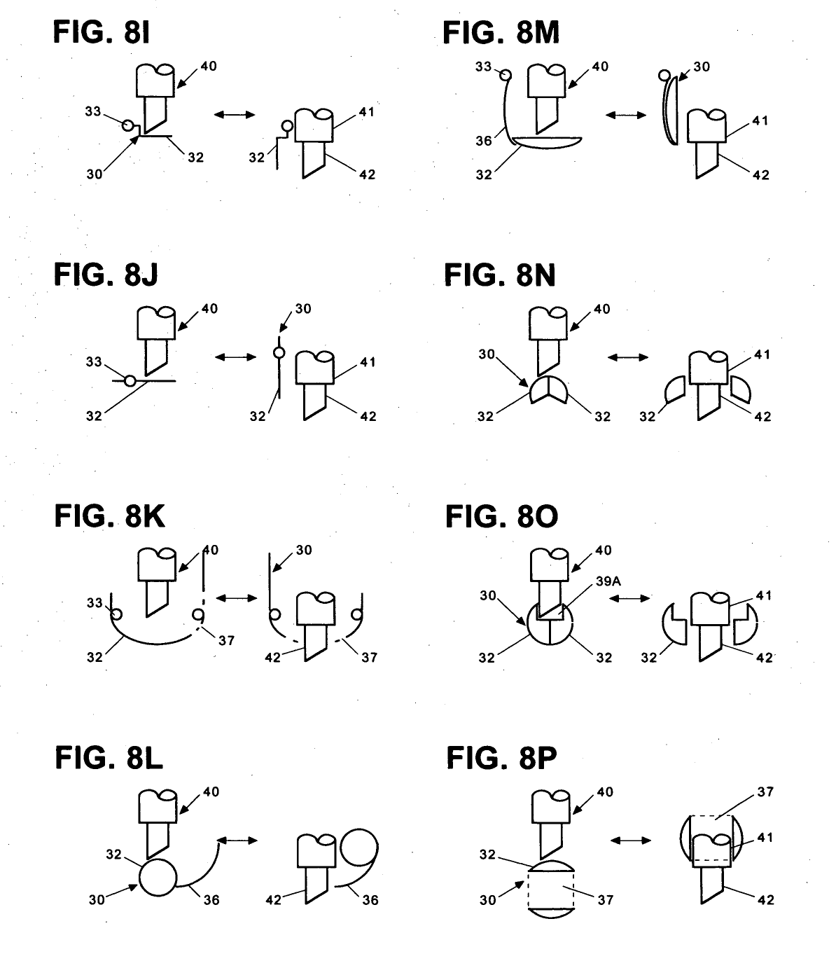

It is appreciated that such writing tools of this invention may also be incorporated with various coupling mechanisms to transmit the input force from one to another member of such tools. Thus, the case members, cap members, cartridge members, and actuator members of such tools and their parts may be arranged to have various shapes and/or sizes, to be fixedly or movably disposed according to various arrangements, to make various movements, to undergo various deformations, and so on. It is to be understood throughout this description that the term “input force” may generally refer to a force supplied by an user to a specific member and/or its part of a writing tool, at least a portion of the “input force” which is transmitted from one to another member of the tool, and/or any derivative force which may be derived from such “input force” supplied by the user by altering its amplitude and/or direction. Following FIGS. 7A to 7L exemplify various modes of receiving the input force from the user, FIGS. 8A to 8P, FIGS. 9A to 9H, and FIGS. 10A to 10H exemplify detailed mechanisms of force transmission from one to other members of such writing tools.

In another aspect of the present invention, various writing tools of the present invention may be arranged to receive input force supplied by an user by various members thereof in various modes. FIGS. 7A through 7L are schematic cross-sectional views of exemplary case members and actuator members for receiving input forces through different arrangements according to the present invention. It is appreciated that following exemplary embodiments of various force receiving and/or transmitting mechanisms are only intended to illustrate various examples of such an aspect of this invention and not to limit the scope of this invention.

In one exemplary embodiment of this aspect of the present invention, a writing tool may include multiple cases at least one of which is arranged to translate or reciprocate with respect to the rest of such cases. For example, FIG. 7A is a schematic cross-sectional view of an exemplary case member for receiving input force through its upper case which may movably enclose a lower case therein and translate vertically, whereas FIG. 7B is a schematic cross-sectional view of another exemplary case member for receiving input force through its upper case which may be movably enclosed in its lower case and translating vertically according to the present invention. In either embodiment, an exemplary case member 20 includes an upper case 21U and a lower case 21L, where at least one of the cases 21U, 21L may be arranged to movably enclose the other thereof 21L, 21U so that one or both of such cases 21U, 21L may translate or reciprocate along longitudinal axes thereof, resulting in a change in a length or height of the case member 21. More particularly, the lower case 21L defines an opening 23 through which a tip of a cartridge member may be exposed. Upon receiving the input force, either or both of the cases 21U, 21L may be arranged to transmit such input force onto other members and/or their parts of such a writing tool, as exemplified in FIG. 6J.

In another exemplary embodiment of such an aspect of this invention, another writing tool may include an actuator member at least a portion of which may be exposed to receive input force directly from an user and to translate or reciprocate in response thereto. For example, FIG. 7C is a schematic cross-sectional view of another exemplary case member for receiving input force through an actuator member disposed on one end of a case member, while FIG. 7D is a schematic cross-sectional view of another exemplary case member similar to that of FIG. 7C but including an actuator member extending over an end of an upper case according to the present invention. In either embodiment, an exemplary writing tool 10 includes a case member 20 having a single case 21, defining an opening 23 in its lower end, and further defining at least one aperture 28 in its upper end. The writing tool 10 also includes an actuator member with a handle 51 exposed through the aperture 28. More particularly, such a handle 51 is arranged to move between its off- and on-states in response to input force and to transmit such input force onto other members and/or their parts of such a writing tool 10, as exemplified in FIGS. 6A through 6E. It is appreciated that the writing tool 10 of FIG. 7D is similar or identical to that of FIG. 7C, except that the handle 51 of FIG. 7D includes a cover 54 which is arranged to enclose the handle 53 and to extend beyond an upper end of the case 21. In this context, such a cover 54 may be deemed as a part of the case member 20. It is also appreciated that the handle 51 of both figures may also be formed as parts of the cartridge member, where such embodiments may correspond to those of FIGS. 2F and 2G.

In another exemplary embodiment of such an aspect of this invention, another writing tool may include another actuator member at least a portion of which is exposed to receive input force directly from an user and to translate or reciprocate in response thereto. For example, FIG. 7E is a schematic cross-sectional view of another exemplary case member for receiving input force through an actuator member embedded into a side of the case member and translating vertically, whereas FIG. 7F shows a schematic cross-sectional view of another exemplary case member for receiving input force by an actuator member protruding out from a side of the case member and translating vertically according to the present invention. In either embodiment, an exemplary writing tool 10 includes a case member 20 having a single case 21 and defining an opening 23 in its lower end. The writing tool 10 also includes an actuator member with a handle 51 which is exposed through a side of the case 21 and arranged to move between its off- and on-states in response to input force and to transmit such input force onto other members and/or their parts of such a writing tool 10, as exemplified in FIGS. 6A through 6E. It is appreciated that the writing tool 10 of FIGS. 7E and 7F are similar or identical to those of FIGS. 7C and 7D, except that the handles 51 of FIGS. 7E and 7F are disposed not on one end of the case 21 but on the side thereof. It is also appreciated that the writing tool 10 of FIG. 7F is similar or identical to that of FIG. 7E, except that the handle 51 of FIG. 7E translates generally in parallel with a longitudinal axis of the case 21, while that of FIG. 7F moves transverse or normal to a longitudinal axis of the case 21. It is further appreciated that such handles 51 may be disposed in any locations along either side of the case 21. When the handles 51 of the figures are formed as parts of the cartridge member, however, such embodiments may correspond to those of FIGS. 6F and 6G as well. In the alternative, when the handles 51 are to be formed as parts of the cap member, such embodiments may instead correspond to those of FIGS. 6H and 6I.

In another exemplary embodiment of such an aspect of this invention, a writing tool may have multiple cases at least one of which may be arranged to rotate or pivot with respect to the rest of the cases. For example, FIG. 7G is a schematic cross-sectional view of another exemplary case member similar to that of FIG. 7A but having an upper case rotating about a lower case, FIG. 7H is a schematic cross-sectional view of another exemplary case member similar to that shown in FIG. 7B but including an upper case rotating about a lower case, while FIG. 7I shows a schematic cross-sectional view of another exemplary case member similar to that of FIG. 7G but including a lower case which is defined proximate to an opening according to the present invention. In all of these embodiments, an exemplary case member 20 includes an upper case 21U and a lower case 21L, where the latter case 21L forms an opening through which a tip of a cartridge member may be exposed and retracted. At least one of the cases 21U, 21L may be arranged to movably enclose the other thereof 21L, 21U such that one or both of the cases 21U, 21L may rotate or pivot with respect to the other about their longitudinal axes, which may or may not necessarily result in a change in a length and/or height of the case member 21. Upon receiving the input force, either or both of the cases 21U, 21L may be arranged to transmit such input force onto other members and/or their parts of such a writing tool, as exemplified in FIG. 6J.

In another exemplary embodiment of such an aspect of this invention, a writing tool may have an actuator member at least a portion of which is exposed to receive input force directly from an user and to rotate or pivot in response thereto. For example, FIG. 7J is a schematic cross-sectional view of another exemplary case member for receiving input force through an actuator member disposed on and translating radially along a track provided over a side of the case member, FIG. 7K is a schematic cross-sectional view of another exemplary case member for receiving input force through an actuator member pivoting about a center of rotation defined in the case member, whereas FIG. 7L represents a schematic cross-sectional view of another exemplary case member for receiving input force through an actuator member which pivots about a center of rotation exposed thereon according to the present invention. In all these embodiments, an exemplary case member 20 may include a single case 21 and an actuator member which in turn includes a handle 51 arranged to rotate or pivot about a preset part of a writing tool 10. More particularly, the case member 20 of FIG. 7J forms a track 52 defined along a portion of a circumference of the case 21, and the handle 51 is arranged to radially translate along the track 52 in response to input force. The case member 20 of FIG. 7K, however, includes the center of rotation or rotation axis near but inside the case 21 such that the handle 51 may pivot vertically about the center of rotation in response to the input force. The handle shown in FIG. 7L is generally similar or identical to that of FIG. 7K, except that the center of rotation is exposed over and outside the case 21. Upon receiving such input force, either or both of the cases 21U, 21L may be arranged to transmit such input force onto other members and/or their parts of such a writing tool. It is appreciated that the handle 51 of both figures may be formed as parts of the cartridge member, where such embodiments may correspond to those of FIGS. 6F and 6G. Alternatively, when the handles 51 are to be formed as parts of the cap member, such embodiments may instead correspond to those of FIGS. 6H and 6I.

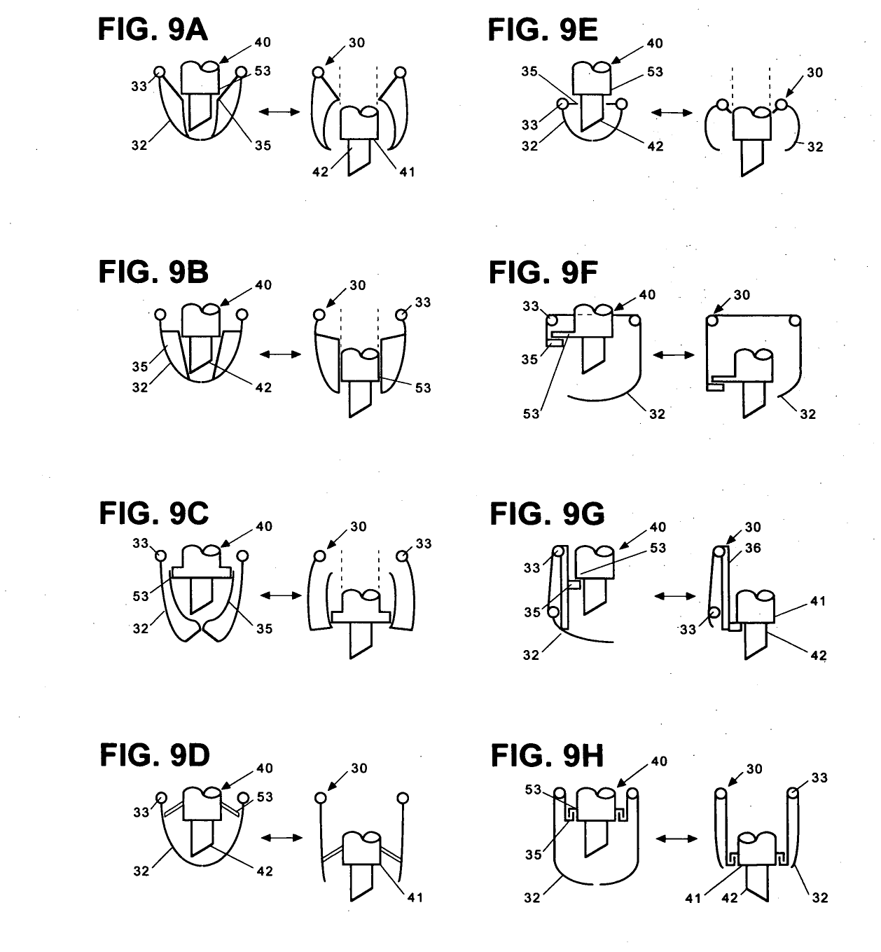

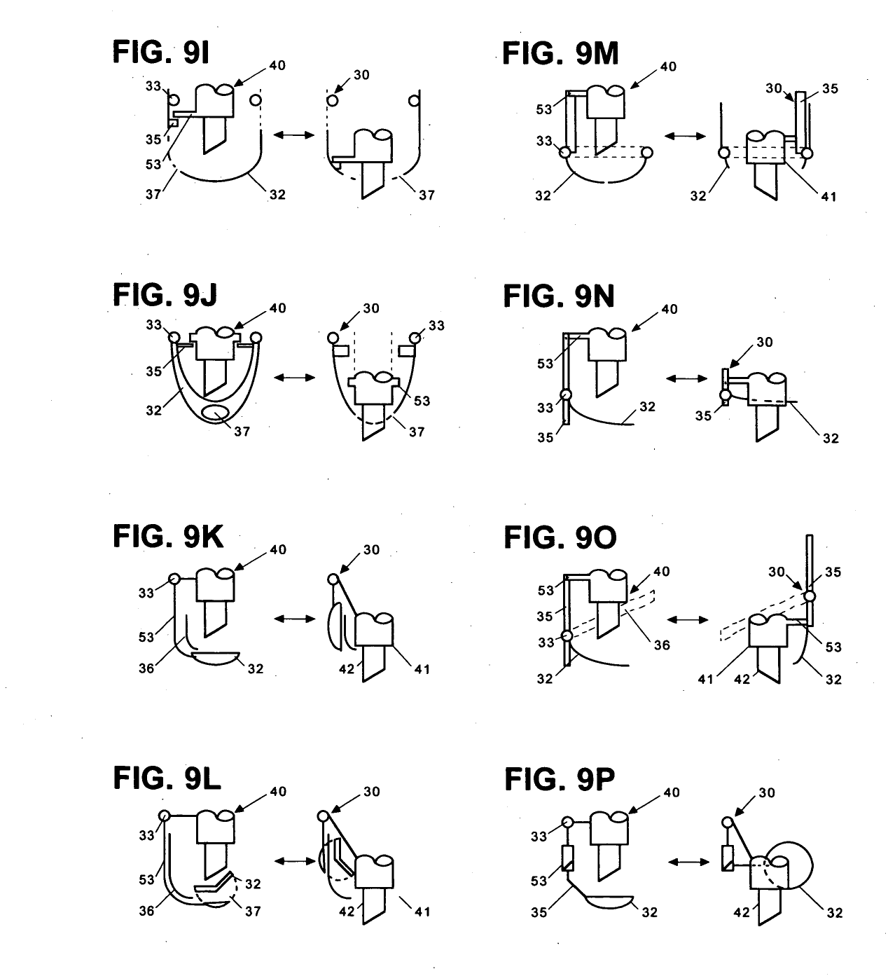

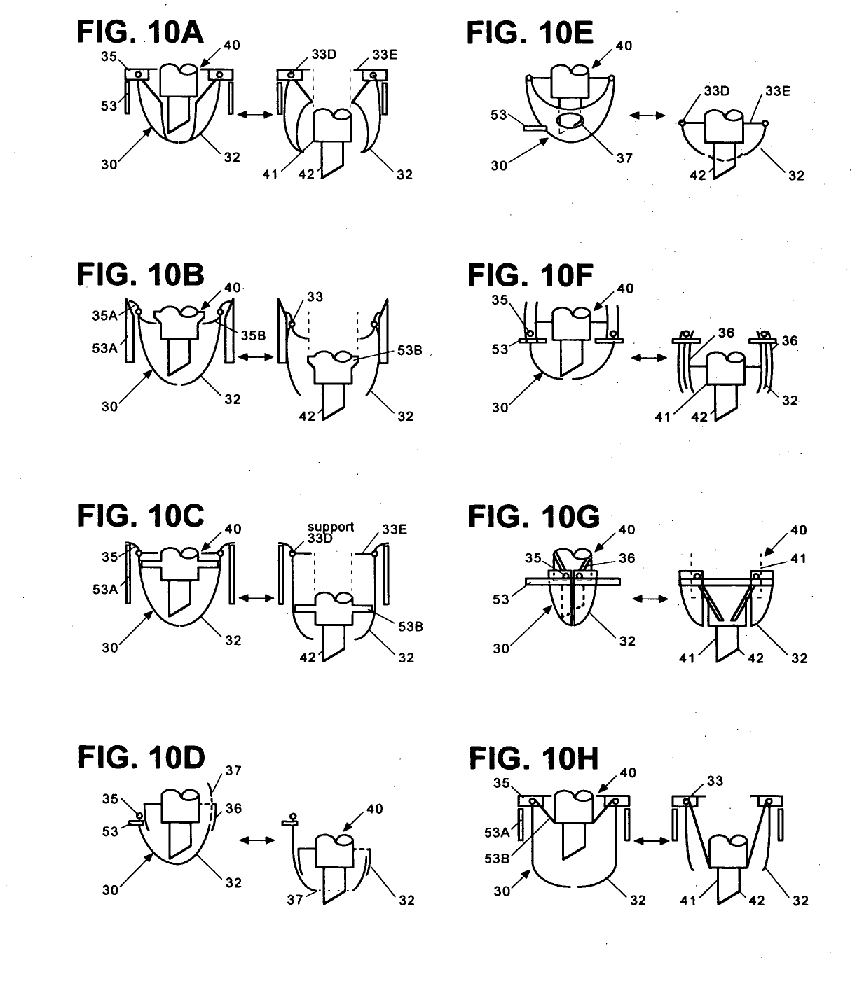

As described above, writing tools of the present invention may employ various mechanisms of force reception and/or transmission through various members thereof and/or various mechanisms for operative and/or mechanical coupling between various members thereof. More particularly, various embodiments of such mechanisms described in FIGS. 8A to 8P exemplify various cap members which may be neither directly nor indirectly coupled to cartridge members, as exemplified in FIGS. 6A and 6J. In contrary, various embodiments of those mechanisms in FIGS. 9A through 9H exemplify various cap members, where movements of their caps between their off- and on-states may be dictated directly or indirectly by cartridge members, as exemplified in FIGS. 6B, 6C, 6F, 6G, and 6J. In addition, various embodiments of those mechanisms in FIGS. 10A to 10H further exemplify various cap members which may dictate movements of cartridge members between their rest and use positions, as exemplified in FIGS. 6D, 6E, 6H, 6I, and 6J. Further details of such mechanisms are to be provided below. It is to be understood that any of the foregoing cap members exemplified in FIGS. 1A to 5H and/or modifications or variations thereof may be applied to any of the following embodiments in FIGS. 8A to 10H and their modifications or variations.

In another aspect of the present invention, various writing tools may include cap members and cartridge members which may move between their off- and on-states and between their rest and use positions, respectively, in order to expose tips of the cartridge members through openings provided on case members and/or through conduits formed by the cap members. FIGS. 8A to 8P show schematic cross-sectional views of exemplary cartridge members which move between rest and use positions thereof and exemplary cap members which operate between off- and on-states thereof according to the present invention. It is to be understood that the cap members and cartridge members exemplified in the following figures may be manipulated independently by actuator members (as exemplified in FIG. 6A), may be operatively coupled directly to each other (as exemplified in FIGS. 6B through 6J), may be coupled to each other through the case member (as exemplified in FIG. 6J), and the like. It is also to be understood that the exemplary cap and cartridge members of the following figures may be arrange so that at least one of such cap and cartridge members may be arranged to move and expose tips of the case members and enclose such tips in such case members. In other words, such cap and cartridge members may move between their off- and on-states and between their rest and use positions or, in the alternative, only cap members may be arranged to move between their off- and on-states relative to stationary cartridge members or, in another alternative, only cartridge members may be arranged to move between their rest and use positions relative to cap members moving between their off- and on-states but not changing their vertical positions. It is further to be understood that following exemplary embodiments of coupling mechanisms between such cap and cartridge members are only intended to illustrate various examples of such an aspect of the present invention, and not to limit the scope of the present invention.

In one exemplary embodiment of this aspect of the present invention, various cap members are arranged to translate or slide through supports so as to obstruct and clear an opening thereby and/or to form and destroy a conduit therebetween. FIG. 8A shows a schematic cross-sectional view of an exemplary cartridge member including a single cap vertically reciprocating through a support between its off- and on-states, while FIG. 8B denotes a schematic cross-sectional view of another exemplary cartridge member including a pair of caps vertically reciprocating through supports between their off- and on-states according to the present invention. In both examples, a writing tool may include a cap member 30 and a cartridge member 40, where the former 30 may include a single cap 32 and a single stationary support 33 in FIG. 8A, or a pair of caps 32 and corresponding stationary supports 33 in FIG. 8B, and where the latter 40 includes a body 41 and a tip 42. Such caps 32 are arranged to translate or slide above, below or across the supports 33 between their off- and on-states in order to obstruct and clear an opening and/or to destroy and form a conduit therebetween such that the tip 42 may be enclosed and exposed. As described hereinabove, the cap members 30 of FIGS. 8A and 8B may be provided by modifying some of the above embodiments and/or may be applied to modify some of such embodiments, e.g., those of FIGS. 1C and 1D, 2E to 2I, 2L, 3A, 3B, 4A, 5C, 5E, 5G, and so on.

In another exemplary embodiment of this aspect of the present invention, various cap members may be arranged to translate or slide with supports in order to obstruct and clear an opening thereby and/or to form and destroy a conduit therebetween. FIG. 8C represents a schematic cross-sectional view of another exemplary cartridge member including a single cap vertically reciprocating along with a support between its off- and on-states, whereas FIG. 8D shows a schematic cross-sectional view of another exemplary cartridge member including a pair of caps vertically reciprocating with supports between their off- and on-states according to the present invention. In both examples, a writing tool may have a cap member 30 and a cartridge member 40 which are similar to those of FIGS. 8A and 8B, except that caps 32 are generally fixedly coupled with supports 33 and, accordingly, move with such supports 33 while moving between their off- and on-states. Other configurational and/or operational characteristics of the writing tool of FIGS. 8C and 8D are similar or identical to those of FIGS. 8A and 8B. As described above, the cap members 30 of FIGS. 8C and 8D may also be provided by modifying some of the foregoing embodiments and/or may be applied to modify some of such embodiments, e.g., those of FIGS. 1C and 1D, 2E to 2I, 2L, 3A, 3B, 4A, 5C, 5E, 5G, and so on.

In another exemplary embodiment of this aspect of the present invention, various cap members may be arranged to rotate or pivot about supports in order to obstruct and to clear an opening thereby and/or to form and to destroy a conduit therebetween. FIG. 8E is a schematic cross-sectional view of another exemplary cartridge member including a single cap pivoting radially about a support between its off- and on-states, while FIG. 8F denotes a schematic cross-sectional view of another exemplary cartridge member with a pair of caps pivoting radially about supports between their off- and on-states in opposite directions according to the present invention. In both examples, a writing tool may include a cap member 30 and a cartridge member 40, where the former 30 may include a single cap 32 and a single stationary support 33 in FIG. 8E, or a pair of caps 32 and corresponding stationary supports 33 in FIG. 8F, and where the latter 40 includes a body 41 and a tip 42. The caps 32 are arranged to pivot or rotate about the supports 33 between their off- and on-states, thereby obstructing and clearing an opening and/or destroying and forming a conduit therebetween such that the tip 42 may be enclosed and exposed. It is appreciated that the caps 32 of FIG. 8F may be arranged to rotate or to pivot along opposite directions or along the same direction As described herein, the cap members 30 of FIGS. 8E and 8F may also be provided by modifying some of the foregoing embodiments and/or may be applied to modify some of such embodiments, e.g., those of FIGS. 1E and 1F, 2D through 2H, 2J, 2L, 3C to 3H, 4B, 5D, 5E, 5H, and so on.

In another exemplary embodiment of this aspect of the present invention, various cap members may be arranged to rotate or pivot about an opening while vertically translating relative to the opening in order to obstruct and clear an opening thereby and/or to form and destroy a conduit therebetween. In one example, FIG. 8G represents a schematic cross-sectional view of another exemplary cartridge member with a single cap translating while circling around an opening between its off- and on-states according to the present invention. An exemplary cap member 30 includes a cap 32 and a support 33 both of which are arranged to travel along a spiral path or an optional track (not shown in the figure) so that the cap 32 may change not only its angular coordinates but also its vertical coordinates. Thus, the cap 32 may obstruct and clear an opening and/or may destroy and form a conduit while translating along the path and/or track between their off- and on-positions. In another example, FIG. 8H shows a schematic cross-sectional view of another exemplary cartridge member having two caps translating while circling around an opening between their off- and on-states according to the present invention. An exemplary cap member 30 is generally similar to that of FIG. 8G, except that its caps 32 may move along opposite paths and/or tracks so as to obstruct and clear an opening and/or to destroy and form a conduit. As described herein, the cap members 30 shown in FIGS. 8G and 8H may also be provided by modifying some of the foregoing embodiments and/or may also be applied to modify some of such embodiments, e.g., those of FIGS. 1E and 1F, 2D to 2H, 2L, 3A, 3B, 3H, 5H, and so on.

In another exemplary embodiment of this aspect of the present invention, various cap members may be arranged to vertically rotate or pivot so as to obstruct and to clear an opening thereby and/or to form and to destroy a conduit therebetween. FIG. 8I represents a schematic cross-sectional view of another exemplary cartridge member with a single cap vertically pivoting about a support between its off- and on-states, while FIG. 8J denotes a schematic cross-sectional view of another exemplary cartridge member having a single cap vertically translating along with a support between its off- and on-states according to the present invention. In both examples, a writing tool includes a cap member 30 and a cartridge member 40, where the cap member 30 has a cap 32 and a support 33 and where the cartridge member 40 includes a body 41 and a tip 42. The cap 32 of FIG. 8I is arranged to pivot or rotate about the support 33 between its off- and on-states, while the cap 32 of FIG. 8J is arranged to pivot or rotate and translate vertically along with such a support 34, thereby obstructing and clearing an opening and/or destroying and forming a conduit therebetween so that the tip 42 may be enclosed and exposed. As described hereinabove, the cap members 30 of FIGS. 8I and 8J may be provided by modifying some previous embodiments and/or may be applied to modify some of those embodiments, e.g., those of FIGS. 1E and 1F, 2D to 2J, 2L, 3C to 3H, 4B, 5E to 5H, and so on.

In another exemplary embodiment of this aspect of the present invention, various cap members may be arranged to define holes therealong and to translate to align such holes with an opening so as to obstruct and clear the opening thereby and/or to form and destroy a conduit therethrough. FIG. 8K is a schematic cross-sectional view of another exemplary cartridge member with a single cap which defines a hole therealong and positioning such a hole while translating along supports between their off- and on-states according to the present invention. A writing tool includes a cap member 30 and a cartridge member 40, where the former 30 includes a cap 32 and multiple supports 33, and the latter 40 has a body 41 and a tip 42. The cap 32 is shaped as a strip or a belt, defines a hole 37 therealong, and arranged to translate while being movably supported or guided by the supports 33. Accordingly, as the cap 32 translates, the hole 37 may obstruct an opening while disposing the hole 37 away from the opening, and may also clear the opening while aligning the hole 37 with an opening. As described above, the cap member 30 of FIG. 8K may be provided by modifying some of the above embodiments and/or may also be applied to modify some of such embodiments, e.g., those of FIGS. 1A and 1B, 2K, and the like.

In another exemplary embodiment of this aspect of the present invention, various cap members may include spherical or truncated caps translating along tracks and/or pivoting about rotation axes in order to obstruct and clear an opening thereby and/or to form and destroy a conduit therebetween. FIG. 8L is a schematic cross-sectional view of another exemplary cartridge member including a single spherical cap moving or rolling along a track between its off- and on-states, whereas FIG. 8M shows a schematic cross-sectional view of another exemplary cartridge member with a lens-shaped single cap which vertically translates along a track between its off- and on-states according to the present invention. A writing tool includes a cap member and a cartridge member 40, where the former 40 has a spherical cap 32 in FIG. 8L or a lens-shaped or truncated spherical cap 32 in FIG. 8M and where the latter 40 includes a body 41 and a tip 42. In both embodiments, the caps 32 are arranged to translate, slide, and/or roll along tracks 36 between their off- and on-positions in order to obstruct and clear an opening and/or to destroy and form a conduit therebetween such that the tip 42 may be enclosed and exposed. Such tracks 36 may be arranged to extend vertically and/or to wind in a spiral manner such that the caps 32 move away from the opening and/or conduit to their on-states. As described herein, the cap members 30 shown in FIGS. 8L and 8M may be provided by modifying some of the foregoing embodiments and/or may be applied to modify some of such embodiments, e.g., those of FIGS. 2D, 2J, 3A, 3C, 4C to 4F, and so on.

In another exemplary embodiment of this aspect of the present invention, various cap members may include spherical or truncated caps which consist of multiple parts and translate along tracks or pivot about rotation axes in order to obstruct and clear an opening thereby and/or to form and destroy a conduit therebetween. FIG. 8N is a schematic cross-sectional view of another exemplary cartridge member including a pair of caps moving toward and away from each other between their off- and on-states, whereas FIG. 8O is a schematic cross-sectional view of another exemplary cartridge similar to that of FIG. 8N but defining receptacles over their top parts according to the present invention. In both examples, a writing tool includes a cap member 30 and a cartridge member 40, where the cap member 30 includes at least two caps 32 forming a sphere or truncation thereof when assembled, and where the cartridge member 40 includes a body 41 and a tip 42. In FIG. 8N, convex capping surfaces of the caps 32 are arranged to face upward while, in FIG. 8O, concave capping surfaces of the caps 32 are facing upward in order to form a receptacle 39A arranged to receive at least a portion of a tip of the cartridge member 40 in its rest position. Such caps 32 of FIGS. 8N and 8O are arranged to translate, rotate, pivot or otherwise move between their off- and on-positions in order to obstruct and clear an opening and/or in order to destroy and form a conduit. As described hereinabove, the cap members 30 of FIGS. 8N and 8O may be provided by modifying some of the previous embodiments and/or may be applied to modify some of such embodiments, e.g., those of FIGS. 1C and 1D, 2D to 2J, 2L, 3A to 3C, 4G, and so on.

In another exemplary embodiment of this aspect of the present invention, various cap members may include caps which may have any arbitrary shapes, form holes therethrough, and align the holes in order to obstruct and clear an opening thereby and/or to form and destroy a conduit therebetween. FIG. 8P is a schematic cross-sectional view of another exemplary cartridge member including a single spherical cap with a hole therethrough and rotating between their off- and on-states according to the present invention. A writing tool includes a cap member 30 and cartridge member 40, where the cap member 30 includes a cap 32 forming a hole 37 therethrough and where the cartridge member 40 has a body 41 and a tip 42. The cap 32 is arranged to roll or rotate while positioning an axis of the hole 37 transverse to and parallel with an opening in order to obstruct and clear the opening, respectively, or in order to destroy and form a conduit, respectively. As described hereinabove, the cap member 30 of FIG. 8P may be provided by modifying some of the previous embodiments and/or may be applied to modify some of such embodiments, e.g., those of FIGS. 1A and 1B, 2K, 4H, and the like.

In another aspect of the present invention, various writing tools may include cap members and cartridge members, where the cartridge members may move between their rest and use positions and to manipulate the cap members to move between their off- and on-states and, respectively, in order to expose tips of the cartridge members through openings of the case members and/or through conduits formed by the cap members. It is to be understood that any cap members and caps thereof described hereinabove and hereinafter may be applied or modified to this end, as far as the cartridge and/or cap members may be arranged to operatively couple with each other so that the cartridge member may be able to manipulate operations of such cap members between off- and on-states thereof. It is also to be understood that such cartridge members may be arranged to manipulate the cap members directly, and/or indirectly through other members of the writing tool such as, e.g., tits case members, actuator members, and the like. FIGS. 9A to 9P show schematic cross-sectional views of exemplary cartridge members capable of directly or indirectly actuating cap members and/or their caps between their off- and on-states according to the present invention. It is to be understood that the following exemplary embodiments of various members are only intended to illustrate various examples of this aspect of the present invention, and not to limit the scope of this invention.

In one exemplary embodiment of such an aspect of the present invention, a cartridge member may be arranged to directly contact a cap of a cap member and to move such a cap from at least one to the other of its off- and on-states. In one example, FIG. 9A describes a schematic cross-sectional view of an exemplary cartridge member arranged to open a cap member by its edge according to the present invention. A cap member 30 typically has a pair of caps 32 and a pair of supports 33, where inner portions of such caps 32 are arranged to protrude inwardly and to form guides 35. The caps 32 are arranged to contact each other in their off-states in order to obstruct an opening thereby and/or to not form any conduit therebetween. A cartridge member 40 has a body 41, a tip 42, and an actuator 53 disposed in a lower portion or leading edge of the body 41 and shaped and sized to abut and push the guides 35 of such caps 32 outwardly as the tip 42 moves downwardly from its rest position to its use position. Accordingly, as the user applies the input force and translates the cartridge member 40 downwardly, its body 41 begins to push the caps 32 outwardly, and the caps 32 rotate or pivot about stationary supports 33 outwardly while clearing the opening and/or creating the conduit. Accordingly, such a tip 42 may be exposed through the opening and/or conduit in its use position. When the user is done with writing or drawing, the cartridge member 40 may be arranged to position the caps 32 back to their off-states or, alternatively, such caps 32 may be arranged to return to their off-states by recoil force generated by their own elasticity and/or provided by a recoil unit. In another example, FIG. 9B is a schematic cross-sectional view of another exemplary cartridge member arranged to open a cap by its edge according to the present invention. A cap member 30 and a cartridge member 40 are typically similar to those shown in FIG. 9A, except that guides 35 of the cap member 30 form generally straight surfaces with respect to an actuator 53. Therefore, contrary to such caps 32 of FIG. 9A which move to their on-states as soon as being abutted by the actuator 53, those caps 32 of FIG. 9B may move to their on-states gradually as the actuator 53 moves vertically and downwardly. Other features of the cap and cartridge members of this embodiment may be similar or identical to those of FIG. 9A.

Still referring to the same exemplary embodiment of the above aspect of the present invention, another example is FIG. 9C which describes a schematic cross-sectional view of another exemplary cartridge member capable of opening a cap member by its protruding edges according to the present invention. A cap member 30 includes a pair of caps 32 and a pair of supports 33, where the caps 32 abut each other so as not to form a conduit in their off-states. A cartridge member 40 includes a body 41, a tip 42, and at least one actuator 53 having protruded edges in a lower portion of the body 41 and shaped and sized to abut and push such caps 32 outwardly as the tip 42 moves downwardly from its rest to use position. Accordingly, as the tip 42 reaches its use position, the caps 32 are moved away from each other and form a conduit through which the tip 42 may be exposed. Further features of the cap and cartridge members of this embodiment may be similar or identical to those of FIGS. 9A and 9B. In another example, FIG. 9D shows a schematic cross-sectional view of another exemplary cartridge member arranged to open a cap member by its protruding edges according to the present invention. A cap member 30 has a pair of caps 32 and a pair of supports 33, where such caps 32 are arranged to abut each other in order to obstruct an opening or to not form a conduit in their off-states. A cartridge member 40 may be generally similar to that of FIG. 1C and includes at least one actuator 53 provided in a lower portion of the body 41 and shaped and/or sized to abut and to push the caps 32 outwardly as the tip 42 moves downwardly from its rest to use position. Further features of the cap and cartridge members of such an embodiment are similar or identical to those shown in FIGS. 9A to 9C. In another example, FIG. 9E is a schematic cross-sectional view of another exemplary cartridge member capable of moving a cap member between its off- and on-states through its protruding edges according to the present invention. A cap member 30 includes a pair of a caps 3 and guide 35 assembly, where each assembly is arranged to pivot about a support 33. A cartridge member 40 is generally similar to that of FIG. 9A, and arranged to abut inner edges of the guides 35 by its lower portions or leading edge of a body 41 to pivot the entire assemblies about he supports 33. Therefore, the caps 32 may move from their off-states to their on-states when the cartridge member 40 begin to depart from its rest position. Other features of the cap and cartridge members of such an embodiment may be similar or identical to those of FIGS. 9A to 9D. It is appreciated that the actuators 53 of all of such above embodiments may be also classified as parts of the cartridge member 40 or those of the actuator member. As described hereinabove, the caps member 30 of FIGS. 9A to 9E may be provided by modifying some of the above embodiments and/or may also be applied to modify some of such embodiments, e.g., those of FIGS. 2D to 2I, 2L, 3C to 3H, 4B, 4D to 4G, 5D, 5E, 5G, 8A to 8I, 8J, 8N, 8O, and the like.

In another exemplary embodiment of such an aspect of this invention, a cartridge member may translate, pull or otherwise move a cap of a cap member from at least one to the other of its off- and on-states while moving between its rest and use positions in the same or opposite directions. In one example, FIG. 9F is a schematic cross-sectional view of another exemplary cartridge member capable of opening a cap of a cap member by horizontally pulling its cap according to the present invention. A cap member 30 includes a cap 32, multiple supports 33, and a guide 35, where such a cap 32 extends upward, across an inner space through the supports 33, and downwardly toward an opening so as to obstruct the opening and/or to not form any conduit in its off-state. A cartridge member 40 includes a body 41, a tip 42, and an actuator 53 provided in a lower portion or leading edge of the body 41, and shaped and/or sized to abut and to push the guide 35 vertically while moving between its rest and use positions. As the user applies the input force and moves the cartridge member 40 downwardly, such an actuator 35 pushes and translates the guide 35 downwardly, resulting in an upward movement of another end of the cap 32 opposite to the guide 35, thus clearing the opening and/or forming conduit. After use, the cartridge member 40 may position the cap 32 back to its off-state or, in the alternative, the cap 32 may return to its off-state by the recoil force as described above. In another example, FIG. 9G is a schematic cross-sectional view of another exemplary cartridge member capable of opening a cap member by vertically pulling a cap thereof according to the present invention. A cap member 30 is typically similar to that of FIG. 9F, but includes a cap 32 of which different portions may be wrapped in opposite directions around a support 33. Accordingly, when a tip 42 of a cartridge member 40 moves downwardly in response to the input force toward its use position while pushing a guide 35 of such a cap 32, an opposite end of the cap 32 translates upward, thereby clearing an opening and/or creating a conduit therebetween. Other features of the cap and cartridge members of this embodiment may be similar or identical to those of FIGS. 9A to 9F.

Still referring to the same exemplary embodiment of the above aspect of the present invention, another example is FIG. 9H which is a schematic cross-sectional view of another exemplary cartridge member and cap member having caps translating vertically according to the present invention. A cap member 30 includes multiple caps 32 each of which may define a guide 35 similar to that of FIG. 9G. A cartridge member 40 is similar to that of FIG. 9G but defining multiple actuators 35 shaped like hooks or catchers and arranged to releasably couple with such guides 35 of the cap member 30 to travel along therewith. Thus, when a tip 42 of a cartridge member 40 moves downwardly in response to the input force toward its use position while pushing the guides 35 of the caps 32, opposite ends of such caps 32 translates upward and clear an opening and/or create a conduit therebetween. Other features of such cap and cartridge members of this embodiment may be similar or identical to those of FIGS. 9A to 9G. As described above, the cap members 30 of FIGS. 9F to 9H may also be fabricated by modifying some of the previous embodiments and/or may be applied to modify some of such embodiments, e.g., those of FIGS. 1A to 1D, 2D, 2I, 2K, 2L, 3A, 4C to 4F, 8A to 8D, 8K, and the like.

In another exemplary embodiment of such an aspect of this invention, a cartridge member may be arranged to translate, pull, pivot or otherwise move a cap of a cap member from at least one to the other of its off- and on-states and aligning its hole with an opening while moving between its rest and use positions in opposite directions. In one example, FIG. 9I shows a schematic cross-sectional view of another exemplary cartridge member and cap member having a cap translating and aligning its hole according to the present invention. A cap member 30 includes a cap 32 and a support 33, where the cap 32 defines a hole 37 and includes a guide 35 therealong. In particular, such a cap 32 is arranged to align or position its hole 37 away from an opening, thereby obstructing the opening in its off-state. A cartridge member 40 is typically similar to that of FIG. 9F and abuts and pushes the guide 35 of the cap 32 downwardly while moving between its rest and use positions. As the user supplies the input force and translates the cartridge member 40 downwardly, the actuator 53 also pushes the guide 35 downwardly and translates the cap 32 therealong, thereby aligning the hole 37 of the cap 32 on and clearing the opening and/or creating the conduit. Accordingly, the tip 42 may be exposed through the opening and/or conduit in its use position. As the user is done with writing or drawing, the cartridge member 40 may be arranged to position the cap 32 back to its off-state or, in the alternative, the cap 32 may be arranged to return to its off-state by such recoil force as described hereinabove. Further features of the cap and cartridge members of such an embodiment may be similar or identical to those of FIGS. 9A through 9H. In another example, FIG. 9J is a schematic cross-sectional view of another exemplary cartridge member and cap member with a cap rotating and aligning its hole according to the present invention. A cap member 30 has a cap 32 and a support 33, where the cap 32 is arranged to define a hole 37, to include a guide 35 therealong, and to pivot about the support 33. In particular, the cap 32 may be arranged to align or position its hole 37 in its off-state vertically away from an opening, thereby obstructing the opening. A cartridge member 40 is typically similar to that of FIG. 9I, and abuts and pushes the guide 35 of the cap 32 downwardly and angularly about the support 33 while moving between its rest and use positions. As the user supplies the input force and translates the cartridge member 40 downwardly, the actuator 53 also pushes the guide 35 downwardly and rotates the cap 32 about the support 33, thereby aligning the hole 37 of the cap 32 on and clearing the opening and/or creating the conduit. Accordingly, the tip 42 may be exposed through the opening and/or conduit in its use position. As the user is done with writing or drawing, the cartridge member 40 may be arranged to position the cap 32 back to its off-state or, in the alternative, the cap 32 may be arranged to return to its off-state by the above recoil force. Other features of the cap and cartridge members of such an embodiment may be similar or identical to those shown in FIGS. 9A to 9I. As described above, the cap members 30 of FIGS. 9I and 9J may be provided by modifying some of the above embodiments and/or may also be applied to modify some of the above embodiments, e.g., those of FIGS. 1A, 1B, 2D, 2I, 2K, 2L, 3A, 4C to 4F, 8A to 8D, 8K, and the like.

In another exemplary embodiment of such an aspect of this invention, a cartridge member may be arranged to translate or rotate a cap of a cap member along a curvilinear track from at least one to the other of its off- and on-states while moving between its rest and use positions. FIG. 9K shows a schematic cross-sectional view of another exemplary cartridge member for translating a lens-shaped cap of a cap member along a track between its off- and on-states according to the present invention. A cap member 30 includes a lens-shaped cap 32, a support 33, and a track 36, where the cap 32 may translate while being guided by the track 36 and where a cartridge member 40 is similar to that shown in FIG. 9G. An actuator 53 is provided by coupling one of its end to a body 41 of the cartridge member 40 and the other end thereof to the cap 32. When the user supplies the input force and translates the cartridge member 40 downwardly, the actuator 53 which fixedly couples with the body 41 of such a cartridge member 40 pulls the cap 32 upwardly along the track 36, thereby clearing the opening and/or creating the conduit. Accordingly, the tip 42 may be exposed through the opening and/or conduit in its use position. As the user is done with writing or drawing, the cartridge member 40 may be arranged to position the cap 32 back to its off-state or, in the alternative, the cap 32 may be arranged to return to its off-state by the above recoil force. Other features of the cap and cartridge members of such an embodiment may be similar or identical to those of FIGS. 9A to 9J. In another example, FIG. 9L shows a schematic cross-sectional view of another exemplary cartridge member capable of opening a cap of a cap member along another track according to the present invention. A cap member 30 has a cap 32, a support 33, and a track 36. The cap 32 is shaped and sized as a truncated sphere and defines a curvilinear hole 37 which is arranged to movably receive the track 36 therethrough. Such a cap 32 is generally oriented to dispose its hole 37 parallel with an opening in its off-state, thereby obstructing an opening by a solid capping surface thereof. When the user supplies the input force and translates the cartridge member 40 downwardly, the actuator 53 fixedly coupling with a body 41 of the cartridge member 40 pulls the cap 32 upwardly along the track 36, thereby clearing the opening and/or creating the conduit and exposing the tip 42 through the opening and/or conduit in its use position. As the user is done with writing or drawing, the cartridge member 40 may be arranged to position the cap 32 back to its off-state or, in the alternative, the cap 32 may be arranged to return to its off-state by the above recoil force. Other features of the cap and cartridge members of such an embodiment may be similar or identical to those of FIGS. 9A to 9K. As described above, such cap members 30 of FIGS. 9K and 9L may be provided by modifying some of the above embodiments and/or may be applied to modify some of the above embodiments, e.g., those of FIGS. 1C, 1D, 2D, 2J, 3A, 4D to 4H, 5H, 8L to 8P, and the like.

In another exemplary embodiment of such an aspect of this invention, a cartridge member may be arranged to translate or rotate a cap of a cap member radially or angularly from at least one to the other of its off- and on-states while rotating between its rest and use positions in opposite directions. FIG. 9M shows a schematic cross-sectional view of another exemplary cartridge member capable of opening a cap member by rotating a guide thereof according to the present invention. A cap member 30 includes multiple caps 32 and supports 33, where such caps 32 match each other and obstruct an opening in their off-states. The cap member 30 also includes a guide 35 operatively coupling with the caps 32 and manipulating such caps 32 to translate vertically or along a spiral path toward and away from each other. A cartridge member 40 may be similar to those of the previous figures, and include an actuator 53 arranged to abut and rotate the guide 35 of the cap member 30. When the user applies the input force by directly or indirectly rotating a body 41 of the cartridge member 40, the actuator 53 rotates the guide 35, resulting in movements of the caps 32 from at least one to the other of their off- and on-states. When the user is done, the cartridge member 40 may be arranged to position the caps 32 back to their off-states or, alternatively, such caps 32 may be arranged to return to their off-states by the recoil force generated by their own elasticity and/or provided by the recoil unit. As described above, the cap member 30 of FIG. 9M may be provided by modifying some of the above embodiments and/or may be applied to modify some of such embodiments, e.g., those of FIGS. 2A to 2C, 2E to 2I, 2L, 3D to 3H, 5A, 5B, and the like.

In another exemplary embodiment of such an aspect of this invention, a cartridge member may rotate or pivot a cap of a cap member about a support from at least one to the other of its off- and on-states while vertically translating between its rest and use positions. FIG. 9N represents a schematic cross-sectional view of another exemplary cartridge member for opening a cap of a cap member by vertically translating a guide thereof according to the present invention. A cap member 30 includes a cap 32, a support 33, and a guide 35, where the cap 32 is arranged to fixedly couple with the guide 35, to be disposed on or over and obstruct an opening in its off-state, and to pivot about the guide 35. A cartridge member 40 is typically similar to those of the previous figures and includes an actuator 53 in its lower portion. When the user applies the input force, the actuator 53 may push the guide 35 and begin to rotate the guide 35 about the stationary support 33. Such a rotating guide 35 also rotates the cap 32 which is fixedly coupled thereto, thereby clearing the opening and/or creating a conduit. When the user is done, the cartridge member 40 may be arranged to position the caps 32 back to their off-states or, alternatively, such caps 32 may be arranged to return to their off-states by the recoil force generated by their own elasticity and/or provided by the recoil unit. As described hereinabove, such a cap member 30 of FIG. 9N may be provided by modifying some of the previous embodiments and/or may be applied to modify some of such embodiments, e.g., those of FIGS. 1E and 1F, 2D to 2I, 2L, 3A, 3D to 3H, 4A, 4G, 5D to 5F, 8E to 8H, 8I, 8J, 8L to 8O, and the like.

In another exemplary embodiment of such an aspect of this invention, a cartridge member may translate, rotate or pivot a cap of a cap member along a track from at least one to the other of its off- and on-states while rotating between its rest and use positions. FIG. 9O depicts a schematic cross-sectional view of another exemplary cartridge member capable of opening a cap member by angularly or radially rotating a cap thereof along its track according to the present invention. A cap member 30 is generally similar to that of FIG. 9N, but includes a track 36 defined along an inner wall of a case of a case member along a radial or spiral path. A cartridge member 40 is also similar to that of FIG. 9N and arranged to rotate a guide 35 of the cap member 30 along the track 36. As the user supplies the input force and directly or indirectly rotates a body 41 of the cartridge member 40, the actuator 53 rotates the guide 35 along the track 36 and removes the cap 32 away from an opening, thereby clearing the opening and/or creating a conduit. When the user is done, the cartridge member 40 may position the cap 32 back to its off-state or, alternatively, the cap 32 may be arranged to return to its off-state by the recoil force as described above. The cap member 30 of FIG. 9O may be provided by modifying some of the previous embodiments and/or may be applied to modify some of such embodiments, e.g., those of FIGS. 1E and 1F, 2D to 2I, 2L, 3A, 3D to 3H, 4A, 4G, 5D to 5F, 8E to 8H, 8I, 8J, 8L to 8O, and the like.

In another exemplary embodiment of such an aspect of this invention, a cartridge member may also move a cap of a cap member angularly or radially about a rotation axis which is transverse to an opening from at least one to the other of its off- and on-states while moving between its rest and use positions. FIG. 9P depicts a schematic cross-sectional view of another exemplary cartridge member for opening a cap member by angularly or radially rotating or pivoting its cap transverse to an opening according to the present invention. A cap member 30 includes a cap 32, a support 33, and a guide 35, where the cap 32 is similar to that of FIG. 9K, while the cap 32 operatively couples with a body 41 of the cartridge member 40 through the support 33. A cartridge member 40 is similar to those of FIGS. 9A to 9C. An actuator 53 is incorporated between the support 33 and guide 35 and, more particularly, the guide 35 is arranged to couple the cap 32 to the actuator 53 at a preset angle so that the cap 32 may rotate or pivot about the guide 35 along a direction and/or at an angle transverse to an opening. Such a cap 32 is disposed to obstruct the opening in its off-state. As the user supplies the input force and translates a body 41 of the cartridge member 40 downwardly, the actuator 53 may pivot or rotate the cap 32 about guide 35 and remove the cap 32 away from the opening in an angular or radial direction, thereby clearing the opening and/or creating a conduit. When the user is done, the cartridge member 40 may position the cap 32 back to its off-state or, alternatively, the cap 32 may be arranged to return to its off-state by the recoil force as described above. The cap member 30 shown in FIG. 9P may also be provided by modifying some of the previous embodiments and/or may be applied to modify some of such embodiments, e.g., those of FIGS. 1E and 1F, 2D to 2I, 2L, 3A, 5H, 8A to 8H, 8M to 8O, and so on.

In another aspect of the present invention, various cartridge members of the writing tools may be arranged to incorporate cap members which may be arranged to be fixedly or movably coupled to the cartridge member and move between their off- and on-states as the cartridge members may move between their rest and use positions. It is to be understood that such cartridge and cap members may be characterized by their physical integrity as an assembly as will be described in detail below and by an actuator member which may typically be disposed in a case member and manipulate such cap and cartridge members to move between their off- and on-states and rest and use positions. Accordingly, tips of the cartridge members may be exposed through openings of the case members and/or through conduits formed by the cap members as the cartridge member travels from its rest to use position and as the cap member moves from its off- to on-state. In this context, such assemblies of this aspect of the present invention may also be regarded as special cases of the cap and cartridge members of the previous aspect of the present invention. It is also to be understood that any cap members and caps thereof described hereinabove and hereinafter may be applied or modified to this end, as far as those cap members may be arranged to fixedly or movably couple with the cartridge member and to operate between its off- and on-state by the actuator member provided to the cartridge and/or case member. It is appreciated that such cartridge members may be arranged to manipulate the cap members and/or their caps directly or indirectly by other members of the writing tool such as, e.g., its case members, actuator members, and the like. FIGS. 10A to 10P are schematic cross-sectional views of exemplary cartridge members fixedly or movably incorporating cap members in order to actuate the cap members and/or their caps to operate between their off- and on-states according to the present invention. It is further appreciated that the following exemplary embodiments of various members are only intended to illustrate various examples of this aspect of the present invention, and not to limit the scope of this invention. It is noted that various guides exemplified in the following FIGS. 10A to 10F may correspond to various supports described in the foregoing figures.

In one exemplary embodiment of such an aspect of this invention, a cartridge-cap assembly is arranged to allow its cartridge member to translate with respect to a cap member while opening caps of the cap member gradually by an edge thereof as the cartridge member moves from its rest position to its use position. FIG. 10A shows a schematic cross-sectional view of an exemplary cartridge-cap member assembly having its cartridge member vertically translating along the cap member and moving caps of the cap member by its edge according to the present invention. It is to be understood that the assembly of FIG. 10A corresponds to the cartridge and cap members of FIG. 9A which are fabricated into the assembly. A cap member 30 include caps 32 which are similar to those shown in FIG. 9A and arranged to rotate or pivot about the supports 33D. The cap member 30 is also arranged to movably couple with and/or to be movably disposed around a body 41 of the cartridge member 40 through an annular support 33E so that such a cap member 30 may translate vertically along the body 41 or vice versa. The cap member 30 is also preferably biased toward a tip 42 of the cartridge member 40 in its off-state, and its caps 32 are also arranged to abut each other in their off-state in order to obstruct an opening and/or to not form a conduit, thereby isolating the tip 42 from an exterior. A cartridge member 40 is similar to that shown in FIG. 9A, while an actuator 53 may be fixedly coupled to a case member. When the user supplies the input force and begins to translate the body 41 of the cartridge member 40 downwardly, the actuator 53 abuts the guide 35 and prevents downward movement of the guide 35. As the body 42 further moves downwardly, the actuator 53 continues to abut the guide 35 and, thus, the body 41 begins to push through the caps 32 outwardly and continues to move downwardly with respect to the cap member 30. As a result, the tip 42 is exposed to the exterior as the cap member 30 moves to its on-state and the cartridge member 40 moves to its use position. As the user is done with writing or drawing, the body 41 of the cartridge member 40 begins to move upwardly, while the caps 32 begin to move back to their off-state. When the body 41 moves to a certain distance, the caps 32 reach their off-state as described in the left panel of FIG. 10A, and the body 41 stop to move in its rest position. As described above, such movements of the cap and/or cartridge members 30, 40 may be actuated by the input force and/or by the recoil unit as described in greater detail below. Such a cap-cartridge member assembly shown in FIG. 10A may also be provided by modifying some of the above embodiments and/or may be applied to modify some of such embodiments, e.g., those of FIGS. 1E and 1F, 2D to 2I, 2L, 3A, 5H, 8A to 8H, 8M to 8O, 9A to 9C, and the like.

In another exemplary embodiment of this aspect of this invention, a cartridge-cap assembly is arranged to allow its cartridge member to translate relative to a cap member while tilting caps of such a cap member gradually by external actuators when the cartridge member moves from its rest position to its use position. FIG. 10B is a schematic cross-sectional view of another exemplary cartridge-cap member assembly having its cap member vertically translating along the cartridge member and tilting its caps by external actuators according to the present invention. It is appreciated that the exemplary assembly of FIG. 10B corresponds to the cartridge and cap members of FIG. 9E which are fabricated into the assembly. A cap member 30 include caps 32 which are similar to those shown in FIG. 9E and arranged to rotate or pivot about supports 33. The cap member 30 also includes multiple guides 35A, 35B, where a first set of guides 35A extends outwardly from the supports 33, while a second set of guides 35B extends inwardly therefrom. Similar to that of FIG. 10A, such a cap member 30 may also be arranged to movably couple with and/or to be movably disposed around a body 41 of the cartridge member 40 so that the cap member 30 translates vertically along the body 41 or vice versa. The cap member 30 is also preferably biased toward a tip 42 of the cartridge member 40 in its off-state, and its caps 32 are also arranged to abut each other in their off-state in order to obstruct an opening and/or to not form a conduit, thereby isolating the tip 42 from an exterior. A cartridge member 40 is similar to that shown in FIG. 10A, except including protrusions which are defined along its surface longitudinally and arranged to abut the second set of guides 35B to serve as actuators 53B. Other actuators 53A are also fixedly coupled to a case member and arranged to abut the first set of guides 35A. When the user applies the input force and translates the body 41 of the cartridge member 40 downwardly, the actuator 53 abuts the second guides 35B and begins tilt the caps 32 about the supports 33. When the body 42 further moves downwardly, the external actuators 53A abut the first guides 35A. Therefore, the body 41 pushes through the caps 32 outwardly and continues to move downwardly with respect to the cap member 30, thereby exposing the tip 42 to the exterior as the cap member 30 moves to its on-state and the cartridge member 40 moves to its use position. When the user is done, the body 41 of the cartridge member 40 begins to move upwardly, and the caps 32 begin to move back to their off-state. When the body 41 moves to a certain distance, the caps 32 reach their off-state as shown in the left panel of FIG. 10B, and the body 41 stop to move in its rest position. As described above, the movements of the cap and/or cartridge members 30, 40 may be actuated by the input force and/or by the recoil unit as described in greater detail below. Such a cap-cartridge member assembly shown in FIG. 10B may also be provided by modifying some of the above embodiments and/or may be applied to modify some of such embodiments, e.g., those described in FIGS. 2D to 2I, 2L, 3C to 3H, 4B, 4D to 4G, 5D, 5E, 5G, 8A to 8I, 8J, 8N, 8O, 9E, and the like.

In another exemplary embodiment of this aspect of this invention, a cartridge-cap assembly is arranged to allow its cartridge member to translate relative to a cap member and pushing and opening caps of the cap member gradually by actuators incorporated thereinto as the cartridge member moves from its rest position to its use position. FIG. 10C shows a schematic cross-sectional view of another exemplary cartridge-cap member assembly with its cartridge member moving caps of the cap member by its protruding edges according to the present invention. It is to be appreciated that the exemplary assembly of FIG. 10C corresponds to the cartridge and cap members of FIG. 9D which are fabricated into the assembly. A cap member 30 include caps 32 which are similar to those of FIG. 9D, a pair of guides 35 similar to the first guides 35A of FIG. 10D. Similar to that of FIG. 10A, the cap member 30 is arranged to movably couple with and/or to be movably disposed around the cartridge member 40, and preferably biased toward a tip 42 of the cartridge member 40 in its off-state, and its caps 32 are also arranged to abut each other in their off-states. In addition, a cartridge member 40 is typically similar to that of FIG. 9D, and external actuators 53A are also fixedly coupled to a case member and arranged to abut the guides 35A. As the user applies the input force and translates the body 41 downwardly, actuators 53B disposed on the cartridge member 40 abuts the caps 32 and begin to move such caps 32 downwardly along therewith. As the body 42 further moves downwardly, the external actuators 53A abut the guides 35 and, therefore, the body 41 pushes and opens the caps 32 outwardly, while translating therethrough, thereby exposing the tip 42 to the exterior as the cap member 30 moves to its on-state and the cartridge member 40 moves to its use position. When the user is done, the body 41 of the cartridge member 40 begins to move upwardly, and the caps 32 begin to move back to their off-state. When the body 41 moves to a certain distance, the caps 32 reach their off-state as shown in the left panel of FIG. 10C, and the body 41 stop to move in its rest position. As described above, the movements of the cap and/or cartridge members 30, 40 may be actuated by the input force and/or by the recoil unit as described in greater detail below. Such a cap-cartridge member assembly shown in FIG. 10B may also be provided by modifying some of the above embodiments and/or may be applied to modify some of such embodiments, e.g., those described in FIGS. 2D to 2I, 2L, 3C to 3H, 4B, 4D to 4G, 5D, 5E, 5G, 8A to 8I, 8J, 8N, 8O, 9D, and the like.

In another exemplary embodiment of such an aspect of the present invention, a cartridge-cap assembly is arranged to allow an external actuator to move its cap member between its off- and on-states and aligning holes defined therein with an opening when its cartridge member moves between its rest and use positions. In one example, FIG. 10D is a schematic cross-sectional view of another exemplary cartridge-cap member assembly having its cap member defining and aligning a hole while being translated by an external actuator along an external guide according to the present invention. It is to be noted that the exemplary assembly of FIG. 10D corresponds to the cartridge and cap members of FIG. 9I which are fabricated into the assembly. A cap member 30 include a cap 32 which is similar to that of FIG. 9I, one end of which terminates at a guide 35 and the other end of which is disposed in a case. The cap member 30 also includes a track 36 along which the cap 32 and/or guide 35 may be arranged to translate while being guided thereby. The cap member 30 is also biased toward a tip 42 of the cartridge member 40 in its off-state, and its caps 32 are arranged to abut each other in their off-states, similar to those shown in FIGS. 10A to 10C. A cartridge member 40 may be generally similar to that of FIG. 9I, except that the track 36 of the cap member 30 may be fixedly coupled thereto, while an external actuator 53 is fixedly coupled to a case member and arranged to abut the guides 35. As the user applies the input force and translates the body 41 downwardly, the actuator 53 abuts the guide 35 and the cap 32 begins to be pulled by the actuator 53 along the track 36, while positioning its hole 37 closer to an opening. As the body 42 further moves downwardly, the actuator 53 further pulls the cap 32 such that its hole 37 of the cap 32 may be disposed over the opening, thereby exposing the tip 42 to the exterior as the cap and cartridge members 30, 40 respectively move to its on-state and use position. When the user is finished, the body 41 begins to move upwardly, while the cap 32 begins to move back to its off-state. When the body 41 moves to a preset distance, the cap 32 reaches its off-state as exemplified in the left panel of FIG. 10D, and the body 41 stops in its rest position.

Still referring to the same exemplary embodiment of such an aspect of thereof and in another example, FIG. 10E represents a schematic cross-sectional view of another exemplary cartridge-cap member assembly having its cap member which defines and aligns its hole while being pivoted by an external actuator and guided by an external guide according to the present invention. A cap member 30 similarly includes a cap 32 which defines a hole 37 therein and is arranged to pivot about supports 33D. Such a cap member 30 is also biased toward a tip 42 of the cartridge member 40 in its off-state, and its cap 32 is arranged to position the hole 37 away from an opening in its off-state, similar to that of FIG. 10D. A cartridge member 40 and an external actuator 53 may be generally similar to those of FIG. 9I. As the user applies the input force and translates the body 41 downwardly, the actuator 53 abuts the guide 35 and the cap 32 begins to be radially pivoted by the actuator 53, while positioning its hole 37 closer to an opening. As the body 42 further moves downwardly, the actuator 53 pivots such a cap 32 so that its hole 37 of the cap 32 may be disposed over the opening, thereby exposing the tip 42 to the exterior. When the user is finished, the body 41 begins to move upwardly, while the cap 32 begins to move back to its off-state. As the body 41 moves to a preset distance, the cap 32 reaches its off-state as exemplified in the left panel of FIG. 10E, and the body 41 stops in its rest position. As described above, the movements of the cap and/or cartridge members 30, 40 of both examples may be actuated by the input force and/or by the recoil unit as described in greater detail below. The cap cartridge member assemblies of FIGS. 10D and 10E may be provided by modifying some of the above embodiments and/or may also be applied to modify some of such embodiments, e.g., those described in FIGS. 1A, 1B, 2D, 2I, 2K, 2L, 3A, 4C to 4F, BA to 8D, 8K, and the like.

In another exemplary embodiment of such an aspect of the present invention, a cartridge-cap assembly is arranged to allow an external actuator to move its cap member along guides between its off- and on-states as its cartridge member moves between its rest and use positions. In one example, FIG. 10F is a schematic cross-sectional view of another exemplary cartridge-cap member assembly having its cap member sliding in and out between a pair of guides by external actuators according to the present invention. A cap member 30 has multiple caps 32 and guides 35, and a cartridge member 40 is similar to those of FIGS. 10D and 10E and fixedly couples with a pair of tracks 36 disposed next to each other. Such a cap member 30 is also biased toward a tip 42 of the cartridge member 40 in its off-state, and its cap 32 is arranged to abut each other and to obstruct an opening and/or not to form a conduit. External actuators 53 are further provided in order to abut the guides 35 of the cap member 30. When the user applies the input force and translates the body 41 downwardly, the actuators 53 similarly abut the guide 35 and stop movement of the cap member 30, while allowing movement of the body 41. As the body 42 continues to move downwardly, the caps 32 continue to be abutted by the actuators 53 and to begin to be interposed between the tracks 36, thereby exposing the tip 42 to the exterior. When the user is finished, the body 41 begins to move upwardly, while the cap 32 begins to move back to its off-state. When the body 41 moves to a preset distance, the cap 32 reaches its off-state as exemplified in the left panel of FIG. 10F, and the body 41 stops in its rest position. In another example, FIG. 10G represents a schematic cross-sectional view of another exemplary cartridge-cap member assembly including its cap member translated by external actuators according to the present invention. Similar to that of FIG. 10F, a cap member 30 includes multiple caps 32 and is biased toward a tip 42 of the cartridge member 40 in its off-state. A cartridge member 40 and an external actuator 53 are generally similar to those of FIG. 10E, except that multiple tracks 36 are formed on an exterior of a body 41 of the cartridge member 40. When the user supplies the input force and translates the body 41 downwardly, the actuator 53 abuts the guides 35 and stop movement of the cap member 30, while allowing movement of the body 41. When the body 42 continues to move downwardly, such caps 32 may begin to be move apart from each other along the tracks 36 which diverge from each other along an upward direction, thereby exposing the tip 42 to the exterior. As the user is finished, such a body 41 begins to move upwardly, while the cap 32 begins to move back to its off-state. When the body 41 moves to a preset distance, the caps 32 reach their off-states as shown in the left panel of FIG. 10F, and the body 41 rests in its rest position. As described above, movements of the cap and/or cartridge members 30, 40 of these examples may be similarly actuated by the input force and/or the recoil unit. The cap-cartridge member assemblies of FIGS. 10F and 10G may also be provided by modifying some of the previous embodiments and/or may be applied to modify some of such embodiments, e.g., those described in FIGS. 1C, 1D, 2D to 2I, 2L, 3A, 3B, 3D to 3H, 4A, 4B, 4G, 5D to 5G, 8A to 8D, 8H, 8L to 8P, and the like.

In another exemplary embodiment of such an aspect of the present invention, a cartridge-cap assembly may be arranged to allow its cartridge member to push and/or pull its cap member between its off- and on-states as its cartridge member moves between its rest and use positions. FIG. 10H is a schematic cross-sectional view of another exemplary cartridge-cap member assembly having its cap member pulled or pushed directly by the cartridge member according to the present invention. It is to be understood that the exemplary assembly of FIG. 10E corresponds to any of such cartridge and cap members of FIGS. 9I, 9J, and 9L which are fabricated into the assembly. A cap member 30 includes multiple caps 32, supports, and guides 35, and a cartridge member 40 includes a body 41 and a tip 42, where such caps 32 terminate by being fixedly coupled to the body 41 and are movably supported by the supports 33 such that the caps 32 may be pulled or pushed while being movably supported by the supports 33 by the body 41. Similar to those of the above embodiments, the cap member 30 may also be arranged to movably couple with and/or to be movably disposed around the cartridge member 40, and preferably biased toward a tip 42 of the cartridge member 40 in its off-state, and its caps 32 are also arranged to abut each other in their off-states. In addition, actuators 53 are also fixedly coupled to a case in order to abut the guides 35. As the user supplies the input force and translates the body 41 downwardly, the actuator 53 abuts the guides 35 and stop movement of the cap member 30, while allowing movement of the body 41. As the body 42 continues to move downwardly, such a body 41 pulls the caps 32 which may then begin to be move apart from each other, thereby exposing the tip 42 to the exterior. As the user is done, the body 41 begins to move upwardly, while the caps 32 begin to move back to their off-states. When the body 41 moves to a preset distance, the caps 32 reach their off-states as exemplified in the left panel of FIG. 10H, while the body 41 stops in its rest position. As described above, movements of the cap and/or cartridge members 30, 40 of such an example may be similarly actuated by the input force and/or by the recoil unit. The cap-cartridge member assemblies of FIG. 10H may also be provided by modifying some of the previous embodiments and/or may be applied to modify some of such embodiments, e.g., those described in FIGS. 1A, 1B, 2A to 2I, 2K, 2L, 3A, 3B, 3D to 3H, 4C to 4F, 5A, 5B, 8A to 8D, 8K, and the like.

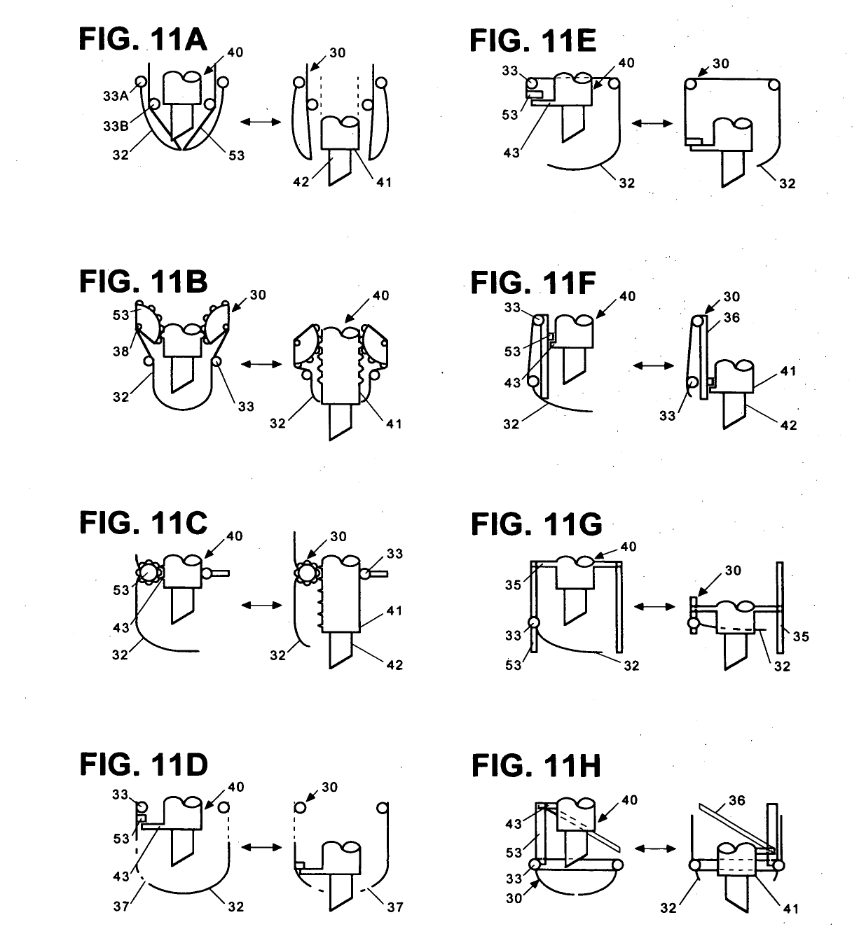

In another aspect of the present invention, various writing tools may include cap members and cartridge members, where the cap members may move between their off- and on-states and to also manipulate the cartridge members to move between their rest and use positions and, respectively, in order to expose tips of the cartridge members through openings of the case members and/or through conduits formed by the cap members. It is to be understood that any cap members and caps thereof described hereinabove and hereinafter may be applied or modified to this end, as far as the cartridge and/or cap members may be arranged to be operatively coupled to each other so that the cap member may manipulate movements of such cartridge members between their rest and use positions. It is also to be understood that the cap members may be arranged to manipulate the cartridge members directly, and/or indirectly through other members of the writing tool such as, e.g., tits case members, actuator members, and the like. FIGS. 11A to 11H describe schematic cross-sectional views of exemplary cap members capable of directly or indirectly actuating cartridge members to move between their rest and use positions according to this invention. It is to be understood that following exemplary embodiments of various members are only intended to illustrate various examples of such an aspect of the present invention, and not to limit the scope of this invention.

In one exemplary embodiment of this aspect of the present invention, a cap member may pull or otherwise translate a cartridge member from at least one to the other of its rest and use positions by a string actuator while moving between its off- and on-states. FIG. 11A is a schematic cross-sectional view of an exemplary cap member moving a cartridge member using its teeth according to the present invention. A cap member 30 has a pair of caps 32 and multiple supports 33A, 33B, while a cartridge member 40 includes a body 41 and a tip 42. An actuator 53 is also provided to operatively couple the cap and cartridge members 30, 40. More particularly, one end of a string-type actuator 53 is coupled to lower ends of the caps 32, whereas an opposing end (not shown in the figure) of the actuator 53 is coupled to an upper portion of the body 41, such that movement of one of the caps 32 and body 41 results in movement of the other thereof in an opposite direction. In its off-state, the caps 32 abut each other and enclose the tip 42 inside a case member. As the user applies the input force directly or indirectly to the cap member 30, its caps 32 move outwardly and begin to clear an opening. At the same time, the caps 32 pull the actuator 53 which in turn vertically translates the cartridge member 40 to its use position. When the user is finished with writing or drawing, the caps 32 move back to their off-state while releasing the actuator 53 which may then move such a cartridge member 40 back to its rest position. In the alternative, the cartridge member 40 may be arranged to return to its rest position by the recoil force as described above. It is appreciated that the embodiment of FIG. 11A is generally similar to that of FIG. 10A, except a sequence of force transmission, i.e., the input force is transmitted from the cap member 30 to the cartridge member 40 in FIG. 11A, whereas the converse is true for the embodiment of FIG. 10A. Accordingly, the cap member 30 of FIG. 11A may be provided by modifying some of the above embodiments and/or applied to modify some of those embodiments, e.g., those of FIGS. 2D to 2I, 2L, 3C to 3H, 4B, 4D to 4G, 5D, 5E, 5G, 8A to 8I, 8J, 8N, 8O, 9A to 9D, and the like.

In another exemplary embodiment of such an aspect of the present invention, a cap member may translate or otherwise move a cartridge member from at least one to the other of its rest and use positions by a gear assembly while moving between its off- and on-states. In one example, FIG. 11B shows a schematic cross-sectional view of another exemplary cap member moving such a cartridge member by a gear assembly according to the present invention. A cap member 30 has a pair of caps 32 and multiple supports 33A, 33B, while a cartridge member 40 has a body 41 with teeth and a tip 42. A circular actuator 53 is also provided with teeth and arranged to operatively couple with the caps 32 such that vertical translation of such caps 32 results in rotation thereof about a rotation axis 38. Such caps 32 are also arranged to abut each other and enclose the tip 42 inside a case member in their off-states. When the user applies the input force directly or indirectly to the cap member 30, the caps 32 are pulled upwardly, while being guided by the stationary supports 33, and begin to clear an opening. Such translation rotates the actuator 53 which in turn vertically translates the cartridge member 40 to its use position. As the user is through with writing or drawing, such caps 32 move back to their off-state while rotating the actuator 53 in the opposite direction, which then moves the cartridge member 40 back to its rest position. In the alternative, the cartridge member 40 may be arranged to return to its rest position by the recoil force as described hereinabove. In another example, FIG. 11C represents a schematic cross-sectional view of another exemplary cap member moving the cartridge member by a gear assembly according to the present invention. A cap member 30 has a cap 32, while a cartridge member 40 is generally similar to that of FIG. 11B. A circular actuator 53 with teeth is also arranged to couple with the cap 32 such that similar vertical translation of the cap 32 results in rotation thereof. In this embodiment, however, the cap 32 is arranged to wind around the actuator 53 in order to directly rotate the actuator 53 in an opposite direction while translating and circling about the actuator 53. The cap 32 is also arranged to obstruct an opening and enclose the tip 42 inside a case member in its off-state. As the user applies the input force directly or indirectly to the cap member 30, such a cap 32 is pulled upwardly and begins to clear the opening. Such translation rotates the actuator 53 which may then vertically translate the cartridge member 40 toward its use position. As the user is through, such a cap 32 moves back to its off-state while rotating the actuator 53 in an opposite direction, which may move the cartridge member 40 back to its rest position. Alternatively, the cartridge member 40 may be arranged to return to its rest position by the recoil force as described hereinabove. It is appreciated that the embodiments of FIGS. 11B and 11C are typically similar to that of FIG. 10B, except a sequence of force transmission is reversed. Accordingly, such cap members 30 of FIGS. 11B and 11C may be provided by modifying some of the above embodiments and/or may be applied to modify some of those embodiments, e.g., those of FIGS. 2D to 2I, 2L, 3C to 3H, 4B, 4D to 4G, 5D, 5E, 5G, 8A to 8I, 8J, 8N, 8O, and the like.

In another exemplary embodiment of such an aspect of this invention, a cap member translates a cartridge member from at least one to the other of its rest and use positions therewith while moving between its off- and on-states. FIG. 11D is a schematic cross-sectional view of another exemplary cap member moving a cartridge member by horizontally pulling a cap thereof, FIG. 11E is a schematic cross-sectional view of another exemplary cap member similarly moving a cartridge member, and FIG. 11F depicts a schematic cross-sectional view of another exemplary cap member moving a cartridge member in opposite directions according to the present invention. In all three examples, cap members 30 and cartridge member 40 are respectively similar or identical to those shown in FIGS. 10C, 10D, and 10E, except that actuators 53 may be provided to caps 32 of the cap members 30 and guides 43 may be provided to bodies 41 of the cartridge members 40 such that the cap members 30 actuate vertical movements of the cartridge members 40. Further configurational and/or operational characteristics of these embodiments are similar or identical to those of FIGS. 10C, 10D, and 10E. As described herein, the cap members 30 of FIGS. 11D, 11E, and 11F may be provided by modifying some of the foregoing embodiments and/or may be applied to modify some of those embodiments, e.g., those of FIGS. 1A to 1D, 2D, 2I, 2K, 2L, 3A, 4C to 4F, 8A to 8D, 8K, 9F to 9I, 9K, 9L, and the like.

In another exemplary embodiment of such an aspect of this invention, a cap member rotates or pivots a cartridge member about a support from at least one to the other of its rest and use positions therewith while moving between its off- and on-states. FIG. 11G is a schematic cross-sectional view of another exemplary cap member moving a cartridge member by vertically pushing a guide according to the present invention. A cap member 30 and a cartridge member 40 are generally similar to those of FIG. 10G. However, an actuator 53 is provided to a cap 32 of the cap member 30, while a guide 43 is provided to a body 41 of the cartridge members 40 such that the cap member 30 may actuate vertical movements of the cartridge members 40. Further configurational and/or operational characteristics of this embodiment are similar or identical to those of FIG. 10G. As described above, the cap member 30 of FIG. 11G may be provided by modifying some of the foregoing embodiments and/or may be applied to modify some of the above embodiments, e.g., those of FIGS. 1E and 1F, 2D to 2I, 2L, 3A, 3D to 3H, 4A, 4G, 5D to 5F, 8E to 8H, 8I, 8J, 8L to 8O, 9J, 9N, and the like.

In another exemplary embodiment of such an aspect of this invention, a cap member rotates or pivots a cartridge member radially or circumferentially along a track from at least one to the other of its rest and use positions therewith while moving between its off- and on-states. FIG. 11H represents a schematic cross-sectional view of another exemplary cap member moving such a cartridge member by rotating a guide thereof along its track according to the present invention. A cap member 30 and a cartridge member 40 are similar to those of FIG. 10H, except that an actuator 53 is provided to caps 32 of the cap members 30 and a guide 43 is provided to a body 41 of the cartridge member 40 so that the cap member 30 actuates vertical movements of the cartridge member 40. Other configurational and/or operational characteristics of this embodiment are typically similar or identical to those of FIG. 10H. As described herein, the cap member 30 of FIG. 11H may be provided by modifying some of the foregoing embodiments and/or may be applied to modify some of those embodiments, e.g., those of FIGS. 1E and 1F, 2D to 2I, 2L, 3A, 3D to 3H, 4A, 4G, 5D to 5F, 8E to 8H, 8I, 8J, 8L to 8O, 9M to 9O, and the like.

In another aspect of the present invention and as described hereinabove, various writing tools may include at least one recoil unit which is arranged to store at least a portion of mechanical energy supplied to various members of the writing tools by the user and to release such energy according to preset temporal and/or spatial patterns. The recoil unit may be adopted by the writing tool for various purposes, made of or include various materials for exhibiting such recoil characteristics and providing such recoil force, and the like.

In one exemplary embodiment of such an aspect of the present invention, the writing tool may include at least one recoil unit which may be arranged to store at least a portion of mechanical energy provided by the user and/or associated with an input force supplied by the user (or to be referred to simply as “energy” hereinafter for simplicity of illustration) for the purpose of moving various members and/or their parts (or to be referred to simply as “members” hereinafter for simplicity of illustration) of the writing tool from one to the other of their off- and on-states, and/or from one to the other of their rest and use positions. Therefore, such a recoil unit may store the energy while the case, cartridge, and/or actuator members move from one to the other of their rest and use positions and release such energy to return the case, cartridge, and/or actuator members from the other back to the one of such positions. Similarly, the recoil unit may store such energy while the cap member or at least one cap of the cap member (or to be referred to simply as “cap member” hereinafter for simplicity of illustration) moves from one to the other of its off- and on-states and may release such energy to return the cap member to from the other to the one of such states. To such ends, such a recoil unit may be disposed in various locations of the writing tool and coupled to various members as far as the recoil unit may be arranged to store the energy while being supported by other members of the writing tool, and then to release such energy to at least one member of the tool through an appropriate mechanical coupling.

In another exemplary embodiment of such an aspect of the present invention, the writing tool may include at least one recoil unit which may be arranged to operatively couple at least two members of the tool and/or to transmit the energy or force from one to the other of such member therethrough. In one example, the recoil unit may be disposed between two or more members in order to movably or fixedly couple such members. Such a recoil unit may not only couple such members but also allow at least minimal movement of at least one of those members with respect to the other thereof. In another example, the recoil unit may also be used to transmit various forces including the input force between different members. Such a recoil unit may be arranged to be disposed between multiple members and to transmit various forces from one to the other end thereof, generally without changing amplitudes or directions thereof. However, the recoil unit may be arranged to be aligned transverse to directions of such forces, thereby transmitting forces which have amplitudes and/or directions compared with the forces received thereby.

In another exemplary embodiment of such an aspect of the present invention, the writing tool may include at least one recoil unit which may be arranged to apply tension force, compression force, and/or torque along at least one curvilinear direction in order to bias at least one member of the writing tool to or toward a favorable position and/or along a desirable direction. In one example, such a recoil unit may be arranged to be disposed in its stressed (i.e., compressed or extended) state between at least two parts or members of the writing tool so that the recoil unit may utilize its tendency or force to restore its unstressed configuration as a source of its recoil force. Therefore, such a recoil unit may be kept or maintained in its stressed position and exert the recoil force constantly regardless of which states or positions a certain member of the writing tool may be disposed or moved onto. Alternatively, the recoil unit may be arranged to restore its unstressed configuration or at least a portion thereof as a certain member of the writing tool is disposed or moves to or toward one of its off- and on-states or rest and use positions. In another example, the recoil unit may be arranged to store the energy and to use the energy to exert the recoil force which may bias at least one member to or toward a desirable position and/or in a favorable direction. The recoil unit is generally disposed in its unstressed position in its original disposition, and then moves to its stressed position in response to the energy supplied by the user. Upon storing the energy, the recoil unit may release an entire portion of the stored energy at once or in a succession of multiple occasions in order to bias such a member as described above.

In another exemplary embodiment of such an aspect of the present invention, such a recoil unit may be arranged to store such energy, and then to release such energy according to preset temporal and/or spatial patterns. In one example, the recoil unit may be arranged to release the stored energy instantaneously, and a member of the writing tool receiving such energy may move at a speed which may be attainable by an amplitude of such energy. In another example, the recoil unit may instead be arranged to release the stored energy at a preset speed and/or limit so as to control movement of the member which receives the energy. To this end, mechanical load on the part of the energy receiving member may be adjusted not to consume an entire energy instantaneously or, in the alternative, such a recoil unit may only release the energy at a rate below a preset limit. In yet another example, such a recoil unit may be used in conjunction with at least one conventional damper so that the recoil unit and damper may exhibit viscoelastic characteristics in response to such energy.

In another exemplary embodiment of such an aspect of the present invention, such a recoil unit may also be made of and/or include various materials and/or arrangements in order to generate recoil force or, in the alternative, so as to store the energy and to generate recoil force in response thereto. In one example, such a recoil unit may be made of at least one elastic (including viscoelastic) material so that the recoil unit may move or may be moved between its unstressed and stressed position while storing and releasing the energy. The recoil unit may have any shapes and/or sizes and may be made of any conventional natural or synthetic substances. In another example, the recoil unit may include at least one conventional elastic element arranged to generate recoil force in response to deformation of at least a portion thereof, where examples of such elastic elements may include, but not be limited to, springs, coils, torsion bars, elastic sheets, elastic rods, elastic bands, elastic nets, snap tapes, cross-curve materials, stampings, extension or compression round wires, tension round wires, and the like, where most of which are available from Vulcan Springs Work, Telford, Pa. In particular, such springs may also include cylindrical coil springs, conical coil springs, flat spiral springs, curved spiral springs, leaf springs, torque springs, torsion bars, and the like. Those springs may be compression springs to be compressed in their stressed positions, extension springs to be stretched and/or elongated in their stressed positions, constant force springs having constant spring constants, variable springs having spring constants which may vary with their lengths and/or with extents of deformation, and the like.

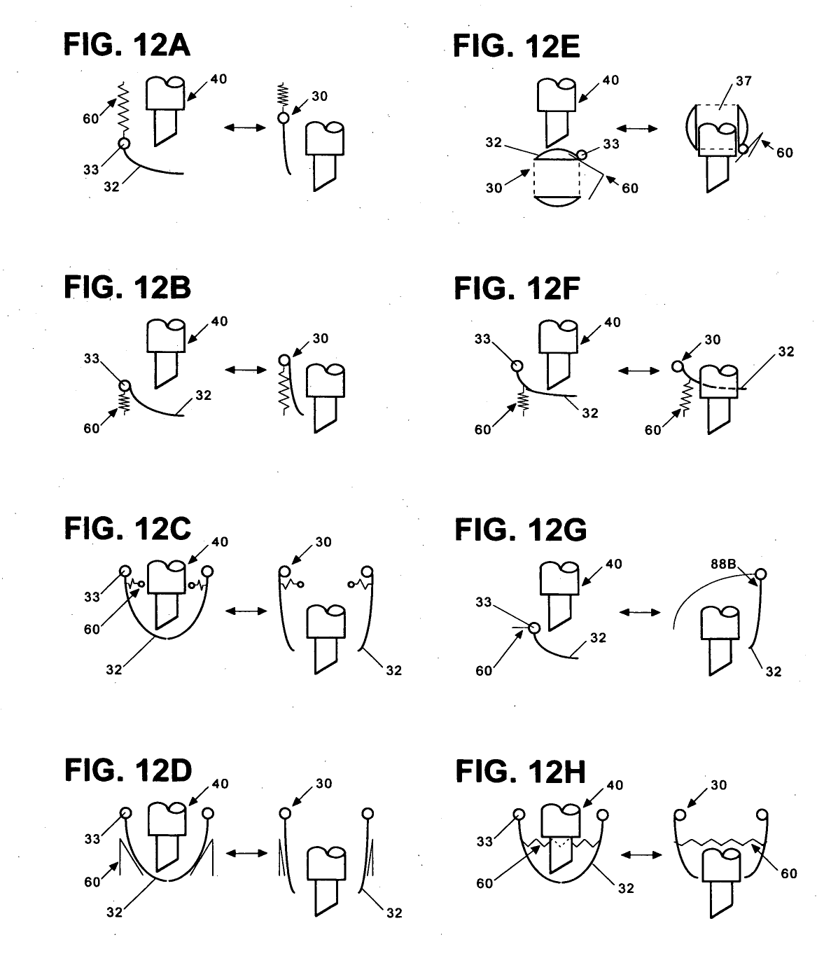

In another aspect of the present invention, such recoil units may be coupled to and disposed in various members and/or their parts of the writing tools. In general, exact modes of disposition and/or couplings of such recoil units depend at least in part on various factors such as, e.g., a transmission sequence or path of the input force, configuration of a member to which the recoil unit may exert such recoil force, types of the recoil units such as compression and/or extension types, and the like. FIGS. 12A to 12H are schematic cross-sectional views of exemplary recoil units which are arranged to be coupled to various cap members and to actuate their caps between their off- and on-states according to the present invention. Although the following exemplary recoil units are incorporated into only some of the cap members, it is appreciated that such recoil units and/or their obvious modifications may also be incorporated into any cap members and their caps of this invention described above and below so as to move such caps from one to the other of their off- and on-states and/or in order to bias the caps toward favorable positions and/or in desirable directions. It is also appreciated that such recoil units and/or their obvious modifications may be incorporated into other members of the writing tool in order to move the case members, cartridge members, and/or actuator members from one to the other of rest and use positions thereof and/or in order to bias such members toward favorable positions and/or in desirable directions. In any of these applications, incorporations, and/or modifications, the recoil units may couple with various members and/or their parts through or by the actuator members and/or their actuators as described hereinabove and hereinafter in order to store the energy therefrom, to transmit the recoil force thereto, and the like.

In one exemplary embodiment of this aspect of the present invention, various recoil units may be disposed so as to exert recoil forces along or at least partially parallel with a direction of movement of a cap of cap member moving from one to the other of its off- and on-states and/or another direction of movement of a body of a cartridge member or a case of a case member which moves from one to the other of its rest and use positions. In one example, FIG. 12A is a schematic cross-sectional view of an exemplary recoil unit of a coil spring for moving a cap along a direction parallel with a movement direction of the cap according to the present invention, where exemplary cap and cartridge members 30, 40 are similar to those of FIG. 8C. A recoil unit 60 is arranged to couple one end with a support 33 and the other end with a part of the writing tool with respect to which the cap 32 is arranged to move between its off- and on-positions. Such a recoil unit 60 may be arranged to be in its unstressed state when the cap 32 is in its off-state, and to move to its stressed state (i.e., compressed or shortened) while storing the energy when the cap 32 moves to its on-state and the cartridge member 40 moves to its use position. As the user is finished with writing or drawing, the recoil unit 60 may be arranged to release the energy stored therein and then to return to its unstressed state while moving the cap 32 to its unstressed state. In the alternative, the recoil unit 60 may be arranged to be in its stressed state and to store the energy (i.e., stretched or lengthened) when the cap 32 is in its off-state. As the user wants to use the writing tool, the recoil unit 60 may release such stored energy and moves back to its unstressed state while moving the cap 32 to its on-state. When the user is done, the recoil unit 60 is moved to its stressed state in response to the input force applied by the user, while storing the energy for next release. In another example, FIG. 12B depicts a schematic cross-sectional view of another exemplary recoil unit of a coil spring which is generally similar to that shown in FIG. 12A according to the present invention, where exemplary cap and cartridge members 30, 40 are similar to those of FIG. 8C and where a recoil unit 60 is also similar to that of FIG. 12A. Contrary to that of FIG. 12A which is disposed upwardly with respect to the support 33, however, the recoil unit 60 of FIG. 12B is disposed downwardly with respect thereto. Therefore, when the recoil unit 60 is arranged to be in its stressed state when a cap 32 is in its off-state, such a recoil unit 60 may release such energy and move to its unstressed state (i.e., lengthened) while moving such a cap 32 from its off- to on-state. Conversely, when the recoil unit 60 is arranged to be in its unstressed state when the cap 32 is in its off-state, the recoil unit 60 may release the stored energy and moves to its unstressed state (i.e., shortened) while moving the cap 32 from its on- to off-state. Other configurational and/or operational characteristics of the recoil unit 60 of FIG. 12B are similar or identical to those of FIG. 12A.

In another exemplary embodiment of such an aspect of this invention, various recoil units may also be disposed in order to exert recoil forces normal to or at least partially transverse to a direction of movement of a cap of cap member moving from one to the other of its off- and on-states and/or a direction of movement of a body of a cartridge member and/or a case of a case member moving from one to the other of its rest and use positions. In one example, FIG. 12C is a schematic cross-sectional view of another exemplary recoil unit of a coil spring which moves a cap in a direction transverse to a movement direction of the cap according to the present invention, where exemplary cap and cartridge members 30, 40 are similar to those of FIG. 8B. A recoil unit 60 is arranged to couple one end with a cap 32 and the other end with a part of the writing tool disposed between the cap 32 and a body 41 of the cartridge member 40. The recoil unit 60 may be arranged to be in its unstressed state when the cap 32 is in its off-state, and to move to its stressed state (i.e., stretched or lengthened) while storing the energy as the cap 32 moves to its on-state and the cartridge member 40 moves to its use position. It is appreciated that, contrary to the recoil units 60 of FIGS. 12A and 12B disposed along a direction of movement of the cartridge member 40, the recoil unit 60 of FIG. 12C is oriented normal or transverse to such a direction. After the user is done with the tool, the recoil unit 60 may be arranged to release the stored energy and returns to its unstressed state while moving the cap 32 to its unstressed state. In the alternative, the recoil unit 60 may be arranged to be in its stressed state and to store such energy (i.e., compressed or shortened) as the cap 32 is in its off-state. When the user wants to use the tool, the recoil unit 60 releases the stored energy and moves to its unstressed state while moving the cap 32 to its on-state. After use, the recoil unit 60 is moved to its stressed state in response to the input force supplied by the user, while storing the energy for next release. In another example, FIG. 11D is a schematic cross-sectional view of another exemplary recoil unit of a leaf spring to move a cap in a direction transverse to a movement direction of the cap according to the present invention. Exemplary cap and cartridge members 30, 40 are generally similar to those of FIG. 8B. Contrary to those of FIGS. 12A to 12C, a conventional leaf spring may be used as a recoil unit 60 and disposed between caps 32 and a case of a case member in order to receive the input force and to store or release energy along a direction normal or transverse to a direction of movement of the cartridge member 40. Similar to that of FIG. 12C, the recoil unit 60 may be arranged to be in its unstressed or stressed state as the cap 32 is in its off-state and to be in its stressed or unstressed state as the cap 32 is in its on-state. Further configurational and/or operational characteristics of the recoil unit 60 of FIG. 12D may be similar to or identical to those of FIG. 12C.

In another exemplary embodiment of such an aspect of this invention, various recoil units may be disposed in order to exert recoil forces at an angle and/or along a slanted direction with respect to a direction of movement of a cap of cap member which moves from one to the other of its off- and on-states, a direction of movement of a body of a cartridge member from one to the other of its rest and use positions, and/or a direction of movement of a case of a case member from one to the other of its rest and use positions. In one example, FIG. 12E shows a schematic cross-sectional view of another exemplary recoil unit of a leaf spring moving a cap radially according to the present invention, where exemplary cap and cartridge members 30, 40 are similar to those shown in FIG. 8P. A recoil unit 60 is arranged to movably couple one end with a support 33 and to fixedly couple the other end with a part of the writing tool disposed between the cap 32 and a case of a case member. The recoil unit 60 may be arranged to be in its unstressed state as the cap 32 is in its off-state, and to move to its stressed state (i.e., compressed or squeezed) while storing the energy when the cap 32 moves to its on-state and the cartridge member 40 moves to its use position. It is appreciated that the rotating cap 32 exerts force in multiple slanted angles onto the recoil unit 60 while moving from its off- to on-state. After the user is done with the tool, the recoil unit 60 may be arranged to release the stored energy and returns to its unstressed state while moving the cap 32 to its unstressed state. Alternatively, the recoil unit 60 may be arranged to be in its stressed state and store such energy (i.e., compressed or squeezed) as the cap 32 is in its off-state. As the user wants to use the tool, the recoil unit 60 releases the stored energy and moves to its unstressed state while moving the cap 32 to its on-state. After use, such a recoil unit 60 is moved to its stressed state in response to the input force supplied by the user, while storing the energy for next release. In another example, FIG. 12F shows a schematic cross-sectional view of another exemplary recoil unit of a coil spring for moving a cap in a radial direction according to the present invention, where exemplary cap and cartridge members 30, 40 are similar to those of FIG. 8E. A recoil unit 60 may be arranged to couple one end to a cap 32 and the other end to a part of the writing tool disposed between the cap 32 and a case of a case member. Such a recoil unit 60 may be arranged to be in its unstressed state when the cap 32 is in its off-state, and to move to its stressed state (i.e., stretched or lengthened) while storing the energy as the cap 32 moves to its on-state and the cartridge member 40 moves to its use position. Similar to that of FIG. 12E, such a rotating cap 32 exerts the force in multiple slanted angles onto the recoil unit 60 while moving from its off- to on-state. After the user is done with the tool, the recoil unit 60 may be arranged to release such stored energy and returns to its unstressed state while moving the cap 32 to its unstressed state. Alternatively, the recoil unit 60 may be arranged to be in its stressed state and store such energy (i.e., compressed or squeezed) as the cap 32 is in its off-state. When the user wants to use the tool, such a recoil unit 60 releases the stored energy and moves to its unstressed state while moving the cap 32 to its on-state. After use, such a recoil unit 60 is moved to its stressed state in response to the input force supplied by the user, while storing the energy for next release. It is to be understood that, in contrary to those recoil units 60 of FIGS. 12A to 12D, the recoil units 60 of FIGS. 12E and 12F are preferably disposed at slanted angles with respect to a movement direction of the cartridge member. Further configurational and/or operational characteristics of the recoil unit 60 of FIG. 12F are similar to or identical to those of FIG. 12E.

In another exemplary embodiment of such an aspect of this invention, various recoil units may be disposed in order to exert recoil forces along a path of movement of a cap of a cap member. FIG. 12G shows a schematic cross-sectional view of another exemplary recoil unit of an elastic string for moving a cap along a track according to the present invention. Exemplary cap and cartridge members 30, 40 are similar to those of FIG. 8G, where a recoil unit 60 may be arranged to couple one end with a support 33 and the other end with any part of the writing tool. The recoil unit 60 may be arranged to be in its unstressed state as the cap 32 is in its off-state, and then to move to its stressed state (i.e., stretched or lengthened) along a path of the cap 32 while storing the energy when the cap 32 moves to its on-state and the cartridge member 40 moves to its use position. After the user is done with the tool, the recoil unit 60 may be arranged to release the stored energy and move to its unstressed state while moving the cap 32 to its unstressed state. Alternatively, the recoil unit 60 may be arranged to be in its stressed state and store such energy (i.e., compressed or shortened) as the cap 32 is in its off-state. When the user wants to use the tool, such a recoil unit 60 releases the stored energy and moves to its unstressed state while moving the cap 32 to its on-state. After use, such a recoil unit 60 may be moved to its stressed state in response to the input force supplied by the user, while storing the energy for next release.

In another exemplary embodiment of such an aspect of this invention, various recoil units may be disposed around a cap of a cap member in order to exert recoil forces centrifugally or centripetally. FIG. 12H shows a schematic cross-sectional view of another exemplary recoil unit of a coil spring for circumferentially moving a cap according to the present invention, where exemplary cap and cartridge members 30, 40 are similar to those of FIG. 8D. A recoil unit 60 may be disposed around or at least a substantial portion of multiple caps 32 in order to exert recoil force into and/or out of a center portion of the cap 32. The recoil unit 60 may be arranged to be in its unstressed state when the cap 32 is in its off-state, and to move to its stressed state (i.e., stretched or lengthened) while storing the energy when the cap 32 moves to its on-state and the cartridge member 40 moves to its use position. After the user is done with the writing tool, the recoil unit 60 may be arranged to release the stored energy and move to its unstressed state while moving the cap 32 to its unstressed state. Alternatively, such a recoil unit 60 may be arranged to be in its stressed state and store the energy (i.e., compressed or shortened) as the cap 32 is in its off-state. When the user wants to use the tool, such a recoil unit 60 releases the stored energy and moves to its unstressed state while moving the cap 32 to its on-state. After use, the recoil unit 60 may be moved to its stressed state in response to the input force supplied by the user, while storing the energy for next release.

Configurational and/or operational variations and/or modifications of the above embodiments of the recoil units described in FIGS. 12A through 12H also fall within the scope of the present invention.

In all of the foregoing exemplary embodiments, any elastic elements of such recoil units may be used interchangeably. For example, any coil springs may be replaced by other elastic elements such as, e.g., leaf springs, elastic strings, elastic or deformable materials, and the like. In addition, the recoil units may include almost any number of elastic elements which may be coupled to each other in series and/or parallel arrangements. For example, any single spring may be replaced by two or more springs and/or multiple other elastic elements which may be coupled to each other in the series and/or parallel arrangement, as long as such multiple elastic elements may exhibit similar static and/or dynamic elastic behavior as the single spring. Similarly, multiple recoil units may also be replaced by a single recoil unit and/or a single elastic element, as long as such a unit and/or element may exhibit similar static and/or dynamic behavior as multiple recoil units and/or elastic elements.

The foregoing recoil units and/or their elastic elements may be disposed in almost any locations inside and/or outside the writing tools, as long as such units and elements may exhibit required elastic behavior. In general, exact modes of disposition of the recoil units may depend at least partially upon various factors such as, e.g., movement paths and/or directions of the cap and/or cartridge members, sequences of force transmission along various members of the writing tools, space availability inside a case member, physical configurations of the body of the cartridge member, and the like. Therefore, various recoil units and/or their elastic elements may preferably be shaped and/or sized to satisfy the above factors but without compromising the static and/or dynamic behavior thereof. When desirable, the recoil units and/or elastic elements thereof may be disposed remotely from various members of the writing tools by providing conventional power transmission lines between such recoil units and those members of the tool, where examples of such power transmission lines may include, but not be limited to, strings capable of transmitting tensile force and/or torque, chains, and so on. The writing tool may also include conventional power converting devices between such recoil units and those members in order to change magnitudes and/or directions of forces, where examples of such power converting devices may include, but not be limited to, various gear assemblies, various power transmission joints including universal joints, and so on. This embodiment may offer the benefit of implementing the recoil unit and/or its elastic element into a smaller space between the case and cartridge members.

The above recoil units and/or their elastic elements may be disposed in almost any orientations with respect to various members of the writing tool. As exemplified in the foregoing figures, the recoil unit may be oriented to move between its unstressed and stressed positions along or in parallel with the movement direction of the cap member, that of the cartridge member, that of the case member, and so on. In the alternative, the recoil unit may be oriented to move between its unstressed and stressed positions along a direction normal to or transverse to one or more of the above movement directions of such members. In another alternative, the recoil unit may be oriented to move between such positions at one or more angles (preferably neither 0 degree nor 90 degrees) with respect to one or more of the above movement directions of such members. Moreover, the recoil unit may be oriented to move and exert the recoil force circumferentially, centrifugally, and/or centripetally, with respect to one or more of the foregoing movement directions of such members. As long as such recoil units and their elastic elements may be arranged to move between their unstressed and stressed positions and to exert the recoil force along a desirable direction, selecting disposition and orientation of the recoil units and their elastic elements may be a matter of choice of one of ordinary skill in the art.

As described above, various elastic elements of the recoil units may also be arranged to be in either of their unstressed or stressed position when the cap member is disposed in its off-state or on-state and/or when the cartridge, case, and/or actuator members may be disposed in their rest position or use position. The only difference between these opposite arrangements is whether the recoil unit exerts the recoil force in order to move the cap member from its off- to on-state or, in the alternative, from its on- to off-state. Therefore, such a selection is also a matter of choice of one skilled in the art. Similarly, the recoil units and their elastic elements may also be either compression- or extension-type. The only difference between these opposite arrangements is whether the recoil unit may develop the recoil force upon being compressed or squeezed or, in the alternative, when stretched or lengthened. Accordingly, such a selection also falls into a matter of choice of one skilled in the art.

Because the recoil units and/or their elastic elements may be disposed in almost any locations inside and/or outside of the writing tool, such units and/or elements may be incorporated into various other members of the tool. Therefore, the recoil units and/or their elastic elements may be viewed as parts of other members of the writing tools such as, e.g., the case members, cap members, cartridge members, actuator members, and the like. As described above, classification of such recoil units as parts of other members may not be material to the scope of the present invention as far as such units and/or their elastic elements may be arranged to receive the energy, to store at least a portion thereof, and to release such energy in order to move the cap and/or other members of the tool from one to the other of their states and/or positions.

The writing tool of this invention may also include at least one release unit which is to be used along with the recoil unit, where such a release unit may be operatively coupled to the recoil unit and to manipulate such a recoil unit to release at least a portion of the stored energy according to a preset pattern. In one example, such a release unit may manipulate the recoil unit to release an entire portion of energy stored therein, regardless of an amount of such energy stored in the recoil unit. In another example, the release unit may instead be arranged to control the recoil unit to release a preset amount of such energy, e.g., by manipulating the recoil unit to stop releasing such energy beyond the preset amount.

Configurational and/or operational variations and/or modifications of the above embodiments of various members and parts thereof described in FIGS. 1A through 12H also fall within the scope of the present invention.

First, various caps of the present invention which may be arranged to move between their off- and on-states may be replaced by deformable caps which may deform between their unstressed and stressed positions. For example, such caps may be arranged to deform in response to the input force and/or other members of the writing tools which may transmit the input force or its portion to the caps. Therefore, the deformable caps may be arranged to have shapes and/or sizes in their unstressed (or stressed) positions which may generally correspond to shapes and/or sizes of various movable caps of this invention in their off-states, and to have shapes and/or sizes in their stressed (or unstressed) state which may correspond to shapes and/or sizes of various movable caps of this invention in their on-states. Such deformable configurations may be incorporated into all of the above caps of the first class and/or the foregoing caps of the first class may also be modified to incorporate the deformable configurations.

As briefly described hereinabove, various caps of the present invention may also be arranged to expose at least portions thereof so that such an exposed portion may define a part of an exterior of the writing tool. Contrary to many caps described hereinabove, the exposed caps of this embodiment may be arranged to form openings by moving or deforming to their on-states, and to destroy or close the openings by moving or deforming to their off-states. Accordingly, such openings may correspond to conduits in such an embodiment. In general, all of the above features described in conjunction with the caps of the first class may be applied to such exposed caps of the second class.

It is to be understood that various members, units, and/or their parts of the writing tool of this invention may be arranged to serve as other members, units, and/or their parts of such a tool, as long as such may perform two or more functions. In one exemplary embodiment, various members, units, and/or parts thereof may be arranged to serve as a cap of a cap member and/or as a portion thereof. Examples of such may include, but not be limited to, various absorber units such as those of FIGS. 1A to 1F, various actuators such as those of FIGS. 10A to 10H and 11A to 10H, various recoil units such as those of FIGS. 12A to 12H, and the like. In another exemplary embodiment, various members, units, and/or their parts may also be arranged to serve as the actuator member and/or as a portion thereof. Examples of such may include, but not be limited to, various frames, supports, guides, and/or tracks of such cap members, various edges of the bodies of the cartridge members, various cases of the case members, and so on. In another exemplary embodiment, various members, units, and/or parts thereof may also be arranged to serve as the cartridge member and/or as its portion. Examples of such may include, but not be limited to, various actuators such as those exemplified in FIGS. 1E and 1F, various supports, guides, and/or tracks of the cap members including those of FIGS. 9A to 9P, and the like. In another exemplary embodiment, various members, units, and/or their parts may be arranged to serve as the case member and/or a case thereof, where examples of such may include, but not be limited to, various frames, caps, supports, guides, and/or tracks of the cap members including those caps of FIGS. 1C and 1D, various actuators including those of FIGS. 1E and 1F, and the like.

All members, units, and/or their parts in the schematic cross-sectional views such as FIGS. 1A to 1F, 7A to 7L, 8A to 8P, 9A to 9P, 10A to 10H, 11A to 11H, and 12A to 12H, may be deemed to have various configurations. For example, any part represented by a curvilinear line in such figures may be interpreted to have one of various shapes such as, e.g., a curvilinear rod, a curvilinear sheet, and the like. Therefore, the caps 32 of FIGS. 1A and 1B may be viewed as a pair of separate caps disposed in opposite sides of the inner space 26 or, in the alternative, as a single annular cap encircling around the inner space 26. Similarly, the caps 32 of FIGS. 10A to 10C and 10F to 10H may also be viewed as a single annular cap encircling the cartridge member, two separate caps disposed in opposite sides of the cartridge members 40, two of four similar caps each disposed in every 90 degrees around such a cartridge member, two of six similar caps each disposed in every 60 degrees therearound, and so on. As long as such caps may be arranged to perform various functions described herein, a selection of the exact number of such caps may be a matter of choice of one of ordinary skill in the art.

Various caps of the writing tool of this invention may be arranged to move in various directions along various paths. As exemplified above, such members, units, and/or their parts may be arranged to move along directions and/or paths similar to those of the input force in response thereto directly or, alternatively, through the transmission of such force through other members, units, and/or their parts. In the alternative, such members, units, and/or parts thereof may be arranged to move along directions and/or paths which may be different from those of the input force. In such an embodiment, the writing tool is provided with the actuator member which may include at least one support and/or guide about which the cap and/or actuator may be disposed at different angles in order to change the direction of the transmission of such force. In the alternative, such an actuator member may include one or more gears, gear assemblies, universal joints, and/or other conventional force transmission and conversion devices which may change one or more of the directions of such force transmission, speeds thereof, and/or modes thereof. Accordingly, such an actuator may be arranged to convert the translating input forces into the rotating and/or pivoting movements of the case, cap, and/or cartridge members or vice versa. In this context, all of the cap members described herein which translate between their off- and on-states may be modified to rotate and/or pivot about the rotation points and/or axes, as exemplified in FIG. 9K.

Regardless of the exact modes of movements between their off- and on-states such as, e.g., translation, rotation, pivoting, deformation, and so on, various caps of the writing tool of this invention may be arranged to move with or without maintaining their shapes in their off-states, as exemplified in FIG. 2O. In this embodiment, such caps may be arranged to change their configurations while moving from at least one to the other of their off- to on-states through various provisions. In one example, the caps may change their shapes and/or sizes while being guided by various guides and/or supports as described above, where such guides and/or supports may be arranged to movably or fixedly fold, roll, bend, stack, deform, and/or otherwise change configurations of at least portions of such caps during movements thereof. In another example, such caps may be arranged to fold, roll, bend, stack, deform, and/or otherwise change configurations of at least portions thereof while at least partially conforming to portions of the case and/or cartridge members such as, e.g., along inner walls of various cases of the case member, outer surfaces of the body of the cartridge member, and the like.

As described above, such cap members and/or caps thereof may be incorporated into various members, units, and/or their parts of the writing tool, and at least portions thereof may move between their off- and on-states. When desirable, such cap members and/or caps thereof may be designed to be disposable and/or replaceable so that the user may exchange the used cap members and/or caps with the new ones. To this end, the cap members and/or their caps may be arranged to be releasably or detachably coupled to such members, units, and/or parts of the writing tool so as to allow the user to readily remove and install such cap members and/or caps. Alternatively, such cap members and/or caps may instead be incorporated into the disposable or replaceable case and/or cartridge members.

Such cap members may also be arranged to move their caps from their on- to off-states upon detecting one or more preset events. For example, the writing tool may include a mechanical sensor for sensing the input force and/or for detecting whether the user uses the writing tool, and may move the caps to their off-states when the sensor does not sense such input force for more than a preset period, when the user does not use the writing tool for more than such a period, when the writing tool is not moved for more than such a period, when such a tool is disposed horizontally for more than the preset period, and the like. In another example, such a tool may also be arranged to move the caps to their off-state strictly based upon a period of time in which the tip of the cartridge member is exposed, in which the caps are in their on-states, and so on. In another example, the recoil unit may instead be arranged to release the stored energy gradually or according to a preset temporal pattern and to move the caps to their off-states after another preset period of time. The recoil unit may also be arranged to store more energy while the user is using the writing tool, thereby prolonging the preset period of time as the user uses the tool.

It is appreciated that some writing tools of the present invention may not include a cap member. For example, a portion of the case member may be arranged to move to form and close an opening in order to allow the tip of the cartridge member to be exposed out of and/or enclosed inside the case of the case member. In this embodiment, such a portion of the case member may be viewed as the cap member as well.

It is also appreciated that the above caps of various cap members may be generally arranged to provide fluid communication between the inner space formed inside the case member and exterior thereof. Some tips of the cartridge members, however, may be shaped and/or sized in order to match the opening and, therefore, substantially block such an opening in the use positions of the tips and/or in the on-states of the caps. Although such tips may completely block the openings, they may usually allow such fluid communication between the inner space and exterior while they move from their rest positions to their use positions. The same may also apply to those caps which are arranged to define the conduits in their on-states. In this context, the caps of the cap members and tips of the cartridge members of the present invention are to be deemed to provide such fluid communication between the inner space and exterior in the on-states of the caps and in the use positions of the cartridge member, regardless of whether the tips may block the opening of the case member and/or conduits of the cap member.

Various cartridge members of such a writing tool of the present invention may be arranged to have various configurations as well. In one example and as exemplified in all of the foregoing figures, the cartridge member may include the body which may be filled with the marking substances. Such a cartridge member may be arranged to move between its rest and use positions or, alternatively, may be disposed to be stationary while the cap and/or case members may expose and hide the tip thereof. In another example, the cartridge member may not include any separate body at all. Rather, a portion of the case of the case member may be arranged to contain such marking substances, while the tip is disposed in one end of such a portion of the case and fluidly coupled thereto in order to dispense the marking substances therethrough. The cartridge member may be arranged to receive the input force directly through a portion thereof from the user, where such a portion may be exposed in order to be manipulated by the user. In the alternative, the cartridge member may be arranged to be transmitted of the input force through other members, units, and/or their parts of the writing tool. An entire portion of such a cartridge member may be disposed inside the case member or, alternatively, at least a portion thereof may be exposed, where detailed design of such a cartridge member may not be material to the scope of the present invention. As described herein, the cartridge member may be arranged to move other members of the writing tool as well. For example, such a cartridge member may be arranged to operate the caps of the cap member from at least one to the other of their off- and on-states, to move the actuator and/or case members from at least one to the other of their rest and use positions, and so on. Conversely, the cartridge member may be arranged to be moved from at least one to the other of their rest and use positions by the caps of the cap member, by the case and/or actuator members, and the like. When desirable, such a cartridge member may also be designed to be disposable and/or replaceable such that the user may exchange the used cartridge member with the new one when the cartridge member may run out of the marking substances, when its tip may be damaged, and the like. To this end, the cartridge member may be arranged to releasably and/or detachably couple with other members, units, and/or parts of the writing tool in order to allow the user to readily remove and install such a cartridge member. Alternatively, such a cartridge member may instead be incorporated into the disposable or replaceable case and/or cap members. When desirable, the cartridge member may also be arranged to be refilled with the marking substances and/or to be replaced by a new tip.

Various dividers may be provided to define the inner spaces in the case of the case member. As described above, such a divider may serve to partition an interior of the case and to form the inner space which may correspond to only a portion of the interior, thereby minimizing the space which may contribute to vaporizing the marking substances from the tip of the cartridge member. The divider may be arranged to be supported by the case, cap, cartridge, and/or actuator members. When the case or cartridge member moves between their rest and use positions, the divider may preferably be arranged to movably seal the inner space.

Various absorber units of the writing tool of the present invention may be arranged to be made of and/or to include any conventional materials which may physically or chemically absorb or adsorb various marking substances to be contained in the body of the cartridge members. Examples of such materials may include, but not be limited to, natural or synthetic cottons, sponges, fabrics, and the like. As described herein, many cartridge members of the writing tool of the present invention are arranged to move between their rest and use positions and to make abrupt stops as they may approach at least one of such positions. Accordingly, it is appreciated that the cartridge members of the writing tools of this invention may tend to leak more marking substances than conventional writing tools and inclusion of such absorber units may be highly recommended. Such absorber units may be disposed in almost any locations inside or outside the case members as long as the absorber units may absorb or adsorb the marking substances leaked from the cartridge members. In addition, such absorber units may also be fixedly or movably coupled to various members, units, and/or their parts as long as such couplings may not obstruct normal operations of various members of such a writing tool. In one example, such absorber units may be fixedly coupled to the stationary or mobile case of the case member in order to absorb or adsorb the marking substances. In another example, the absorber units may be coupled to the caps of the cap members, as exemplified in FIGS. 1A to 1F, so that the absorber units may absorb or adsorb the marking substances. The writing tool may also be arranged to include multiple absorber units each of which is arranged to be disposed in and out of the inner space in an alternating mode so that one absorber unit may be absorbing or adsorbing the marking substances while the other may be dried while being exposed to the exterior. Such absorber units may be arranged to move along with the cap and/or cartridge members or, in the alternative, to move independently of such members. The above absorber units may be provided as disposable, replaceable, and/or refillable units such that the user may replace used and wet absorber units by new and dry absorber units. When desirable, the absorber units may be fixedly or movably included in the disposable, replaceable, and/or refillable cap and/or cartridge members.

In addition to all of such variations and/or modifications of various members and/or units of the writing tools of this invention, other configurational and/or operational details described in the above co-pending applications may also be readily applied to such members and/or units of the writing tools of this invention, unless otherwise specified.

It is appreciated that various members and/or units of the writing tools of this invention may be incorporated into various conventional pens to form novel capless writing tools which also fall within the scope of this invention, where selected examples of such conventional pens may include, but not be limited to those disclosed in U.S. Pat. Nos. 6,830,402 B2 (to Sunatori), 6,773,185 B1 (to Hsieh), 6,752,557 B1 (to Hsieh), 6,623,136 B1 (to Kuo), 6,609,846 B1 (to Lai et al.), 6,379,068 B1 (to W-P Yu), 6,305,865 B1 (to Yoshii et al.), 6,273,627 B1 (to Mittersinker et al.), 6,213,661 B1 (to Coon), 6,155,733 (to Holbrook et al.), 6,092,951 (to Greene et al.), 5,997,204 (to Ducrocq), 5,984,559 (to Shiobara et al.), 5,967,684 (to Huang et al.), 5,913,629 (to Hazzard), 5,888,007 (to Nicoll et al.), 5,673,996 (to Ducker), 5,564,849 (to Greer, Jr.), 5,518,330 (to Gervais), 5,221,151 (to Kuo), 5,203,638 (to Redmond, Jr.), 5,174,814 (to Burwell), 5,206,190 (to Longarzo), 4,969,764 (to Gregory), 4,759,650 (to Granoff), 4,711,592 (to Gregory), 4,595,307 (to Heyden), 4,560,298 (to Oki et al.), 4,540,300 (to Midorikawa), 4,378,171 (to Schmidt), 4,343,559 (to Silver), 4,272,206 (to Treen), 4,269,525 (to Melikian), 4,227,823 (to Kitzerow), 4,115,015 (to Torii), 3,944,371 (to Schenk), U.S. Pat. Appl. Pub. No. US 2002/0192007 A1, and the like.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

What is claimed is:

1. A capless writing tool capable of applying a marking substance onto an article while minimizing leakage of said marking substance therethrough comprising:
at least one cartridge member configured to keep said marking substance therein and to have a tip with which said user is configured to apply said marking substance onto said article;
at least one case member configured to retain at least a portion of said cartridge member and to define an opening for exposing said tip of said cartridge member therethrough;
at least one cap member including at least one cap configured to operate between at least one off-state and at least one on-state, to respectively obstruct and clear said opening in said off- and on-states, and to respectively prevent and provide said fluid communication through said opening in said off- and on-states; and
at least one absorber unit configured to be one of fixedly and movably coupled to at least one of said members and to absorb said marking substance which is leaked out of said cartridge member, thereby minimizing said leakage of said marking substance out of said writing tool.

2. The writing tool of claim 1, wherein said cap member is configured to close and form a conduit in said off- and on-states, respectively, and to be disposed in one end of said case member such that said conduit is configured to replace said opening of said case member.

3. The writing tool of claim 1, wherein said cap member includes a single cap which is configured to translate away from said opening from said off-state to said on-state, and to translate toward said opening from said on-state to said off-state.

4. The writing tool of claim 1, wherein said cap member includes a single cap which is configured to at least one of rotate and pivot along a direction at least partially parallel with said opening between said off- and on-states.

5. The writing tool of claim 1, wherein said cap member includes a single cap which is configured to at least one of rotate and pivot about a rotation axis located along at least one edge of said opening between said off- and on-states.

6. The writing tool of claim 1, wherein said cap member includes at least one track coupled to at least one of said members and wherein said cap is configured to move from one to the other of said off- and on-states along said track.

7. The writing tool of claim 1, wherein said cap is configured to define at least one hole thereon, to misalign said hole away from said opening in said off-state, and to align said hole with said opening in said on-state.

8. The writing tool of claim 1, wherein said cap member is configured to receive input force from an user of said tool and to move said cap from at least one to the other of said off- and on-states.

9. The writing tool of claim 1, wherein said case member is configured to receive input force from an user of said tool and to transmit at least a portion of said input force in order to move said cap from at least one to the other of said off- and on-states.

10. The writing tool of claim 1, wherein said cartridge member is configured to receive input force from an user of said tool and to transmit at least a portion of said input force in order to move said cap from at least one to the other of said off- and on-states.

11. The writing tool of claim 1 further comprising at least one actuator member which is configured to receive input force supplied by an user of said tool and to transmit at least a portion of said force in order to move said cap from at least one to the other of said off- and on-states.

12. The writing tool of claim 1, wherein said absorbed unit is configured to be disposed adjacent to said opening and to absorb said marking substances before said substances leak out of said opening.

13. The writing tool of claim 1, wherein said absorbed unit is configured to be disposed over said cap and to primarily absorb said marking substances when said cap is in said off-state.

14. The writing tool of claim 1 further comprising at least one divider which is configured to couple with at least one of said members, wherein said case member has an interior in which said cartridge member is disposed, wherein said divider is configured to define an inner space which is configured to correspond to only a fraction of said interior of said case member and to be disposed closer to said tip, and wherein said tip is configured to be disposed in said inner space when said cap is in said off-state, thereby minimizing an amount of said marking substance to evaporate in said off-state.

15. The writing tool of claim 14, wherein at least a portion of said divider is configured to be fixedly coupled to an inner surface of said case member.

16. The writing tool of claim 15, wherein said divider is configured to movably enclose therein said cartridge member and to enable said cartridge member to move therethrough during movement of said cap between said off- and on-states while at least partially keeping airtight sealing between said inner space and interior.

17. The writing tool of claim 14, wherein at least a portion of said divider is configured to be fixedly coupled to said cartridge member and to move along with said cartridge member while at least partially abutting an inner surface of said case member and keeping airtight sealing between said inner space and interior.

18. The writing tool of claim 1 further comprising at least one recoil unit which is configured to be coupled to said cap and to bias said cap toward said opening when said cap is in said off-state.

19. A cartridge assembly for a writing tool with a case member capable of receiving said cartridge member therethrough and configured to form an interior therein, said cartridge assembly containing at least one marking substance capable of leaving marks onto an article and further comprising:
at least one body configured to store therein a preset amount of said marking substance;
at least one tip configured to be in fluid communication with said marking substance inside said body and to dispense said marking substance therethrough out of said body onto said article; and
at least one absorber unit configured to be coupled to said body and capable of absorbing said marking substance, thereby capable of removing said marking substance leaked from said tip into said interior of said case member.

20. A method of enclosing a tip of a cartridge member of a writing tool in a case member thereof and exposing said tip to an exterior of said tool through an opening of said case member for applying a marking substance contained inside said cartridge member onto an article while minimizing leakage of said marking substance out of said case member, said method comprising the steps of:
operatively coupling at least one movable cap to said opening;
obstructing at least a substantial portion of said opening by said cap as said writing tool is not used by an user;
clearing said portion of said opening by removing said cap therefrom in response to input force supplied to at least one of said case member, cap member, and cartridge member as said tool is in use by said user; and
absorbing said marking substance which leaks from said tip to an interior of said case member before said marking substance escapes to said exterior, thereby minimizing said leakage.
